(19) United States
(12) Patent Application Publication
(10) Pub. No.: US 2014/0368373 A1
(43) Pub. Date: Dec. 18, 2014

(54) SCANNERS, TARGETS, AND METHODS FOR SURVEYING

(71) Applicant: SADAR 3D, INC., St. Louis, MO (US)

(72) Inventors: Stephen B. Crain, St. Louis, MO (US); Joseph V.R. Paiva, St. Louis, MO (US); Dennis H. Cowdrick, St. Louis, MO (US)

(21) Appl. No.: 14/310,954

(22) Filed: Jun. 20, 2014

Related U.S. Application Data
(63) Continuation of application No. PCT/US2012/071100, filed on Dec. 20, 2012.
(60) Provisional application No. 61/578,042, filed on Dec. 20, 2011.

(51) Int. Cl. H01Q 15/14; G01S 13/86

(52) U.S. Cl. CPC H01Q 15/14; G01S 13/867; G01S 13/86
USPC 342/5

(57) ABSTRACT

Apparatus and methods useful in surveying to provide information rich models. In particular, information not readily or possibly provided by conventional survey techniques can be provided. In some versions targets provide reference for baseline positioning or improving position information otherwise acquired. Scanning may be carried out in multiple locations and merged to form a single image. Machine mounted and hand mounted scanning apparatus is disclosed.

### CROSS-REFERENCE TO RELATED APPLICATIONS

This application is a continuation of PCT/US2012/071100, filed Dec. 20, 2012, claiming priority to U.S. Provisional Patent Application No. 61/578,042, filed Dec. 20, 2011, both of which are hereby incorporated by reference in their entirety.

### BACKGROUND OF THE INVENTION

Conventional methods and apparatus for noninvasive scanning are limited. One form of scanning is synthetic aperture radar. Synthetic aperture radar (SAR) is defined by the use of relative motion between an antenna and its target region to provide distinctive signal variations used to obtain finer resolution than is possible with conventional radar. SAR uses an antenna from which a target scene is repeatedly illuminated with pulses of radio waves from different antenna positions. The reflected radio waves are processed to generate an image of the target region.

A particular example of an SAR apparatus is disclosed in U.S. Pat. No. 6,094,157 (“the '157 patent”), which is hereby incorporated by reference in its entirety. The '157 patent discloses a ground penetrating radar system which uses an oblique or grazing angled radiation beam oriented at a Brewster angle to provide improved coupling of radar energy into the earth, reducing forward and back scatter and eliminating the need to traverse the surface of the earth directly over the investigated volume. An antenna head is moved along a raster pattern lying in a vertical plane. The antenna head transmits and receives radar signals at regular intervals along the raster pattern. In particular, measurements are taken at thirty-two spaced intervals along the width of the raster pattern at thirty-two vertical increments, providing a total of 1,024 transmit/receive positions of the antenna head. For reliably moving the antenna head along the raster pattern, the antenna head is mounted on a horizontal boom supported by an upright telescoping tower. The antenna head is movable along the horizontal boom by a cable and pulley assembly. The antenna head is movable vertically by movement of the telescoping tower. The horizontal boom and telescoping tower provide a relatively “rigid” platform for the antenna head to enable reliable movement of the antenna head to predetermined positions along the raster pattern. Processing of the radar signals received along the raster pattern yields a three-dimensional image of material beneath the surface of the earth.

Improved noninvasive scanning apparatus and methods are desirable, using SAR and/or other noninvasive techniques.

### SUMMARY

In one aspect, the present invention includes a target for use in combined radar and photographic scanning. The target includes a support, a generally symmetrical structure mounted on the support having the same appearance to a photographic scanning device from different vantages, and a radar reflector mounted on the support in a predetermined position with respect to the generally symmetrical structure whereby the target can be correlated between radar and photographic images.

In another aspect, the present invention includes a method of imaging a zone to be surveyed. The method includes placing a target in the zone. The target includes an optical signaling mechanism and a radar reflector. The method also includes illuminating the zone with radar and receiving a reflected radar return from the zone. The radar reflector is configured to provide a strong radar reflection. The method also includes acquiring photographic data from the zone while the optical signaling mechanism is activated. The method also includes processing image data including the reflected radar return and the photographic data. The processing includes identifying the radar reflector and optical signaling mechanism and correlating the reflected radar return and the photographic data with each other based on a known positional relationship of the optical signaling mechanism and the radar reflector for use in producing a three dimensional image of the zone.

In another aspect, the present invention includes a target for use in surveying with radar. The target includes a support adapted to engage a surface in the zone. The support is made of a radar transparent material. The target also includes a radar reflector located within the support.

In another aspect, the present invention includes a target for using in mapping a zone. The target includes a support and a radar reflector mounted on the support and constructed to strongly reflect radar incident upon the radar reflector. The target also includes a flash source for flashing electromagnetic radiation. The flash source includes a receiver for receiving a signal from a remote scanning device to activate the flash source to emit a flash of electromagnetic radiation detectable by the remote scanning device.

In another aspect, the present invention includes a method of imaging a zone to be surveyed. The method includes manually transporting a support having a radar scanning device thereon to a first location within the zone and illuminating at least a portion of the zone with radar from the radar scanning device. The method also includes receiving with the radar scanning device image data including return reflections of the radar emitted from the radar scanning device.

In another aspect, the present invention includes a target for use in obtaining image data from a zone. The target includes a support and a transponder mounted on the support and sensitive to a radar radio wave within a predetermined frequency bandwidth to transmit information about the target upon detecting illumination of the transponder by radar waves in the predetermined bandwidth.

In another aspect, the present invention includes a method of imaging a zone includes illuminating the zone using a radar scanning device supported from the ground with radar of multiple stepped frequency bandwidths ranging from about 500 MHz to about 3 GHz from plural different vantages. The method also includes receiving return radar reflections from the illumination at the plural different vantages and processing image data includes the return radar reflections to produce a three dimensional image of the zone.

In another aspect, the present invention includes a target for using in imaging a zone. The target includes a support having at least one of a reflecting device for preferentially reflecting electromagnetic radiation in a predetermined frequency bandwidth and a emitting device for emitting electromagnetic radiation in a predetermined frequency bandwidth. The target also includes a marking device mounted on the support for marking a surface in the zone.

In another aspect, the present invention includes a method of radar imaging a zone includes placing targets in the zone at points whose position is known and receiving position information from the targets whereby the position of a movable radar scanning device relative to the targets may be established. The method also includes moving the radar scanning device and making scans of the zone with radar from the radar scanning device at different locations. The method also includes using the position information from the targets to create a synthetic aperture radar image of the zone from the scans made by the radar scanning device at the different locations.

In another aspect, the present invention includes a method for locating a position within a scanned zone. The method includes scanning the position of a target within the scanned zone and sending a signal to the target including information regarding the position of the target within the scanned zone.

In another aspect, the present invention includes a method of producing a three dimensional scan of land. The method includes imaging the land by illuminating the land with radar at different locations and receiving radar reflections from the land at the different locations. The method also includes creating, using the radar reflections, a three dimensional image of the land and determining from the radar reflections characteristics of the land in addition to its physical configuration.

In another aspect, the present invention includes a synthetic aperture radar scanning pod for use in scanning a zone. The scanning pod includes a housing adapted to be carried by a human adult, a radar scanning device supported by the housing for emitting radar radiation and receiving radar reflection of the emitted radar radiation, and an adaptor for selectively and releasably mounting the housing on a mechanical support.

In another aspect, the present invention includes a synthetic aperture radar scanning pod including a housing, a first radar device supported by the housing adapted to emit and receive radar radiation for establishing range from the radar device of objects illuminated by the radar radiation, and a second radar device supported by the housing adapted to emit and receive radar radiation for building up an image of a zone scanned with the synthetic aperture scanning pod.

In another aspect, the present invention includes a synthetic aperture radar scanning pod wherein the at least one of the first and second radar devices includes three radar antennas.

In another aspect, the present invention includes a synthetic aperture radar scanning pod wherein both the first and second radar devices comprise three radar antennas.

In another aspect, the present invention includes a synthetic aperture radar and photographic scanning pod including a housing and a photographic device supported by the housing. The photographic device includes at least two cameras at spaced apart locations on the housing. The pod also includes a radar device supported by the housing. Photographic data from two different vantages can be obtained at a single location of the scanning pod.

In another aspect, the present invention includes a radar and photographic scanning device including a housing having an upper surface and a lower surface, a photographic device supported by the housing, and a radar device supported by the housing. The device also includes a leveling laser mounted on the lower surface of the housing for projecting a plane into a zone to the scanned thereby to establish a reference level within the zone.

In another aspect, the present invention includes a method for surveying including scanning a zone with a synthetic aperture camera device, acquiring with the scanning an image of ground visible markings, using the ground visible marking image for location in the zone.

In another aspect, the present invention includes a target element for use in surveying. The target element includes a generally symmetrical body having a height, width and a depth.

In another aspect, the present invention includes a method of surveying including placing a target in the zone on a point of ascertainable position, the target projecting up from the point and at least one of illuminating the zone with radar and acquiring a photographic image of the zone from a scan position to obtain image data. The method also includes processing the image data to determine one of location of the point and location of the scan position at which one of radar illumination and photographic imaging occurs.

Other objects and features will be in part apparent and in part pointed out hereinafter.

### BRIEF DESCRIPTION OF THE DRAWINGS

FIG. 1 is a perspective of a scanner of the present invention;

FIG. 2 is a front elevation of the scanner of FIG. 1;

FIG. 3 is a rear elevation of the scanner;

FIG. 4 is a block diagram illustrating components of the scanner;

FIG. 5 is a view of a person using the scanner inside a room of a building, walls of the room being removed to expose an interior of the room;

FIG. 6 is a view similar to FIG. 5 but showing interior aspects and elements of the far wall in phantom;

FIG. 7 is a view similar to FIG. 5 but showing the person using the scanner from a different position and perspective with respect to the far wall;

FIG. 8 is a flow chart indicating an example sequence of steps which may be performed in processing data collected in a scan according to the present invention;

FIG. 9 is a view similar to FIG. 5 but including insets showing enlarged views of interior aspects and elements of the interior of the far wall as if they were removed from the wall but having the same orientation as when in the wall;

FIG. 10 is a section through a structural building component such as a stud having a wall sheathing secured thereto by wall sheathing fasteners, which are covered by a finishing layer of mud, tape, and paint;

FIG. 11 is a diagrammatic view of a possible user interface of a scanner according to the present invention;

FIG. 12 is a perspective of another embodiment of a scanner according to the present invention;

FIG. 13 is a front elevation of another embodiment of a scanner according to the present invention, including a mobile telephone and a scanning adaptor, the mobile telephone and scanning adaptor being shown disconnected from each other;

FIG. 13 is a rear elevation of the scanner of FIG. 13, the mobile telephone being shown docked and connected with the scanning adaptor;

FIG. 14 is a view of another embodiment of a scanner of the present invention superimposed over a perspective of the room of FIG. 5 and displaying an example augmented reality view which may be displayed on the scanner;

FIG. 15 is a front elevation of the scanner of FIG. 13 displaying an example augmented reality view of the far wall of the room in which interior aspects and elements of the far wall are shown superimposed on the near surface of the wall and in which furniture of the room has been hidden;

FIG. 16 is a front elevation of the scanner displaying another example augmented reality view of the far wall in which the near surface of the wall is removed for exposing interior elements and aspects of the wall;

FIG. 17 is a front elevation of the scanner displaying another example augmented reality view of the far wall in which the near and far surfaces of the wall are removed for permitting partial view through the wall into an adjacent room behind the wall in which a table and chairs are located;

FIG. 18 is a front elevation of the scanner displaying another example augmented reality view in which the far wall is removed permitting clear view into the adjacent room including the table and chairs located in the adjacent room;

FIG. 19 is a front elevation of the scanner superimposed over a perspective of the room of FIG. 5 and displaying another example augmented reality view of the room in which the view is shown from the adjacent room looking back in the direction of the scanner at the rear surface of the far wall;

FIG. 20 is a front elevation of the scanner illustrating another example augmented reality view of the far wall including a reticule or selection indicator around a motion sensor mounted on the far wall and virtual annotation bubbles associated with the sensor which may display an identification or other information associated with the sensor;

FIG. 21 is a rear elevation of another embodiment of a scanner of the present invention including a template for assisting in marking a position located by the scanner and including displayed guidance for locating the position;

FIG. 23 is a perspective of a building including joists and knob and tube wiring and copper wiring installed on the joists to replace the knob and tube wiring;

FIG. 24 is a section of a diagrammatic perspective of a building illustrating various symptoms of subsidence;

FIG. 25 is a view of a corner of a building including a concrete floor and wood frame walls, rebar of the concrete, interior structural components of the walls, and various types of conditions present in the wall being shown in phantom;

FIG. 26 is a diagrammatic section of a building illustrating various locations where water may be present and some potential sources of the water;

FIG. 27 is a front elevation of the scanner of FIG. 13 displaying a view in which a representation of a cabinet is positioned adjacent the far wall;

FIG. 28 is a diagrammatic view of a person and/or a stool adjacent a wall and being scanned according to the present invention, interior elements and aspects of the wall being shown in phantom;

FIG. 29 is a perspective of a vehicle including another embodiment of a scanner of the present invention;

FIG. 30 is a diagrammatic side perspective of the vehicle in use and illustrating potential surface and subsurface objects, structures, and environments which may be included in a scan conducted by the vehicle;

FIG. 31 is an enlarged portion of FIG. 30 illustrating certain features in finer detail;

FIG. 32 is a diagrammatic plan view of the vehicle on a roadway including representations of scan areas associated with the scanner of the vehicle, subsurface utility lines being shown in phantom, and a junction box and pole being shown on the surface;

FIG. 33 is a view similar to FIG. 32 but illustrating a second vehicle of the same type superimposed over the first vehicle for purposes of illustrating an example overlap of scan areas associated with the scanner of the vehicle as it moves along a roadway;

FIG. 34 is a diagrammatic perspective of a side of a roadway including objects, structure, and environments which may be included in a scan of the present invention and including insets showing in finer detail objects and markings which may be included in the scan;

FIG. 35 is a diagrammatic perspective of a taxi cab including another embodiment of a scanner of the present invention;

FIG. 36 is a diagrammatic perspective of a law enforcement vehicle including another embodiment of a scanner of the present invention;

FIG. 37 is a schematic illustration of synthetic aperture radar scanning system showing targets in a scanning zone;

FIG. 38 is a is a schematic illustration of synthetic aperture radar scanning system showing a scanning zone having a rise;

FIG. 39 is a front view of a first scanning survey pole showing a rodman holding the pole;

FIG. 40 is a front view of the first scanning survey pole illustrating a scan pattern;

FIG. 41 is a top perspective of a barrel;

FIG. 42 is a top perspective of a cone;

FIG. 43 is a front view of a second scanning survey pole showing a rodman holding the pole;

FIG. 44 is a perspective of the second scanning survey pole showing a scanner exploded from the pole

FIG. 45 is a front view of a two target survey pole showing a rodman holding the pole;

FIG. 46 is a front view of a tripod with a target element mounted on top of the tripod;

FIG. 47 is a front elevation of the tripod with radar reflectors embedded in legs of the tripod

FIG. 48 is a front elevation of the tripod of FIG. 47 showing the tripod supporting a survey pole;

FIG. 49 is an enlarged fragmentary view of FIG. 47;

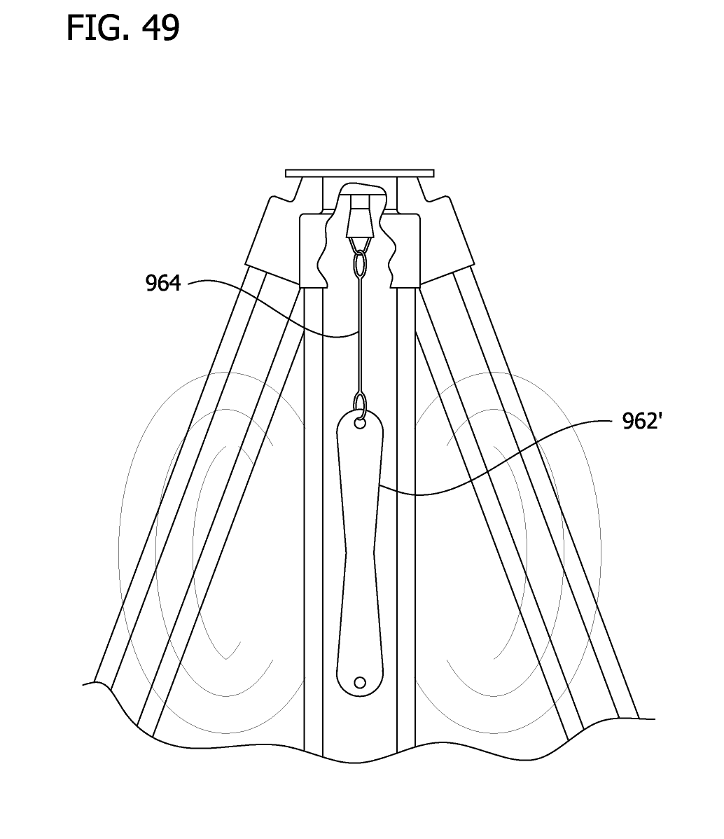

FIG. 50 is a front elevation of a survey pole including embedded radar reflectors;

FIG. 51 is an enlarged fragmentary front elevation of a survey pole showing an embedded radar detector in the pole;

FIG. 52 is a side elevation of a survey pole showing a radar scanner releasably mounted on the pole;

FIG. 53 is a front elevation of the survey pole of FIG. 52 with the radar scanner removed;

FIG. 53A is front elevation a display unit mounted on a bracket to the survey pole of FIG. 52;

FIG. 54 is a top plan view of a modular scanner mounted in a pivoting base;

FIG. 55 is a top plan view of the modular scanner attached to a GPS sensor unit;

FIG. 56 is a front elevation of a target element with portions broken away to show internal components;

FIG. 57 is a front elevation of a target element with portions broken away to shown internal components;

FIG. 58 is a front elevation of a radar scanning pod;

FIG. 59 is a fragmentary portion of a boom;

FIG. 60 is a is a diagrammatic plan view of a block of parcels of land bordered by roadways and having surveying monuments represented by stars;

FIG. 61 is a diagrammatic perspective of an environment including a roadway, building, and utilities infrastructure including unauthorized taps of the utilities, and a scanning vehicle of the present invention which scanning the utilities infrastructure including the unauthorized taps;

FIG. 62 is a diagrammatic perspective of an environment including a roadway, building, and subsurface piping, including a obstructed drainage pipe extending from the building and a leaking fluid delivery pipe, and a scanning vehicle of the present invention scanning the environment;

FIG. 63 is a diagrammatic perspective of an environment including a roadway, various roadway damage, pooled water over a drainage system inlet, and roadside vegetation, and a scanning vehicle of the present invention scanning the environment;

FIG. 64 is a diagrammatic perspective of a soil compaction vehicle including a scanner according to the present invention and a partial volume of soil illustrated in partial section including layers of compacted soil;

FIG. 65 is a diagrammatic perspective of an environment including a roadway, cars on the roadway, and pedestrians to the side of the roadway, and a scanning vehicle of the present invention scanning the environment;

FIG. 66 is a top plan view of a fixed-wing unmanned aerial vehicle

FIG. 67 is a side view thereof;

FIG. 68 is a fragmentary bottom view thereof;

FIG. 69 is a schematic illustration showing the unmanned aerial vehicle scanning a zone;

FIG. 70 is a top perspective of a rotorcraft;

FIG. 71 is a bottom perspective of the rotorcraft;

FIG. 72 is a schematic illustration showing use of the rotorcraft in a surveying operation;

FIG. 73 is a schematic illustration showing use of the rotor craft in a synthetic aperture scanning operation;

Corresponding reference characters indicate corresponding parts throughout the drawings.

### DETAILED DESCRIPTION

The present invention is generally directed to systems, apparatus, and methods associated with data acquisition, using acquired data for imaging or modeling, and/or use of an image or model for various purposes. Data acquisition may include collection of image data and optionally collection of position data associated with the image data. For example, the image data may be collected or captured using camera, radar, and/or other technologies. The position data may be derived from the image data and/or collected independently from the image data at the same time as or at a different time as the image data. For example, the position data may be acquired using lasers, electronic distance measuring devices, Global Positioning System (GPS) sensor technology, compasses, inclinometers, accelerometers, inertial measurement units and/or other devices. The position data may represent position of a device used to acquire the image data and/or position of representations in the image data. The position data may be useful in processing the image data to form an image or model.

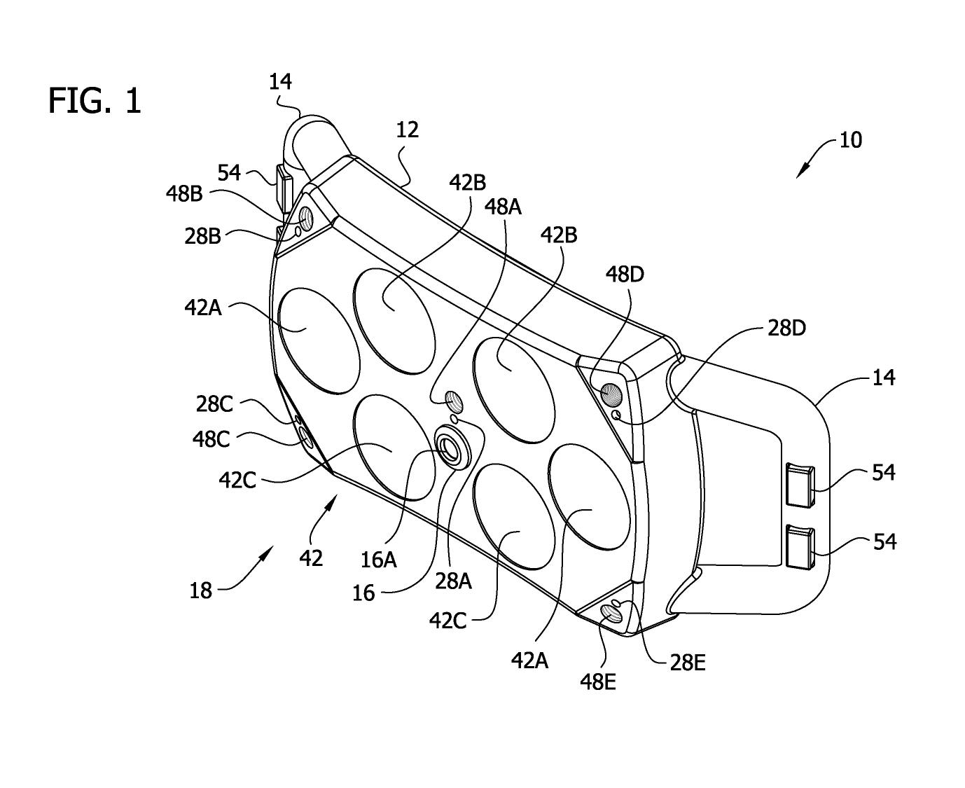

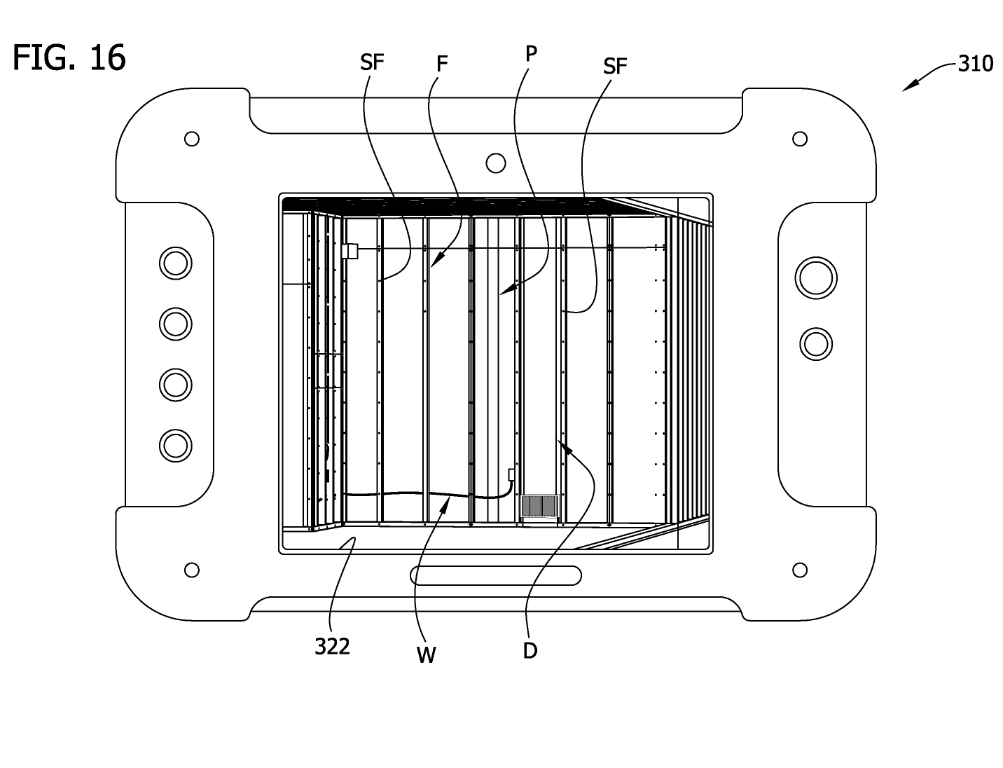

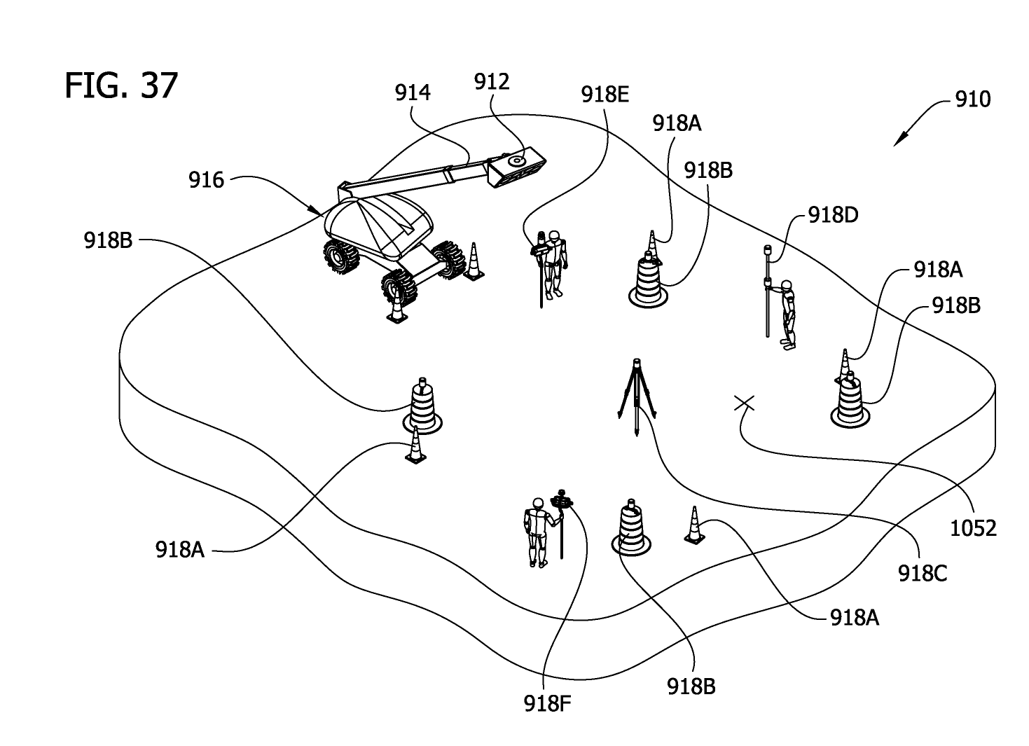

Various embodiments of apparatus are disclosed herein for use in acquiring image data and/or position data, in generating an image or model, and/or using such an image or model. In some embodiments, the apparatus may be referred to as “scanners,” “scanning devices” or “pods.” For example, first, second and third embodiments of scanners according to the present invention are illustrated in FIGS. 1, 12, and 14, respectively. Additional embodiments of scanners are shown in FIGS. 15, 22, 29, 35, and 36. Other embodiments of scanners are shown in FIGS. 37, 64, 66, and 70. These scanners are illustrated and described by example and without limitation. Scanners having other configurations may be used without departing from the scope of the present invention. Scanners may be used on their own or in combination with other apparatus for data acquisition, image or model generation, and/or use of an image or model. The scanners may be suited for use in various applications and for indoor and/or outdoor use. For example, in use, some of the scanners may be supported by hand, other scanners may be supported on a vehicle, and still other scanners may be supported on a support such as a boom, tripod, or pole. Other ways of supporting scanners may be used without departing from the present invention. Generally speaking, a scanner will include hardware necessary for one or more types of data acquisition, such as image data and/or position data acquisition. The scanners may or may not have the capability of processing the acquired data for building an image or model. The scanners may be part of a system which includes a remotely positioned processor which may be adapted for receiving and processing the data acquired by the scanner for processing the data (e.g., for generating an image or model). Moreover, the scanners may or may not be adapted for using the acquired data and/or an image or model generated from the acquired data. Further detail regarding configurations and operation of various embodiments of scanners will be provided below.

As will become apparent, in some embodiments, scanners according to the present invention may be used for various types of scans. The term scan as used herein means an acquisition of data or to acquire data. The data acquired may include image data and/or position data. Position data can include orientation, absolute global position, relative position or simply distances. The data may be collected for purposes of building an image or model and/or for referencing an image or model. In a scan, data may be collected, for example, by a camera, a radar device, an inclinometer, a compass, and/or other devices, as will become apparent. In an individual scan, one or more types of image data and/or position data may be collected. Image data and position data can be collected simultaneously during a single scan, at different times during a single scan, or in different scans. A scan may include collection of data from a single position, data from one or more samples of multiple samples acquired at a single position and/or perspective and/or multiple positions or perspectives.

Scanners according to the present invention may be adapted for mass data capture including spatial data in two or three dimensions. For example, mass data may be acquired using a camera and/or radar device. This type of data acquisition enables rapid and accurate collection of a mass of data including localized data and positional relationship of the localized data with respect to other localized data in the mass of data. Mass data capture may be described as capture of a data point cloud including points of data and two-dimensional or three-dimensional spatial information representing position of the data points with respect to each other. Mass data capture as used herein is different than collection of individual data points which, for some types of analysis, may need to be manually compared to each other or be assembled into point clouds via processing. For example, some types of surveying include collection of individual data points. A total station may collect individual data points (elevation at certain latitude and longitude, three dimensional Cartesian coordinates in a coordinate system that is arbitrarily created for the instant project, or in a pre-existing coordinate system created by other parties) as it records successive positions of a prism. The individual data points need to be assembled manually or via processing to form a map of elevation or topography. Even after assembly of the data points, the quality of the map is dependent on the density of measured individual data points and the accuracy of the estimation by interpolation or extrapolation to fill gaps among the collected data points. In mass data acquisition methods, such as photography and radar, a vastly greater number of data points are collected in addition to their position with respect to each other. Accordingly, mass data collection provides a powerful, potentially more complete and accurate means for mapping and image or model generation. The data richness and precision of images including two-dimensional and three-dimensional maps and models generated according to the present invention opens the door to advanced virtual analysis and manipulation of environments, structures, and/or objects not previously possible. Various types of virtual analysis and manipulation will be described in further detail below.

According to the present invention, image data may be collected in various settings and for various reasons. For example, image data may be acquired in indoor and/or outdoor environments for inspection, documentation, mapping, model creation, reference, and/or other uses. In an indoor environment, the image data may be acquired for mapping a building, building a two-dimensional image or three-dimensional model of a building, inspecting various aspects of a building, planning modifications to a building, and/or other uses, some examples of which will be described in further detail below. In an outdoor environment, the image data may be acquired for surveying, mapping buildings, mapping utilities infrastructure, mapping surveying monuments, inspecting roadways, inspecting utilities infrastructure, documenting incidents or violations, and other uses, some examples of which will be described in further detail below. Collection of the image data may be used for generating an image or model and/or for referencing an image and/or model. The image data may be used for purposes other than those described without departing from the scope of the present invention.

An image as referred to herein means a representation of collected image data. An image may be an electronic representation of collected image data such as a point cloud of data. An image may exist in a non-displayed or displayed virtual electronic state or in a generated (e.g., formed, built, printed, etc.) tangible state. For example, a camera generates photographs (photos) and/or video, which are electronic images from the camera which may be stored and/or displayed. An image may include multiple types of image data (e.g., collected by a camera and radar device) or a single type of image data. An image may be generated using image data and optionally position data. A composite image or combined image is a type of an image which may include image data of multiple types and/or image data collected from multiple positions and/or perspectives. A composite or combined image may be a two-dimensional image or three-dimensional image. A model as used herein is a type of an image and more specifically a three-dimensional composite image which includes image data of multiple types and/or image data collected from multiple positions and/or perspectives. The type of image used in various circumstances may depend on its purpose, its desired data richness and/or accuracy, and/or the types of image data collected to generate it.

Data acquisition, image or model generation, and/or use of an image or model may be performed with respect to a volume including a surface and subsurface. For example, a volume may include a portion of the earth having a surface (e.g., surface of soil, rock, pavement, etc.) and a subsurface (e.g., soil, rock, asphalt, concrete, etc.) beneath the surface. Moreover, a volume may refer to a building or other structure having a surface or exterior and a subsurface or interior. Moreover, a building or structure may include partitions such as walls, ceilings, and/or floors which define a surface of a volume and a subsurface either within the partition or on a side of the partition opposite the surface. Data acquisition devices such as cameras and lasers may be useful for acquiring image data and/or position data in the visible realm of a surface of a volume. Data acquisition devices such as radar devices may be useful in acquiring image data and/or position data in the visible and/or non-visible realms representative of a surface or subsurface of a volume.

In one aspect of the present invention, image data and/or position data may be acquired by performing a scan with respect to a target. A target as used herein means an environment, structure, and/or object within view of the data collection apparatus when data is collected. For example, a target is in view of a data collection apparatus including a camera if it is within view of the lens of the camera. A target is in view of a data collection apparatus including a radar device if it is within the field in which radar radio waves would be reflected and returned to the data collection apparatus as representative of the target. A target may be an environment, structure, and/or object which is desired to be imaged. A target may be an environment, structure, and/or object which is only part of what is desired to be imaged. Moreover, the target may be an environment, structure, or object which is not desired to be imaged or not ultimately represented in the generated image but is used for generating the image. A target may include or may be a reference which facilitates processing of image data of one or more types and/or from one or more positions or perspectives into an image or model. A target may be on or spaced from a surface of a volume, in a subsurface of a volume, and/or extend from the surface to the subsurface.

According to the present invention, references included in the image data and/or position data may be used to correlate collected image data and for referencing images or models generated with the image data. For example, references may be used in correlating different types of image data (e.g., photography and radar) and/or correlating one or more types of image data gathered from different positions or perspectives. A reference may be environmental or artificial. References may be surface references, subsurface references, or references which extend between the surface and subsurface of a volume. A reference may be any type of environment, structure, or object which is identifiable among its surroundings. For example, surface references may include lines and/or corners formed by buildings or other structure; objects such as posts, poles, etc.; visible components of utilities infrastructure, such as junction boxes, hydrants, electrical outlets, switches, HVAC registers, etc.; or other types of visible references. Subsurface references may include framing, structural reinforcement, piping, wiring, ducting, wall sheathing fasteners, and other types of radar-recognizable references. References may also be provided in the form of artificial targets positioned within the field of view of the scan for the dedicated purpose of providing a reference. These and other types of references will be discussed in further detail below. Other types of references may be used without departing from the scope of the present invention.

Although a variety of types of references may be used according to the present invention, in certain circumstances use of subsurface references may be desirable. In general, subsurface references may more reliably remain in position over the course of time. For example, in an outdoor setting, items such as posts, signs, roadways, and even buildings can change over time such as by being moved, removed, or replaced. Subsurface structure such as underground components of utilities infrastructure may be more reliable references because they are less likely to be moved over time. Likewise, in an indoor setting, possible surface references such as furniture, wall hangings, and other objects may change over time. Subsurface structure such as framing, wiring, piping, ducting, and wall sheathing fasteners are less likely to be moved over time. Other references which may reliably remain in place over time include references which extend from the surface to the subsurface, such as components of utilities infrastructure (e.g., junction boxes, hydrants, switches, electrical outlets, registers, etc.). Surface and subsurface references which have greater reliability for remaining in place over time are desirably used as references. For example, subsurface references may be used as references with respect to imaging of environments, structure, and/or objects on the surface because the subsurface references may be more reliable than surface references.

In an aspect of the present invention, redundancy or overlap of types of data acquired, both image data and position data, can be useful for several reasons. For example, redundant and/or overlapping collected data may be used to confirm data accuracy, resolve ambiguities of collected data, sharpen dimensional and perspective aspects of collected data, and for referencing for use in building the collected data into an image or model. For example, redundant or overlapping image data representative of a surface may be collected using a camera and a radar device. Redundant or overlapping position data may be derived from photo and radar data and collected using lasers, GPS sensors, inclinometers, compasses, inertial measurement units, accelerometers, and other devices. This redundancy or overlap depends in part on the types of devices used for data collection and can be increased or decreased as desired according to the intended purpose for the image or model and/or the desired accuracy of the image or model. The redundancy in data collection also enables a scanner to be versatile or adaptive for use in various scenarios in which a certain type of data collection is less accurate or less effective.

As will become apparent, aspects of the present invention provide numerous advantages and benefits in systems, apparatus, and methods of data acquisition, generation of images or models, and/or use of images or models. Apparatus according to the present invention are capable of precise mass data capture above and below surfaces of a volume in indoor and outdoor settings, and are adaptive to various environments found in those settings. The variety and redundancy of collected data enables precise two-dimensional and three-dimensional imaging of visible and non-visible environments, structures, and objects. The collected data can be used for unlimited purposes, including mapping, modeling, inspecting, planning, referencing, and positioning. The data and images may be used onsite and/or offsite with respect to the subject matter imaged. In some uses, a model may be representative of actual conditions and/or be manipulated to show augmented reality. In another aspect, a relatively unskilled technician may perform the scanning necessary to build a precise and comprehensive model such that the model provides a remote or offsite “expert” (person having training or knowledge in a pertinent field) with the information necessary for various inspection, manufacturing, designing, and other functions which traditionally required onsite presence of the expert.

The features and benefits outlined above and other features and benefits of the present invention will be explained in further detail below and/or will become apparent with reference to various embodiments described below.

Referring now to FIGS. 1-4, a scanner or pod of the present invention is designated generally by the reference number 10. In general, the scanner 10 includes various components adapted for collecting data, processing the collected data, and/or displaying the data as representative of actual conditions and/or augmented reality. The scanner 10 will be described in the context of being handheld and used for imaging of interior environments such as inside buildings and other structures. However, it will be appreciated that the scanner 10 may be used in outdoor environments and/or supported by various types of support structure, such as explained in embodiments described below, without departing from the scope of the present invention.

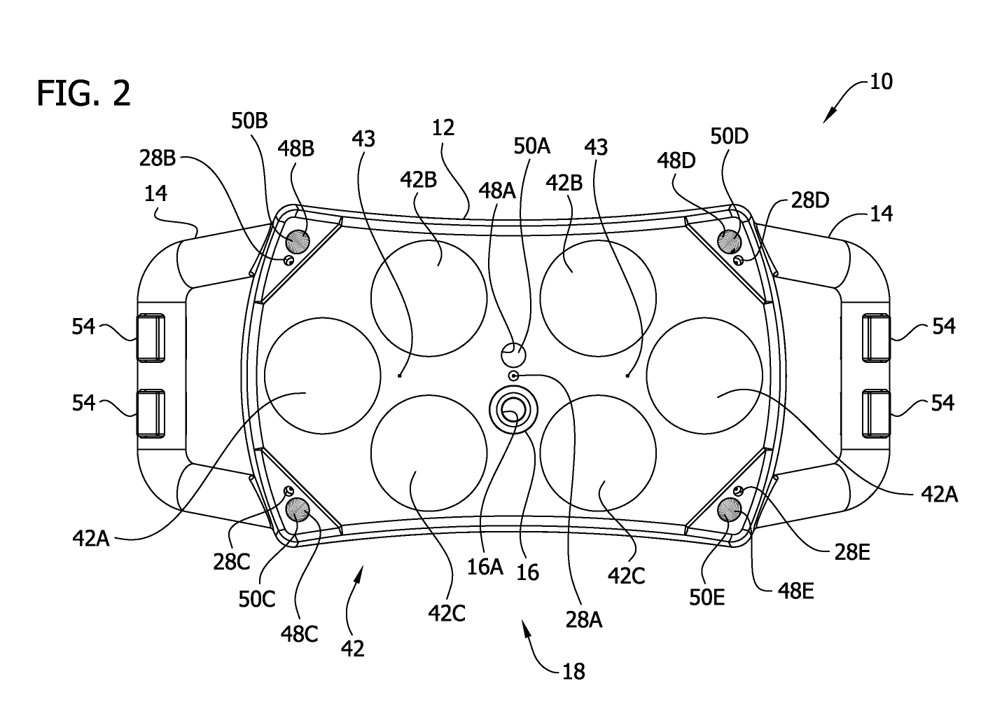

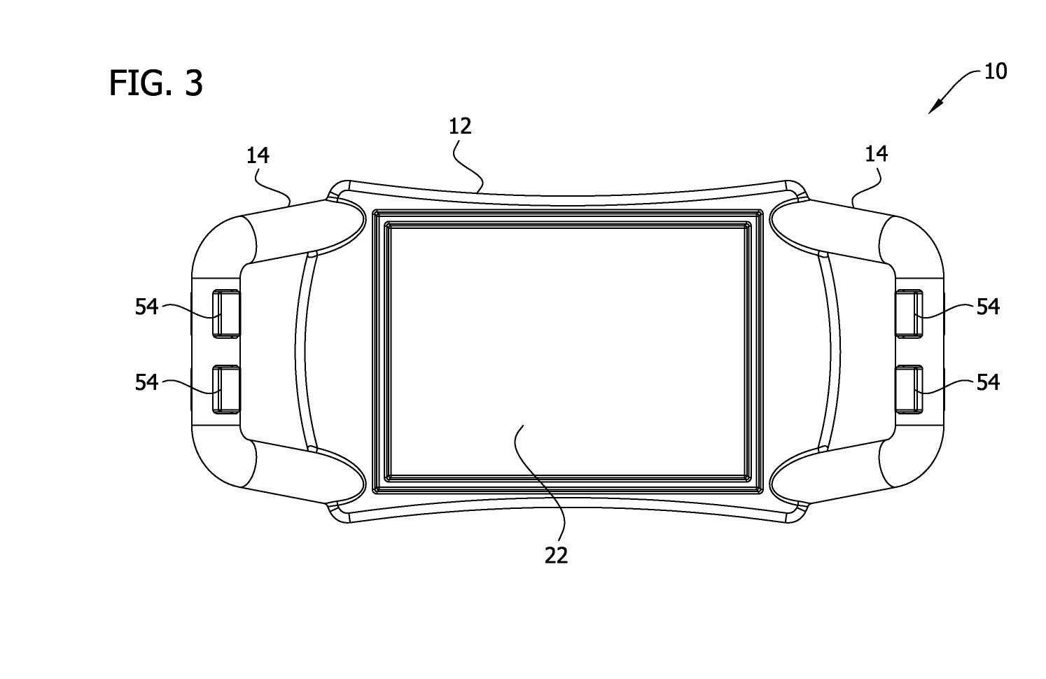

The scanner 10 includes a housing 12 including a front side (FIG. 2) which in use faces away from the user, and the scanner includes a rear side (FIG. 3) which in use faces toward the user. The scanner 10 includes left and right handles 14 positioned on sides of the housing 12 for being held by respective left and right hands of a user. The housing 12 is adapted for supporting various components of the scanner 10. In the illustrated embodiment, several of the components are housed within or enclosed in a hollow interior of the housing 12.

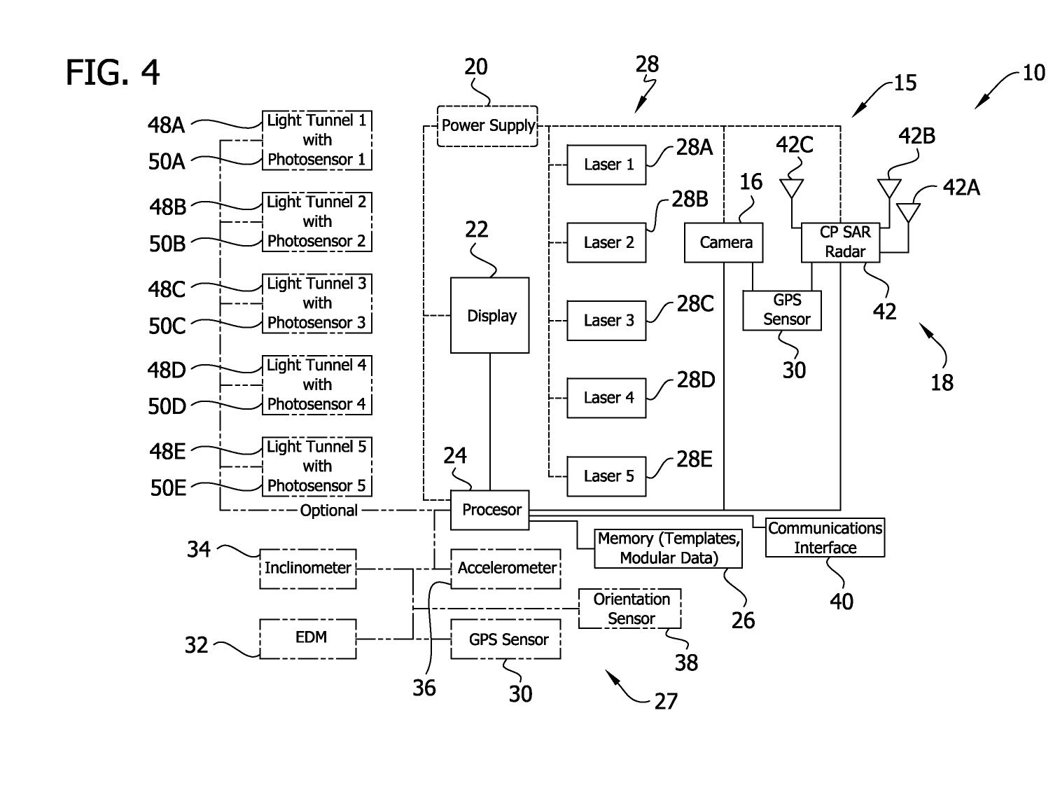

A block diagram of various components of the scanner 10 is shown in FIG. 4. The scanner 10 may include image data collection apparatus 15 including a digital camera 16 and a radar device 18. The scanner 10 may also include a power supply 20, a display 22, and a processor 24 having a tangible non-transitory memory 26. Moreover, the scanner 10 may also include one or more position data collection apparatus 27 including a laser system 28 and one or more GPS sensors 30 (broadly “global geopositional sensor), electronic distance measuring devices 32, inclinometers 34, accelerometers 36, or other orientation sensors 38 (e.g., compass). Geopositional sensors other than the GPS sensors 30 may be used in place of or in combination with a GPS sensor, including a radio signal strength sensor. The scanner 10 may also include a communications interface 40 for sending and receiving data. It will be understood that various combinations of components of the scanner 10 described herein may be used, and components may be omitted, without departing from the scope of the present invention. As explained in further detail below, the data collected by the image data collection apparatus 15 and optionally the data collected by the position data collection apparatus 27 may be processed by the processor 24 according to instructions in the memory 26 to generate an image which may be used onsite and/or offsite with respect to the subject matter imaged.

As shown in FIG. 2, a lens 16A of the camera and antenna structure 42 of the radar device 18 are positioned on the front side of the scanner 10. In use, the lens 16A and antenna structure 42 face away from the user toward a target. The digital camera 16 is housed in the housing 12, and the lens 16A of the camera is positioned generally centrally on the rear side of the housing. The lens 16A includes an axis which is oriented generally away from the housing 12 toward the target and extends generally in the center of the field of view of the lens. The digital camera 16 is adapted for receiving light from the target and converting the received light to a light signal. The camera 16 may be capable of capturing image data in the form of video and/or still images. More than one camera may be provided without departing from the scope of the present invention. For example, a first camera may be used for video and a second camera may be used for still images. Moreover, multiple cameras may be provided to increase the field of view and amount of data collected in a single sample in video and/or still image data capture.

The radar device includes antenna structure 42 which is adapted for transmitting radio waves (broadly, “electromagnetic waves”) and receiving reflected radio waves. In the illustrated embodiment, the antenna structure 42 includes two sets of antennas each including three antennas 42A-42C. The antennas 42A-42C are arranged around and are positioned generally symmetrically with respect to the lens 16A of the camera 16. Each set of antennas has an apparent phase center 43. The antennas 42A-42C are circularly polarized for transmitting and receiving circularly polarized radio waves. Each set of antennas includes a transmitting antenna 42A adapted for transmitting a circularly polarized radio waves toward the target and two receiving antennas 42B, 42C adapted for receiving reflected circularly polarized radio waves. Desirably, the transmitting antennas 42A are adapted for transmitting radio waves in frequencies which reflect off of surface elements of the target and/or subsurface elements of the target. For each scan, the radar is cycled through a large number (e.g., 512) stepped frequencies of the radio waves to improve the return reflection in different circumstances. In one embodiment, the frequencies may range from about 500 MHz to about 3 GHz. One of the receiving antennas 42B of each set is adapted for receiving reflected radio waves having clockwise (right-handed) polarity, and the other of the receiving antennas 42C is adapted for receiving reflected radio waves having counterclockwise (left-handed) polarity. Other types of antenna structure may be used without departing from the scope of the present invention. For example, more or fewer antennas may be used, and the antennas may or may not be circularly polarized, without departing from the scope of the present invention.

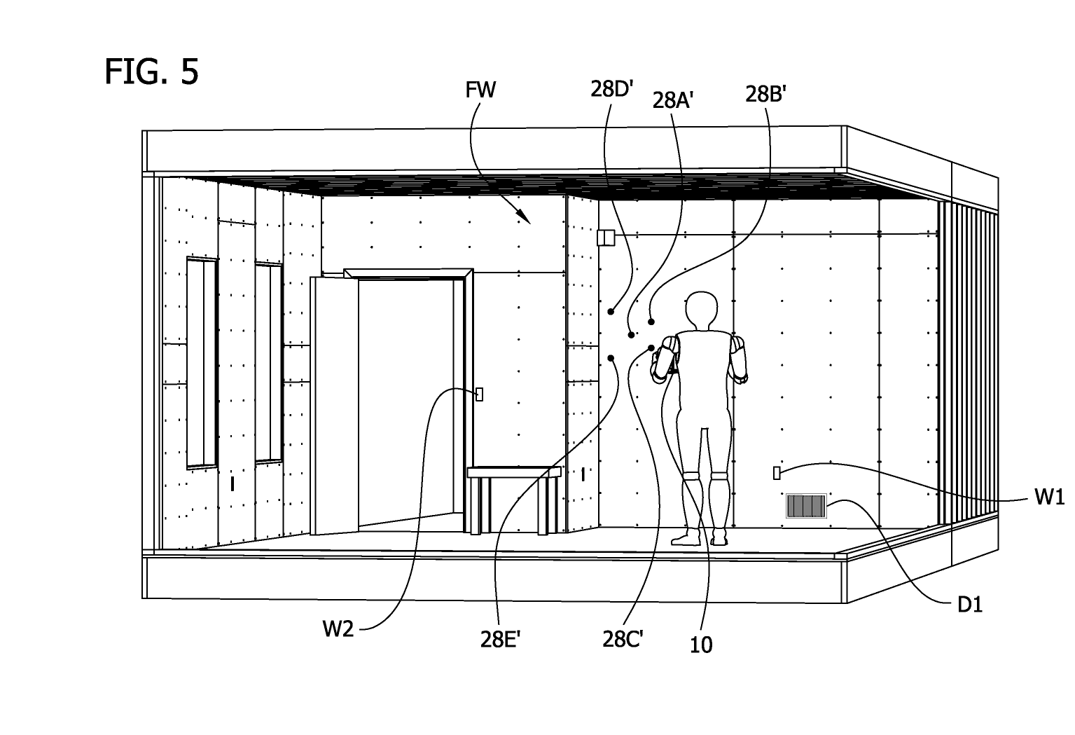

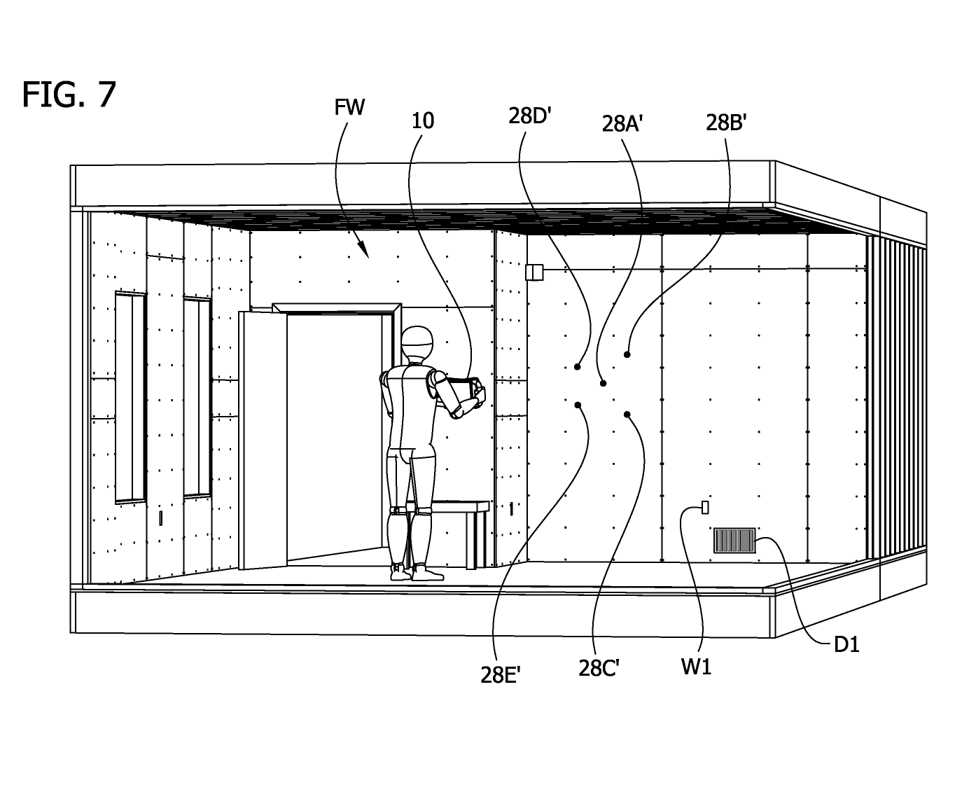

The scanner 10 includes a laser system 28 adapted for projecting laser beams of light in the direction of the target. In the illustrated embodiment, the laser system 28 includes five lasers, including a central laser 28A and four peripheral lasers 28B-28E. The lasers 28A-28E are adapted for generating a laser beam of light having an axis and for illuminating the target. The orientations of the axes of the lasers 28A-28E are known with respect to each other and/or with respect to an orientation of the axis of the lens 16A of the digital camera 16. The central laser 28A is positioned adjacent the lens 16A and its axis is oriented generally in register with or parallel to the axis of the lens. The central laser 28A may be described as “bore sighted” with the lens 16A. Desirably, the central laser 28A is positioned as close as practically possible to the lens 16A. The axes of the peripheral lasers 28B-28E are oriented to be diverging or perpendicular in radially outward directions with respect to the central laser 28A. The arrangement of the lasers 28A-28E is such that an array of dots 28A′-28E′ corresponding to the five laser beams is projected onto the target. The array of dots 28A′-28E′ is illustrated as having different configurations in FIGS. 5 and 7, based on the position of the scanner 10 from the target and the perspective with which the scanner is aimed at the target. The dots 28A′-28E′ have a known pattern or array due to the known position and orientation of the lasers 28A-28E with respect to the camera lens 16A and/or with respect to each other. Desirably, the pattern is projected in view of the lens 16A, and the camera 16 receives reflected laser beams of light from the target. As will become apparent, augmentations of the pattern or array of the laser beams as reflected by the target may provide the processor 24 with position data usable for determining distance, dimension, and perspective data. Fewer lasers (e.g., one, two, three, or four lasers) or more lasers (e.g., six, seven, eight, nine, ten, or more lasers) may be used without departing from the scope of the present invention. If at least two lasers (e.g., any two of lasers 28A-28E) are provided and it can be assumed the incident surface is flat, distance of the scanner 10 (i.e., the camera and radar device) from the points of reflection may be estimated by comparison of the spacing of the projected dots (28A′-28E′) to the spacing of the lasers from which the laser beams originate and considering the known orientations of the lasers with respect to each other or the camera lens 16A. If at least three lasers (e.g., any three of lasers 28A-28E) are provided, perspective can be determined based on a similar analysis. The distance between the first and second, second and third, and first and third dots (e.g., three of dots 28A′-28E′) would be compared to the spacing between the corresponding lasers. If one or more of the lasers 28A-28E has an axis which diverges from the axis of the camera lens 16A sufficiently to be out of view of the lens, one or more additional cameras may be provided for capturing the reflection points of those lasers.

In the illustrated embodiment, the laser system 28 is adapted for measuring distance by including light tunnels 48A-48E and associated photosensors 50A-50E (FIG. 4). More specifically, the laser system 28 includes five light tunnels 48A-48E and five photosensors 50A-50E each corresponding to a respective laser 28A-28E. The photosensors 50A-50E are positioned in the light tunnels 48A-48E and are positioned with respect to their respective laser 28A-28E for receiving a laser beam of light produced by the laser and reflected by the target. The photosensors 50A-50E produce a light (or “laser beam”) signal usable by the processor 24 to determine distance from the laser system 28 to the reflection point (e.g., dots 28A′-28E′) on the target. The photosensors 50A-50E are shielded from reflected light from lasers other than their respective laser by being positioned in the light tunnels 48A-48E. The light tunnels 48A-48E each have an axis which is oriented with respect to the axis of its respective laser 28A-28E for receiving reflected light from that laser. In response to receiving the light from their associated lasers 28A-28E, the photosensors 50A-50E generate distance signals for communicating to the processor 24. Accordingly, the lasers 28A-28E and photosensors 50A-50E are adapted for measuring the distance to each laser reflection point on the target. The distance measured may represent the distance from the radar device 18 and/or the lens 16A of the camera 16 to the point of reflection on the target. The combination of the lasers 28A-28E and the photosensors 50A-50E may be referred to as an electronic distance measuring (EDM) device 32. Other types of EDM devices may be used without departing from the scope of the present invention. For example, the camera 16 may be adapted for measuring distance from reflection points of the lasers, in which case the EDM device 32 may comprise the camera and lasers 28A-28E. Other types of lasers may be used, and the laser system 28 may be omitted, without departing from the scope of the present invention. For example, one or more of the lasers 28A-28E may merely be “pointers,” without an associated photosensor 50A-50E or other distance measuring feature.

Other position data collection apparatus 27 including the GPS sensors 30, inclinometer 34, accelerometer 36, or other orientation sensors 38 (e.g., compass) may be used for providing position or orientation signals relative to the target such as horizontal position, vertical position, attitude and/or azimuth of the antenna structure 42 and digital camera lens 16A. For example, the GPS sensors 30 may provide a position signal indicative of latitude, longitude and elevation of the scanner. The position indication by the GPS sensors 30 may be as to three dimensional Cartesian coordinates in a coordinate system that is arbitrarily created of the particular project, or in a pre-existing coordinate system created by other parties. The inclinometers 34, accelerometers 36, or other orientation sensors 38 may provide an orientation signal indicative of the attitude and azimuth of the radar structure 42 and camera lens 16A. For example, a dual axis inclinometer 34 capable of detecting orientation in perpendicular planes may be used. Other orientation sensors 38 such as a compass may provide an orientation signal indicative of the azimuth of the radar structure 42 and camera lens 16A. Other types of position data collection apparatus 27 such as other types of position or orientation signaling devices may be used without departing from the scope of the present invention. These position data apparatus 27 may be used at various stages of use of the scanner 10, such as while data is being collected or being used (e.g., viewed on the display).

Referring to FIG. 3, the display 22 is positioned on the rear side of the housing 12 for facing the user. The display 22 is responsive to the processor 24 for displaying various images. For example, the display 22 may be a type of LCD or LED screen. The display 22 may serve as a viewfinder for the scanner 10 by displaying a video image or photographic image from the camera 16 representative of the direction in which the camera and radar device 18 are pointed. The view shown on the display 22 may be updated in real time. In addition, the display device 22 may be used for displaying an image or model, as will be described in further detail below.

The display device 22 may also function as part of a user input interface. For example, the display device 22 may display information related to the scanner 10, including settings, menus, status, and other information. The display 22 may be a touch screen responsive to the touch of the user for receiving information from the user and communicating it to the processor 24. For example, using the user input interface, the user may be able to select various screen views, operational modes, and functions of the scanner. The display 22 may be responsive to the processor 24 for executing instructions in the memory 26 for displaying a user interface. The user input interface may also include buttons, keys, or switches positioned on the housing, such as the buttons 54 provided by way of example on the front and/or rear side of the handles 14, as shown in FIGS. 1-3. Moreover, the user input interface may include indicators other than the display 22, such as lights (LEDs) or other indicators for indicating status and other information. Moreover, the user input interface may include a microphone for receiving audible input from the user, and may include a speaker or other annunciator for audibly communicating status and other information to the user.

The communications interface 40 (FIG. 4) may be adapted for various forms of communication, such as wired or wireless communication. The communications interface 40 may be adapted for sending and/or receiving information to and from the scanner 10. For example, the communications interface 40 may be adapted for downloading data such as instructions to the memory 26 and/or transmitting signals generated by various scanner components to other devices. For example, the communications interface 40 may include sockets, drives, or other portals for wired connection to other devices or reception of data storage media. The communications interface 40 may be adapted for connection to peripheral devices including additional processing units (e.g., graphical processing units) and other devices. As another example, the communications interface 40 may be adapted for wireless and/or networked communication such as by Bluetooth, Wi-Fi, cellular modem and other wireless enabling technologies.

The processor 24 is in operative communication (e.g., via interconnections electronics) with other components (e.g., camera 16, radar device 18, laser system 28, GPS sensor 30, inclinometer 34, etc.) of the scanner 10 for receiving signals from those components. The processor 24 executes instructions stored in the memory 26 to process signals from the components, to show images on the display 22, and to perform other functions, as will become apparent. Although the processor 24 is illustrated as being part of the scanner 10, it will be understood that the processor may be provided as part of a device which is different than the scanner, without departing from the scope of the present invention. Moreover, although the scanner 10 includes a processor 24, the function of processing the collected data to form images may be performed by a different processor external to the scanner, without departing from the scope of the present invention. For example, the processor 24 of the scanner 10 may be operative to control images shown on the display, receive user input, and to send signals via the communications interface 40 to a different processor (e.g., an offsite processor) which uses the collected data for imaging. The processed data may be transmitted to the scanner 10 via the interconnections interface 40 for use on the scanner such as viewing on the display 22.

The scanner 10 provides the capability of generating a precise model of scanned subject matter while removing the need to physically access each point at which a measurement is required. Scanning replaces field measurements with image measurements. If something is within the field of view of the camera 16 and/or the radar device 18, the exact location of that something can be determined by processing the image data generated by the camera and/or radar device. The scanner 10 of the present invention permits field measurements to be done virtually in the scanner or another processing device (e.g., offsite computer). Scanning reduces onsite time required for measurements. As explained in further detail below, overlapping or redundant data collected by the various components of the scanner 10 enables the scanner to resolve ambiguities and sharpen dimension and perspective aspects for generation of a precise model. Scanning with scanners of the present invention provides a fast, cost-effective, accurate means to create maps and models of the scanned environment and is an alternative to manual measurement and traditional surveying techniques.

In use, the scanner 10 may function as an imaging or modeling device such as for modeling environments in indoor or outdoor settings, structures or parts of structures such as buildings, and/or objects such as persons and apparatus. For indoor environment modeling, the scanner 10 may be used for a plurality of functions, such as: 1) mapping building and/or room dimensions; 2) modeling partitions including walls, ceilings, floors; 3) modeling angles between surfaces such as partitions; 4) mapping locations of lines that are defined by the intersections of surfaces, such as between two adjoining walls, a wall and a floor, around a door frame or window; 5) fitting simple or complex shapes to match surfaces and lines; 6) documenting condition of the environments in structures including structural members, reinforcing members, and utilities infrastructure; and 7) preparing models having sufficient detail such that an offsite expert can use the model for various purposes including inspection, construction planning, and interior design. It will be understood that the scanner 10 may be used in various other ways and for generating other types of models without departing from the scope of the present invention. For example, the scanner may be used to model not just interior environments but also the exterior of the structure and/or various other parts of the structure or the entirety of the structure, including surface and subsurface aspects.

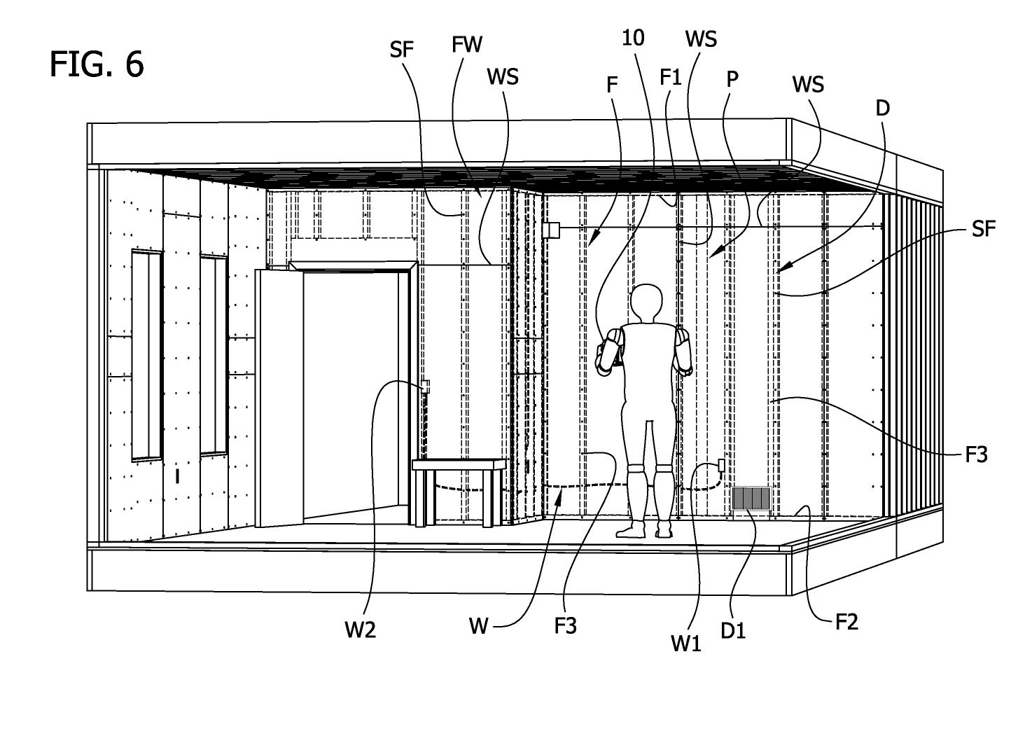

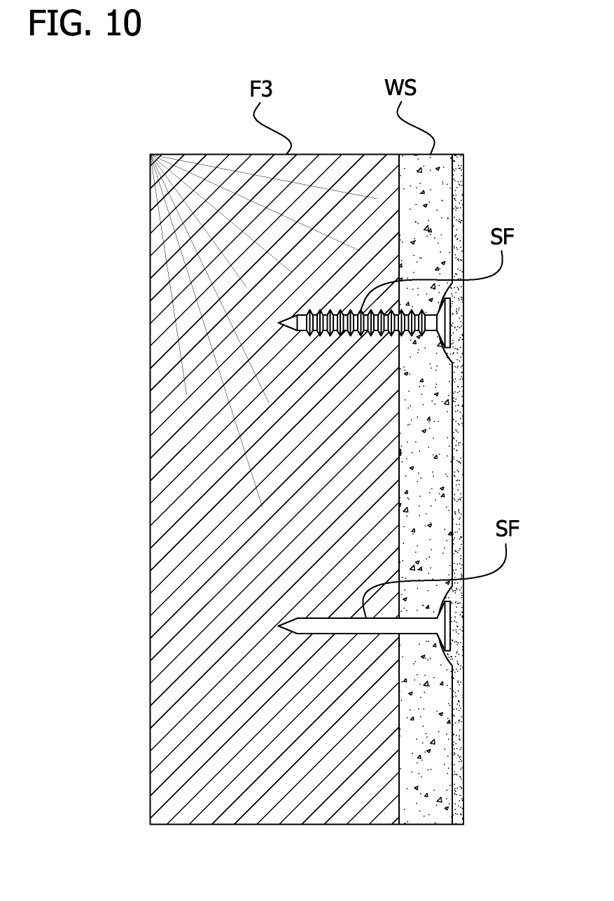

Performance of an example scan will now be described with respect to FIGS. 5-7, which illustrate a user holding the scanner 10 in a room including a far wall FW. In FIG. 6, interior elements and aspects of the wall FW are shown in phantom. For example, the wall FW includes framing F, ducting D, wiring W, and piping P. The framing F includes a various wooden framing members, including a header F1 and footer F2 and studs F3 extending therebetween. The ducting D includes an HVAC register D1 for emitting conditioned air into the room. The wiring W includes an electrical outlet W1 and a switch E2. The piping P is shown as extending vertically from the top of the wall FW to the bottom of the wall. Moreover, as shown in FIG. 5, the wall FW includes subsurface aspects such as lines defining outlines of wall sheathing WS (e.g., sheetrock or drywall) and wall sheathing fasteners SF (e.g., screws or nails). For convenience of illustration, the room is shown throughout the views as not including final wall finishings, such as mud, tape, and paint or wallpaper. It will be understood that in most cases, such a wall would include such finishings, thus making the outlines of the sheathing members WS and sheathing fasteners SF subsurface elements of the wall FW. For example, see FIG. 10, in which wall sheathing WS is secured to a stud F3 by fasteners SF which are covered by a layer of finishing material. As will become apparent, the components of the wall mentioned above and/or other elements of the room or wall may be used as references.

To perform a scan, the scanner 10 is aimed at a target, and the various data acquisition apparatus 15, 27 are activated to collect image data and position data. A scan may be performed in such a way to collect image and position data from one or more positions and perspectives. For example, as shown in FIG. 5, the scanner may be aimed at a wall FW (target) which is desired to be modeled. The aim of the scanner 10 may be estimated by the user by using the display 22 as a viewfinder. The display 22 may show a live video feed representative of the view of the camera 16 and approximating the aim of the radar device 18. In some cases, a scan from a single position/perspective may collect sufficient data for generation of a two-dimensional or even three-dimensional model, depending on the apparatus of the scanner used to collect the data. For example, because the radar device 18 includes two sets of transmitting and receiving antennas 42A-42C, the radar device would provide two-dimensional image data. Coupled with positional data this image data may be sufficient to form a three-dimensional image. However, in most cases, it will be desirable to collect image and position data from several positions and perspectives with respect to a target so that a three-dimensional model having greater resolution may be generated. For example, the user may move the scanner 10 by hand to various positions/perspectives with respect to the target and permit or activate the data collection apparatus to collect image data and position data at the various positions/perspectives. As an example, the user is shown holding the scanner 10 in a position and perspective in FIG. 7 which is different than the position and perspective of FIG. 5. This may be referred to as creating a “synthetic aperture” with respect to the target. In other words, the various positions and perspectives of the scanner 10 create an “aperture” which is larger than an aperture from which the camera 16 and radar device 18 would collect data from a single position/perspective. The desired synthetic aperture for a particular scan likely depends on the intended use of a model to be generated using the collected data, the desired precision of the model to be generated, and/or the components of the scanner available for collecting data.

In one example, a scan for mapping an interior of a room may include the steps listed below.

1. The scanner 10 is pointed at the target (e.g., surface or surfaces) to be mapped. For example, the scanner 10 may be pointed at a wall such as shown in FIG. 5. Actuation of a button or switch 54 causes the lasers 28A-28E to power on. A live video image is shown on the display 22 indicative of the aim of the camera 16. The projected dots 28A′-28E′ of the lasers 28A-28E on the target are visible in the video image. Actuation of the same or different button or switch 54 causes the camera 16 to capture a still image. If the lasers 28A-28E are distance measuring units, as in the illustrated embodiment, the distances are then measured by the respective photosensors 50A-50E and recorded for each laser. Simultaneously, position data is recorded such as supplied by the GPS sensor 30, inclinometer 34, accelerometer 36, inertial measurement unit 38, or other orientation indicating device (e.g., compass).

2. The scanner 10 is then moved to a different position (e.g., see FIG. 7) for capturing the next still image. The display 22 shows a live video feed of the view of the camera 16. The display 22 may assist the user in positioning the scanner 10 for taking the next still image by superimposing the immediately previously taken still image on the live video feed. Accordingly, the user may position the scanner 10 so that a substantial amount (e.g., about 80%) of the view of the previous still image is captured in the next still image. When the scanner 10 is properly positioned, the scanner 10 collects another still image and associated position data, as in the previous step. The process is repeated until all of the surfaces to be mapped have been sufficiently imaged.

3. After the still image capture process has been completed, the radar device 18 may be activated to collect radar image data. The display 22 shows a live video feed of the approximate aim of the radar device 18. An on-screen help/status system helps the user “wave” the scanner 10 in a methodical way while maintaining the aim of the radar device 18 generally toward the target to capture radar data as the scanner is moved to approximate a synthetic aperture. The radar image data represents objects that exist behind the first optically opaque surface. The software in the scanner 10 records how much of the surfaces to be penetrated have been mapped and indicates to the user when sufficient synthetic aperture data has been captured.

The various components of the scanner 10 such as the radar device 18, laser system 28, digital camera 16, and display 22 may serve various functions and perform various tasks during different steps of a scan.

It will be understood the steps outlined above are provided by way of example without limitation. Scans may be performed in other fashions, including other steps, and the steps may be performed in other orders, without departing from the scope of the present invention. For example, photographic and radar image data may be collected simultaneously, in alternating intervals, in overlapping intervals, or at different times. Position data may be collected with one or more of the position data collection apparatus during all or one or more parts of a scan.

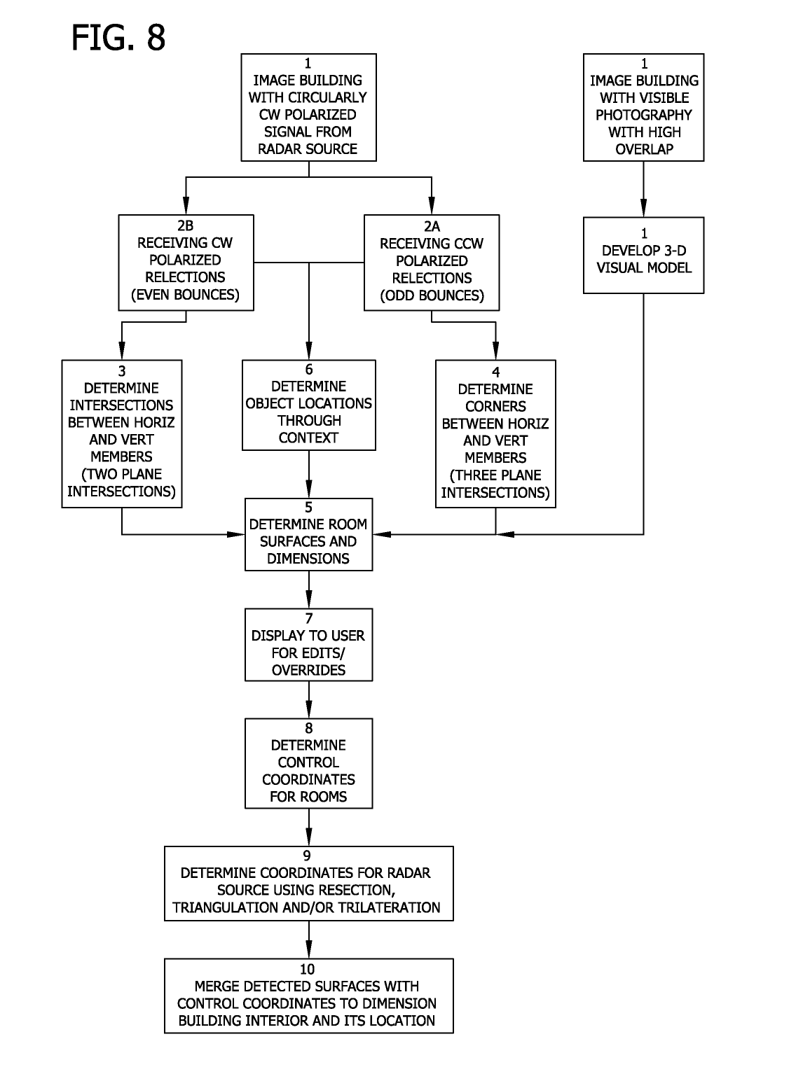

In an example use of the scanner 10, it may be desired to model an interior of a room of a plurality of rooms, such as an entire floor plan of a building. Example steps of such a scan and use of collected data are provided below including scanning using the radar device and digital camera. Transmission and reception of radio waves is described, along with processing (optionally including processing the radar image data with photo image data) for forming a model. The steps below are illustrated in the flow chart of FIG. 8.

1. Walls, floor, and/or ceilings of rooms are scanned using radar radio waves that both penetrate and reflect from interior surfaces of a room (first surfaces). In addition, the room interior may scanned with visible photography with high overlap (e.g., about 70% or more overlap) so that a model of the interior can be developed using the photographic images. Scanning steps such as described above may be used.

2. With respect to the radar imaging in (1), when circularly polarized radio waves are emitted, the received energy is detected with separate antennas, one of which that can receive only the polarization that was emitted, and the other of which can receive only the polarization that has been reversed.
2a. When the transmitted energy goes through a single bounce, or any other odd number of bounces, the energy is returned to the receiving antenna that can detect only polarity reversal as compared to what was transmitted.
2b. When the transmitted energy goes through two bounces, or any other even number of bounces, the energy is returned to the receiving antenna that can detect only the polarity that is the same as what was transmitted.

3. When radar energy bounces at two-plane intersections, whether with the interior surfaces or structural surfaces (such as intersections between studs and walls, studs and other vertical or horizontal members, floor and ceiling joists with ceilings or floors, etc.), the fact that two bounces occur makes these types of intersections easier to detect and localize, i.e., position accurately. The photo image data may also be used to confirm and sharpen detection and localization these types of intersections.

4. When radar energy bounces at three plane intersections, whether with the interior surfaces (such as occurs at room corners where the intersection may be, for example, two walls and a ceiling) or structural surfaces (such as occurs between a stud, a bottom plate and the back side of wallboard, or stud, top plate and back side of wallboard), the three bounce effect can be detected. This helps to localize and position accurately, these corners. The photo image data may also be used to confirm and sharpen detection and localization of these types of intersections, at least when they are in the line of sight of the camera 16.

5. Completion of the above activities allows the complete detection of the shape of the room using the collected radar image data. This may also be done by reference to a model generated using the photo image data. For example, reference to a photo image data model may be used to confirm and sharpen the shape of the room and other physical attributes of the interior of the room.

6. Scale may be detected so that every detail of its dimensions can be calculated. The radar scan done in step 1 develops locations of objects within the walls, floors and ceilings, such as studs, joists and other structural members, utilities infrastructure such as wiring, receptacles, switches, plumbing, HVAC ducting, HVAC registers, etc. These objects are identified and verified through context. For example, modularity of building components and construction may be referenced. For example, a modularity of construction which may be referenced is the fact that structural members are placed at intervals that are a factor of 48 inches in the Imperial System, or 1,200 mm in the Metric System. Thus, elements such as wall studs can be used to deduce through scaling, lengths and heights of walls, etc. Additionally, the detected location of three-bounce corners will contextually define the major room dimensions. The photo image data may also be used for determining scale and dimensions by reference to the photo image data itself and/or a model generated using the photo image data.

7. There may be a presentation of the information gathered and labeled by the software so that the user can verify the locations, resolve ambiguities, and/or override or add further locational information and annotations.

8. When the geometry of the “behind the surface” structure is finalized, the interior can be scaled and coordinates calculated based on the room's geometry and an arbitrarily created set of Cartesian axes which will be aligned with one of the primary directions of the room. These coordinates of key points in the room, may be referred in surveying terms to “control” coordinates.

9. From these fundamental (or as used in surveying terms, “control”) room coordinates, the coordinates of the observing station(s) of the radar (and optionally the camera) can be deduced using common algorithms used in surveying usually referred to as “resection,” “triangulation,” or “trilateration,” or a combination of the three.

10. The surfaces of the room as detected with the radar may now be merged with the control coordinates to enable dimension of every aspect of the interior for modeling. This will include creation of all the data to enable calculation of all primary and secondary linear measurements, areas, volumes and offsets. Photo image data may be used to enhance the model such as by sharpening dimensional and perspective aspects of the model. A model created using the photo image data may be compared to and/or merged with the model generated using the radar image data. For example, the two models may be compared and/or merged by correlating control coordinates of the two models.

After the model is generated, the model may be shown on the display 22 for viewing by the user. For example, a true representation of the scanned environment may be shown or various augmented reality views may be shown, some examples of which are described in further detail below.

During a scan such as described above, the scanner 10 is typically collecting image data from the radar device 18 and/or the camera 16 and collecting position data from one or more of the position data collecting apparatus 27 (e.g., laser system 28, inclinometer 34, compass 38, etc.). These components of the scanner 10 generate signals which are communicated to the processor 24 and used by the processor to generate the model. The processor 24 generates images or models as a function of the signals it receives and instructions stored in the memory 26. Depending on the type of model desired to be generated, various combinations of the data collection components may be used. For example, in a brief scan, perhaps only the camera 16 and one of the position data collecting apparatus 27 are used (e.g., the inclinometer 34). This type of scan may be used for purposes in which lesser resolution or precision is needed. In other situations, where greater resolution and precision are desired, perhaps all of the image and data collecting components are used, and a multitude of scan positions and/or perspectives may be used. This provides the processor with a rich set of data from which it can generate a model usable for very detail-oriented analyses.

The data communicated to the processor 24 may include overlapping or redundant image data. For example, the camera 16 and radar device 18 may provide the processor 24 with overlapping image data of a visible surface of walls of a room, including a ceiling, floor, and/or side wall. The processor 24 may execute instructions in the memory 26 to confirm accuracy of one or the other, to resolve an ambiguity in one or the other (e.g., ambiguities in radar returns), and/or to sharpen accuracy of image data of one or the other. The redundant image data from the camera 16 and the radar device 18 may provide the processor 24 with a rich set of image data for generating a model. The processor 24 may use or mix the camera and radar image data at various stages of processing. For example, as described above in steps 3, 4, and 6, the camera image data may be used with the radar image data before a full model is resolved. For example, an algorithm may be used for edge detection in the camera images that can be applied to detect abrupt changes in color, texture, signal return, etc. to also hypothesize and edge, which may be then automatically created in the model, or verified and accepted through user interaction. This edge detection may be used to assist in refining or sharpening the radar data before or after a model is resolved. In another example, separate models may be constructed using the camera and radar image data and the models merged, such as by correlating control points of the models.

The data communicated to the processor 24 may also include overlapping or redundant position data. For example, some types of position data may be derived from the image data from the photo image data and the radar image data. Other types of position data may be supplied to the processor 24 in the form of signals from one or more of the position data collection apparatus 27, including the laser system 28, GPS sensors 30, electronic distance measuring device 32, inclinometer 34, accelerometer 36, or other orientation sensors 38 (e.g., compass or inertial measurement unit). The position data may assist the processor 24 in correlating different types of image data and/or for correlating image data from different positions/perspectives for forming a model. In the synthetic aperture radar and photogrammetry techniques which may be used, it is important to know or determine a relatively exact position of the camera 16 and radar device 18 at the time the relevant image data was collected. This may be especially necessary when high resolution and precision is desired for a model. The multitude of signals provided to the processor indicative of various position aspects enables the processor 24 to confirm position data by comparing it to redundant data from other signals, sharpen position data, assign an accuracy value or weight to position data and so forth. For example, if the laser system 28 is providing the processor 24 with position data which appears to be inconsistent with expected returns, the processor may choose to ignore that position data or decrease the weight with which it uses the data in favor of other perceived more accurate position data (e.g., from the inclinometer 34, accelerometer 36, or inertial measurement unit 38). The processor could prompt the user to assist it in deciding when an ambiguity arises. For example, if a curved wall is being scanned, the returns from the laser system 28 may not be accurate, and the processor may recognize the returns and ask the user whether to use the laser data or not (e.g., ask the user whether the wall being scanned is curved). As with the image data discussed above, having redundant or overlapping position data enables the processor to resolve very accurate models if needed.

Various types of references may be used for correlating image data of different types and/or correlating image data collected from different positions or perspectives. Moreover, such references may also be useful in correlating one model to another or determining a position with respect to a model. References which are on or spaced from visible surfaces of volumes may be represented in the image data generated by the camera 16 and the radar device 18. These types of references may include, without limitation, artificial targets used for the intended purpose of providing a reference, and environmental targets such as lines or corners or objects. In the indoor modeling context, light switches, electrical outlets, HVAC registers, and other objects may serve as references. These types of references may be more reliable than objects such as furniture etc. which are more readily movable and less likely to remain in place over time. Subsurface references may include without limitation framing (e.g., studs, joists, etc.), reinforcing members, wiring, piping, HVAC ducting, wall sheathing, and wall sheathing fasteners. Because these references are subsurface with respect to wall surfaces, they are more reliably fixed and thus typically better references to use. The references may be identified by user input and/or by the processor 24 comparing an image to a template representative of a desired reference. For example, a reference (e.g., electrical outlet) identified by the processor 24 in multiple images by template comparison may be used to correlate the images. One or more references may be used to relate a grid to the target for referencing purposes.

To assist the processor 24 in generating a model, various assumptions may be made and associated instructions provided in the memory 26 for execution by the processor. For example, assumptions which may be exploited by the processor 24 may be related to modularity of construction. In modern construction, there are several modular aspects, including modular building component dimensions, and modular building component spacing. For example, studs may have standard dimensions and when used in framing be positioned at a known standard distance from each other. As another example, wall sheathing fasteners such as screws generally have a standard length and are installed in an array corresponding to positions of framing members behind the sheathing. These and other examples of modular construction and ways of using the modularity of construction according to the present invention are outlined below.

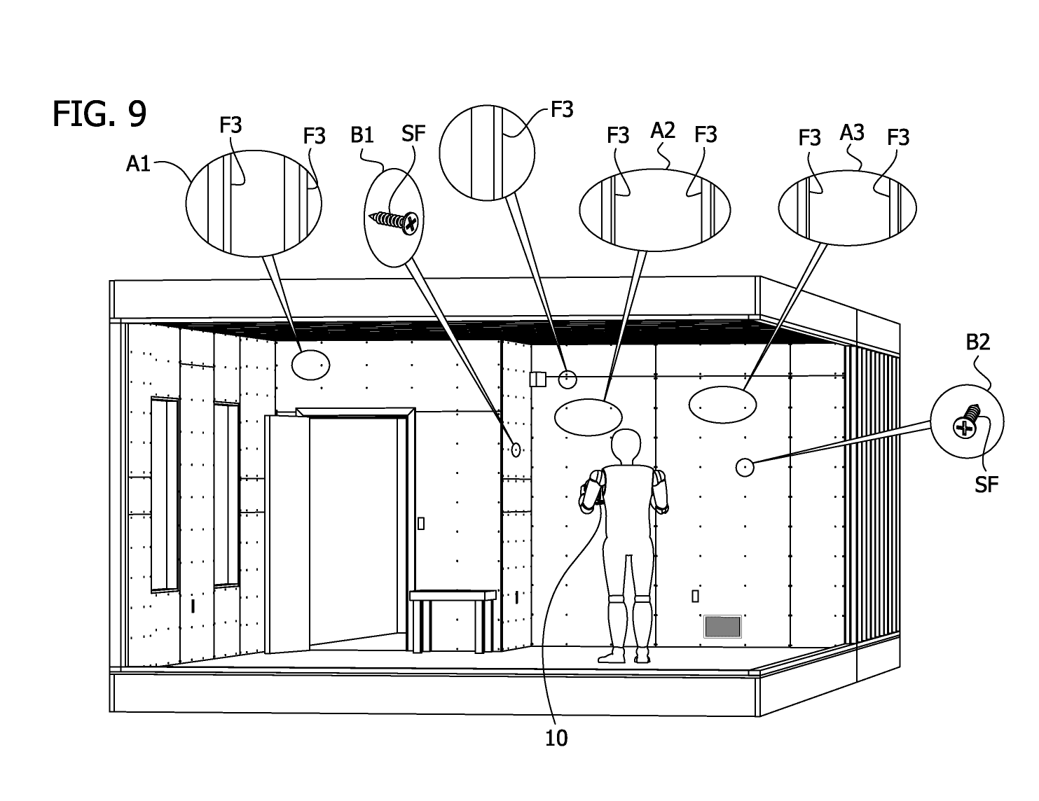

In an aspect of the present invention, features of modular construction, and in particular subsurface features of modular construction may be used as references. For example, known dimensions of building components such as studs, wall sheathing fasteners, and sheathing members, and known spacing between building components such as studs may be used as a dimensional reference for determining and/or sharpening the dimensions of modeled subject matter. As explained above, subsurface components may be identified by context. Once identified, modular subsurface components may provide the processor with various known dimensions for use in scaling other scanned subject matter, whether it be surface and/or subsurface subject matter scanned using the radar device or surface subject matter scanned using the digital camera. Moreover, the modularity of subsurface building components may be used to determine, confirm, or sharpen a perceived perspective of scanned subject matter. For example, the processor may identify from radar returns perceived changes in spacing of studs from left to right or perceived changes in length of wall sheathing fasteners from left to right, or from top to bottom. As shown in FIG. 9, for example, the perceived spacing of sets of studs A1, A2, A3, and the dimensional aspects of the studs themselves would provide perspective information. Likewise, the perspective of the wall sheathing fasteners B1, B2 by themselves and with respect to each other provide perspective information. Knowing the modular spacing and dimensions compared to the perceived changes in spacing and length may enable the processor 24 to determine perspective. The memory 26 may include instructions for the processor 24 to determine reference dimensional and/or perspective information of modular construction features.

In another aspect of modular construction, it may be assumed that certain features of modular construction continue from one place to another. For example, if a network of wiring is identified by a scan as extending through various portions of a structure it can be assumed that the network of wiring is a particular type throughout the network (e.g., electrical, communications, etc.). Once the identity of a portion of a network of wiring is identified, the processor can identify the remainder of the network as being of the same type. For example, if it is desired to model or map the electrical wiring throughout a structure, a complete scan of the structure may reveal various types of wiring. For the processor 24 to identify the electrical wiring it may identify a switch or electrical outlet (e.g., from a library or from user input) which can be used to carry the identity of that electrical wiring through the remainder of the network. As another example, it may be assumed that studs are positioned in a wall extending from left to right at generally standard spacing. If radar returns are insufficient to directly indicate the presence of modular components (i.e., there are gaps or insufficient data richness in the image data), the processor may use the known attributes of the modular components to supplement or sharpen the image data for building a model. For example, if a pattern of studs is indicated by radar returns but includes a gap of insufficient radar returns, the processor may fill the gap with image data representative of studs according to the modular spacing. Such assumptions may be checked by the processor 24 against other sources of image data. For example, if camera image data indicates an opening in the wall is present at the gap in the studs, the processor would not fill the gap with image data representative of studs.

As mentioned above, wall sheathing fasteners may serve as subsurface references with respect to surface and/or subsurface scanned subject matter. Wall sheathing fasteners, being installed by hand, provide a generally unique reference. A pattern of sheathing fasteners may be compared to a “fingerprint” or a “barcode” associated with a wall. Recognition of the pattern from prior mapping could be used to identify the exact room. Sheathing fasteners are readily identifiable by the radar device 18 of the scanner 10 because the fasteners act as half dipoles which produce a top hat radar signature. Because of the top hat of the shape of the fasteners (e.g., see FIG. 10), including a shaft which is advanced into the sheathing, and a head at a tail end of the shaft, the fasteners resonate with a greater radar cross section (across a greater range of frequencies) than if they lacked the head. According to the present invention, wall sheathing fasteners may be used for many purposes, such as dimensional and perspective references, as explained above, and also as readily identifiable markers (identifiable by top hat radar signature) for indicating positions of framing members. Such an assumption may be used by the processor 24 for confirming or sharpening radar returns indicative of the presence of a framing member.

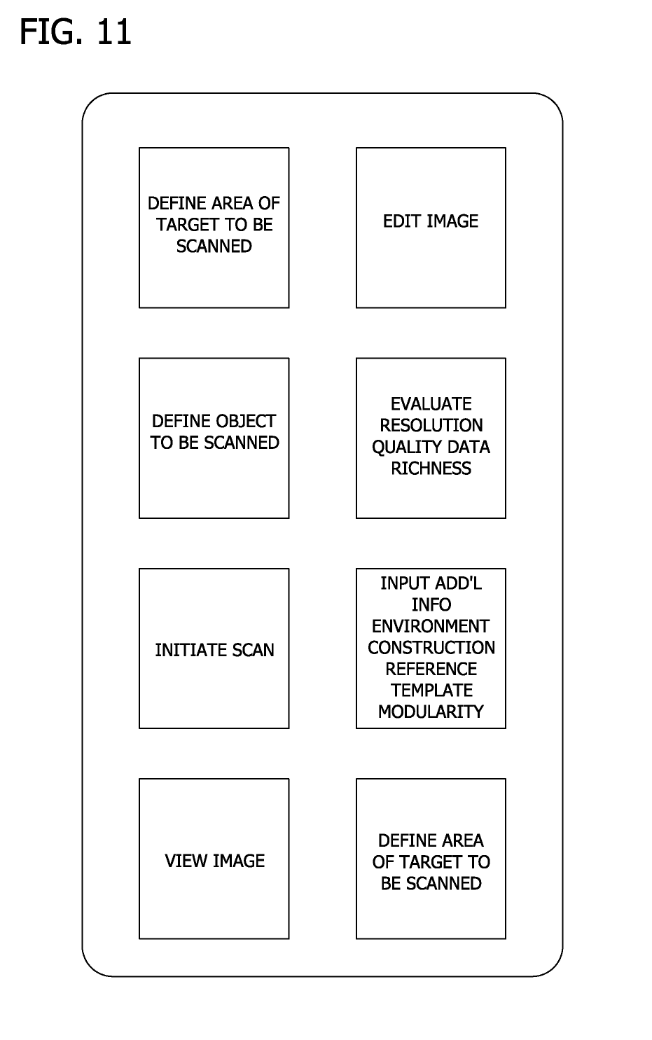

The processor 24 may benefit in image generation by information supplied by the user. FIG. 11 illustrates schematically a possible menu of user input interface options. For example, the user may input information which relates to aspects of a scan. For example, the user may be prompted to define a scan area or define a purpose of the scan (e.g., for floor plan mapping, termite inspection, object modeling, etc.) so that the scanner can determine aspects such as the required environment, structure, or object to be scanned, the boundaries of the scan, and the synthetic aperture required for the scan. The user input interface may prompt the user to identify and/or provide information or annotations (label and/or notes) for scanned features such doors, windows, and components of utilities infrastructure. The user may also be able to input, if known, modularity of construction information including whether the setting of the scan includes plaster or sheetrock construction, wood or metal framing, and/or Imperial or Metric modularity. The user may input human-perceptible scan-related evidence such as visible evidence of a condition for which the scan is being performed (e.g., termite tubes or damage, water damage, etc.). These user-defined features may assist the processor 24 in conducting the scan and interpreting image data received from the camera and radar device for forming a model or other image.

It may be desirable to determine whether a sufficient scan has been performed before leaving the site of the scan or ending the scan. Accordingly, the memory 26 may include instructions for the processor to determine whether collected data is sufficiently rich and/or includes any gaps for which further scanning would be desirable. To estimate the synthetic aperture, the processor 24 may analyzes position data derived from the image data or provided by one or more of the position determination apparatus 27. This information may be used to determine whether scans were performed at sufficient distances from each other and with sufficient diversity in perspective with respect to the target. Moreover, the processor 24 may determine whether image data has sufficient overlap for model generation based on presence of common references in different scans. Accordingly, the scanner 10 may indicate to the user if additional images should be created, and optionally direct the user where from and with what perspective the additional scans should be taken.

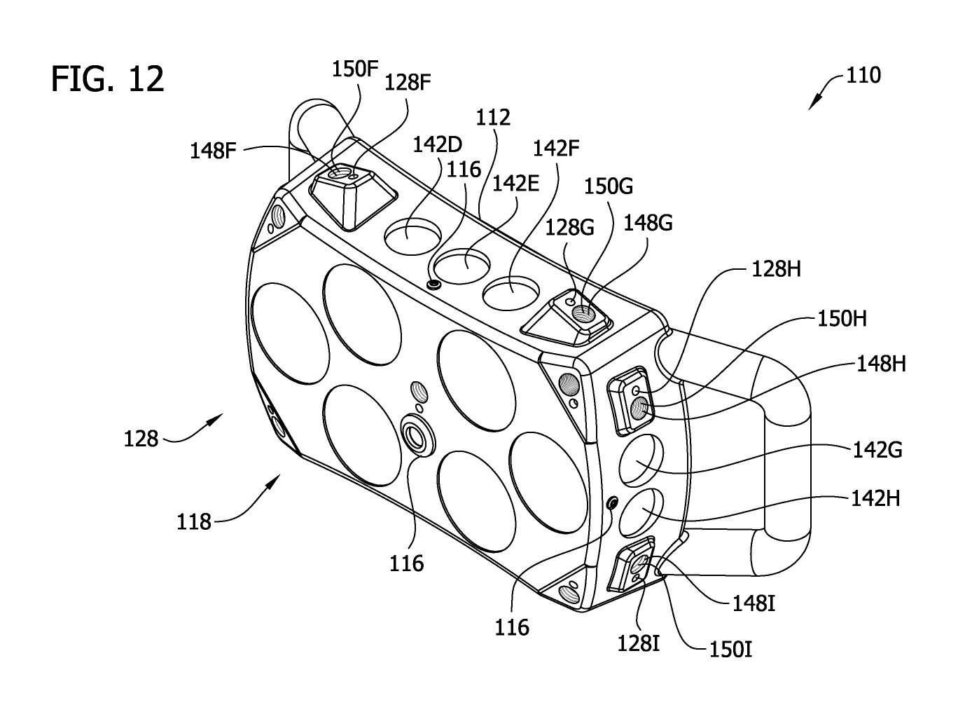

Referring now to FIG. 12, another embodiment of a scanner or pod of the present invention is designated generally by the reference number 110. The scanner 110 is substantially similar to the embodiment described above and shown in FIGS. 1-4. Like features are indicated by like reference numbers, plus 100. For example, the scanner includes a housing 112, a digital camera 116, a radar device 118, and a laser system 128. In this embodiment, the scanner 110 includes additional cameras 116, additional antennas 142D-142H, and additional lasers 128F-128I, light tunnels 150E-150I, and photosensors 148F-148I. These additional components are provided around a periphery of the housing 112 for expanding the field of view of the scanner 110. Although not visible in the view shown, it will be understood that similar arrangements of components are provided on the bottom and far side of the scanner 110. It will be understood that these additional components operate in much the same way as the corresponding parts described above with respect to the scanner illustrated in FIGS. 1-4. The scanner 110 of this embodiment is adapted for collecting image data more rapidly (i.e., with fewer scans). Moreover, the additional lasers 128F-128I permit the position of the scanner 110 to be located with more precision. It will be understood that the scanner 110 of this embodiment operates substantially the same way as the scanner described above but with the added functionality associated with the additional components.

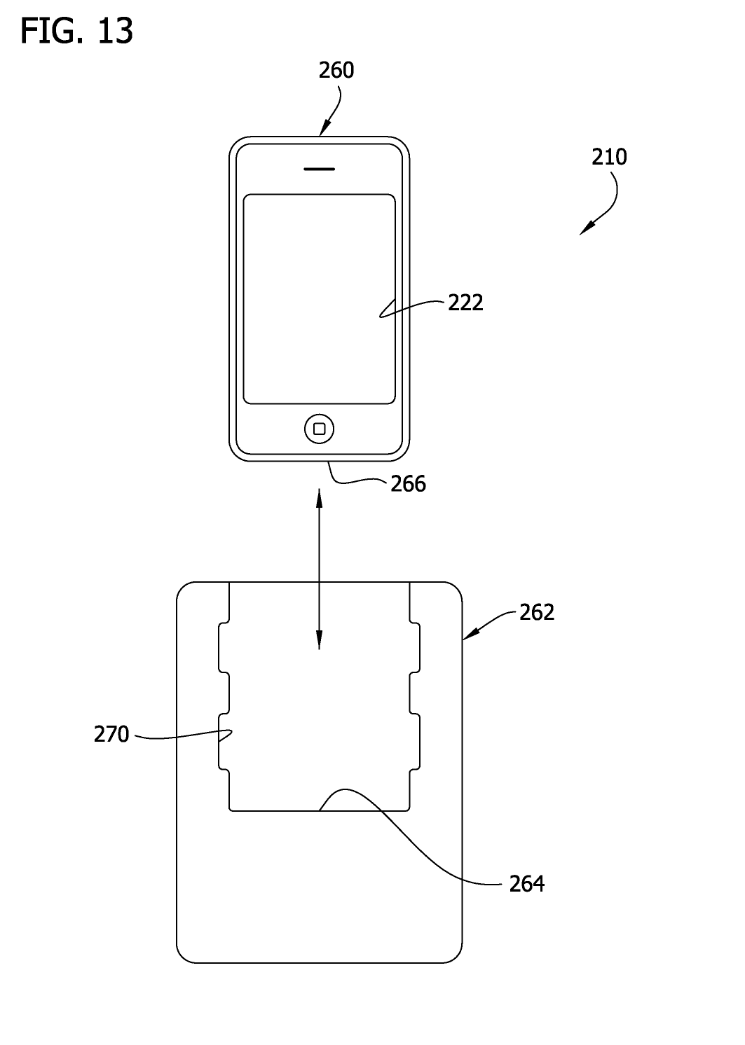

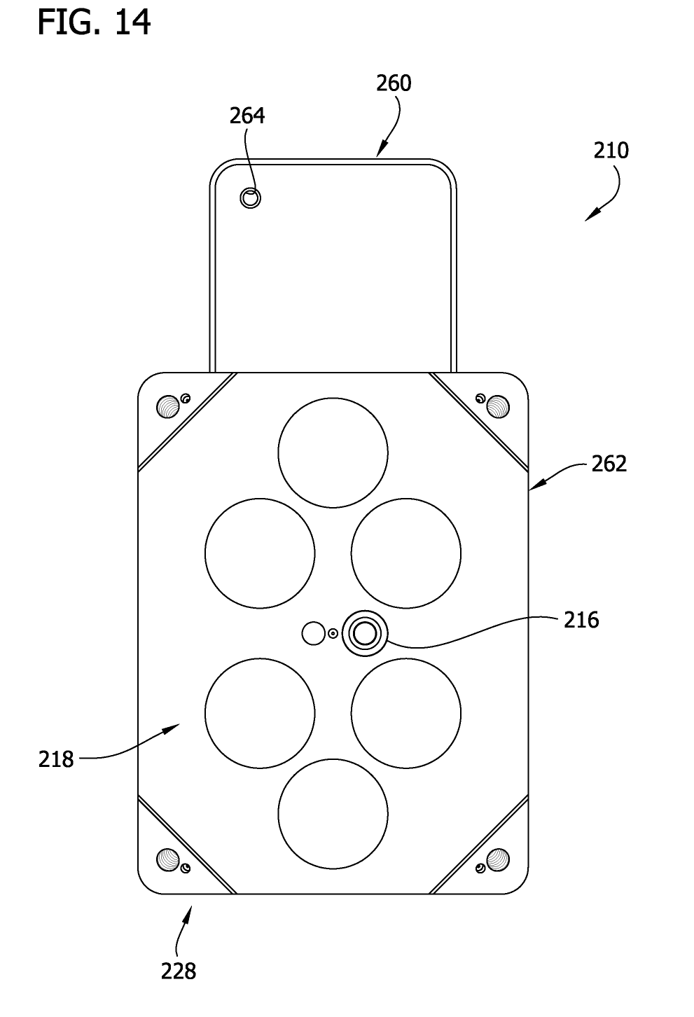

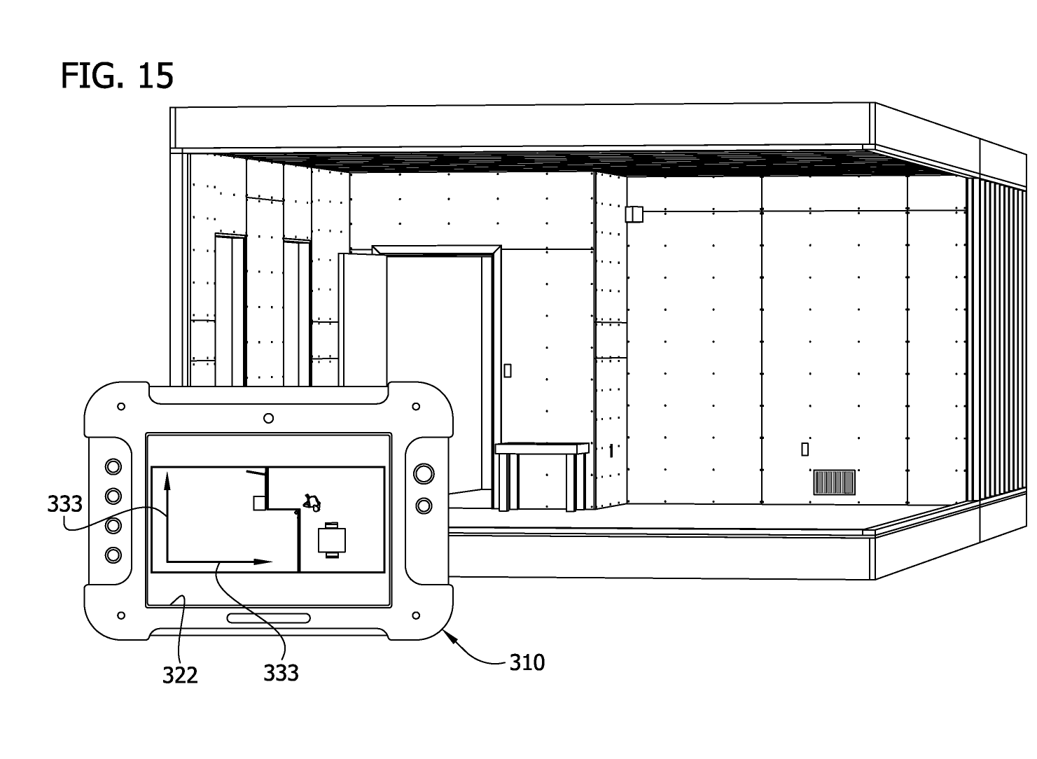

Referring now to FIGS. 13 and 14, another embodiment of a scanner or pod of the present invention is designated generally by the reference number 210. The scanner 210 is similar to the embodiment described above and shown in FIGS. 1-4. Like features are indicated by like reference numbers, plus 200. In this embodiment, the scanner 210 includes a smart telephone 260 (broadly, “a portable computing device”) and a scanning adaptor device 262. The smart telephone 260 may be a mobile phone built on a mobile operating system, with more advanced computing capability and connectivity than a feature telephone. In the illustrated embodiment, the scanning adaptor device 262 includes a port 264 for connection with a port 266 of the smart telephone 260. The ports 264, 266 are connected to each other when the smart telephone 260 is received in a docking bay 270 of the scanning adaptor device 262. The telephone 260 and adaptor device 262 are shown disconnected in FIG. 13 and connected in FIG. 14. The smart telephone 260 and scanning adaptor device 261 may be connectable in other ways, without departing from the scope of the present invention. For example, the smart telephone 260 and scanning adaptor device 262 may be connected via corresponding ports on opposite ends of the wire. Moreover, the smart telephone 260 and scanning adaptor device 262 may be connected wirelessly via wireless communications interfaces. A portable computing device may include for example and without limitation in addition to a smart phone, a laptop or hand-held computer (not shown).

The smart telephone 260 and scanning adaptor device 262 may include respective components such that when the smart telephone and scanning adaptor are connected to form the scanner 210 it includes the components of the scanner 10 described above with respect to FIGS. 1-4. The scanning adaptor device 262 may include whatever components are necessary to provide the smart telephone 260 with the functionality of a scanner. For example, the scanning adaptor device 262 may include a radar device 218, a laser system 228, and a camera 216 (FIG. 14). The smart telephone 260 may include a display 222, a camera 264, and a user interface such as a high-resolution touch screen. The smart telephone 260 may also include a processor and a communications interface providing data transmission, for example, via Wi-Fi and/or mobile broadband. Moreover, the smart telephone may include a GPS sensor, compass, accelerometer, inertial measurement unit, and/or other position or orientation sensing device. The scanning adaptor device may include a processor of its own if desired for executing the scanner-related functions or supplementing the processor of the smart telephone in executing the scanner functions. It will be understood that when the smart telephone and scanning adaptor device are connected, their components may be represented by the block diagram illustrated in FIG. 4. The scanner 210 of this embodiment may be used in substantially the same way as described above with respect to the scanner 10 illustrated in FIGS. 1-4.

A model may be used for several purposes after being generated. Some uses include functionality at the same site as the scan was completed. In general, these uses may relate to determining location with respect to modeled subject matter by reference to the model. Other uses include creating various maps or specific purpose models from the model. Still other uses include inspection, planning, and design with respect to the modeled subject matter. In some of these uses, the model may be displayed as representative of real condition of the scanned subject matter or augmented reality may be used. Moreover, a video may be generated to show all or part of the model in two or three dimensions.

After performing a scan and modeling the scanned subject matter, the scanner (e.g., scanner 10) may be used to determine relatively precisely a location with respect to the scanned subject matter. Using similar components and techniques described above for gathering image data and position data, the scanner can locate references and determine location of the scanner by relation to the references in the model. For example, as described above, several aspects of an interior room setting may be useful as references, including surface references such as light switches, electrical outlets, HVAC registers, and including subsurface references such as wiring, piping, ducting, framing, and sheathing fasteners. Irregularities in typically modular or modularly constructed features may also be used as references. A scanner may use camera image data and/or radar image data for locating surface references. A scanner may use radar image data for locating subsurface references. If a building is used as an example, each room of the building includes a minimum combination of references which provides the room with a unique “fingerprint” or locational signature for enabling the scanner to know it is in that room. Moreover, using position data derived from the camera or radar image data and/or position data provided by one or more of the position determination apparatus, the scanner can determine relatively precisely where it is in the room (e.g., coordinates along x-, y-, and/or z-axes). Moreover, using similar information, the scanner can determine in which direction it is pointing (e.g., the orientation, or attitude and azimuth, of the axis of the camera lens). This determination of location and orientation of the scanner by referencing may be sensed and updated by the scanner in real time.

Having the capability of determining its location and orientation, the scanner may be used for displaying various views of the model or other images of the modeled subject matter as a function of the position and/or orientation of the scanner. Several uses will be described below with respect to FIGS. 15-21. In these figures, a different embodiment of a scanner 310 having a display 322 is illustrated, but it will be understood it has the same functionality as described above with respect to other embodiments. For example, as illustrated in FIG. 15, the display 322 of the scanner 310 may show a two-dimensional or three-dimensional map of the modeled building and a representation of the scanner or person using the scanner. The orientation of the scanner 310 may be indicated in the same view. For example, in the illustrated embodiment, lines 333 are shown extending outwardly from the indicated user for representing the field of view of the user.

In another aspect, the capability of the scanner 310 to determine its location and orientation may be used to display the model in various augmented or non-augmented reality views. The processor may use the known location and orientation of the scanner 310 to not only display the correct portion of the modeled subject matter, but also display it in proper perspective and in proper scale. As viewed by the user, the image of the model displayed on the screen 322 would blend with the environment in the view of the user beyond the scanner. This may be updated in real time, such that the view of the model shown on the display 322 is shown seamlessly as the scanner is aimed at different portions of the modeled subject matter.

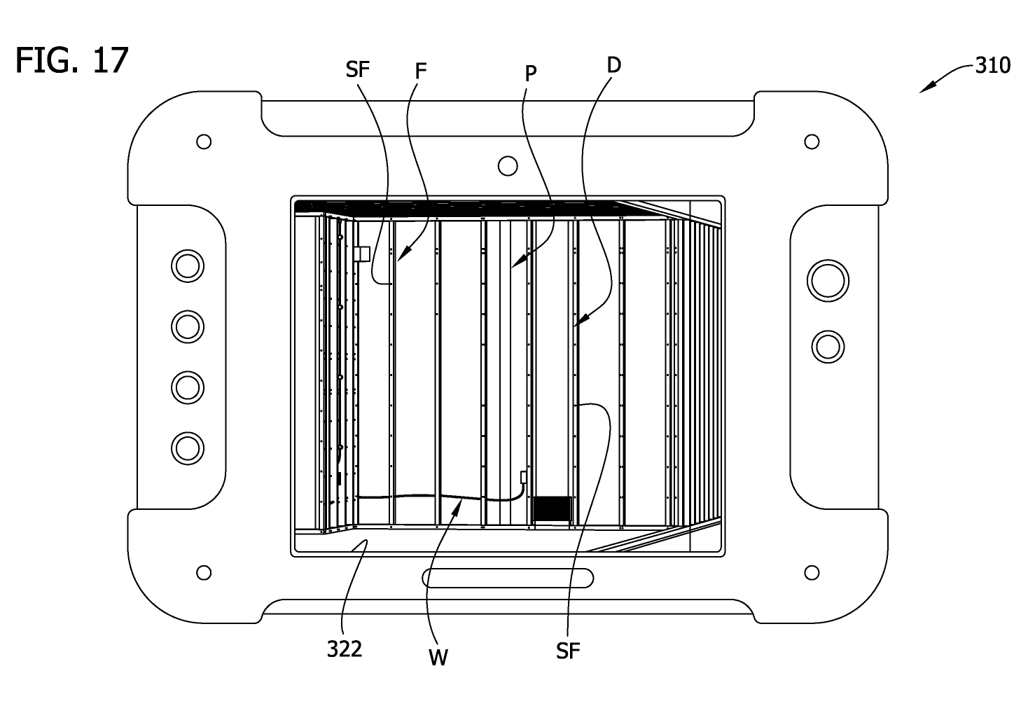

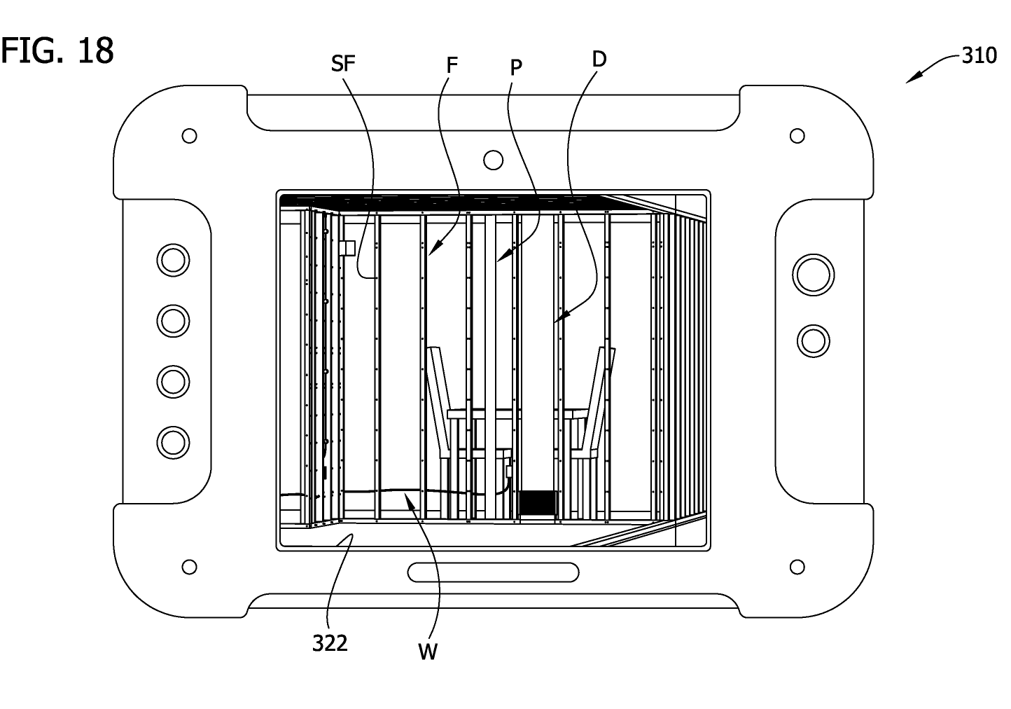

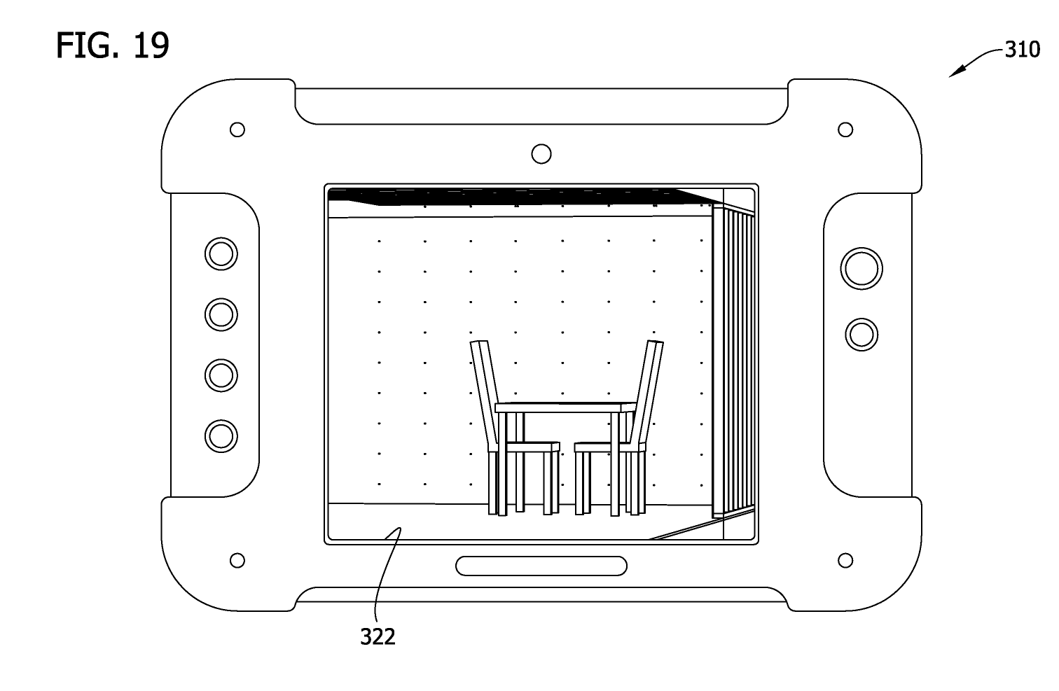

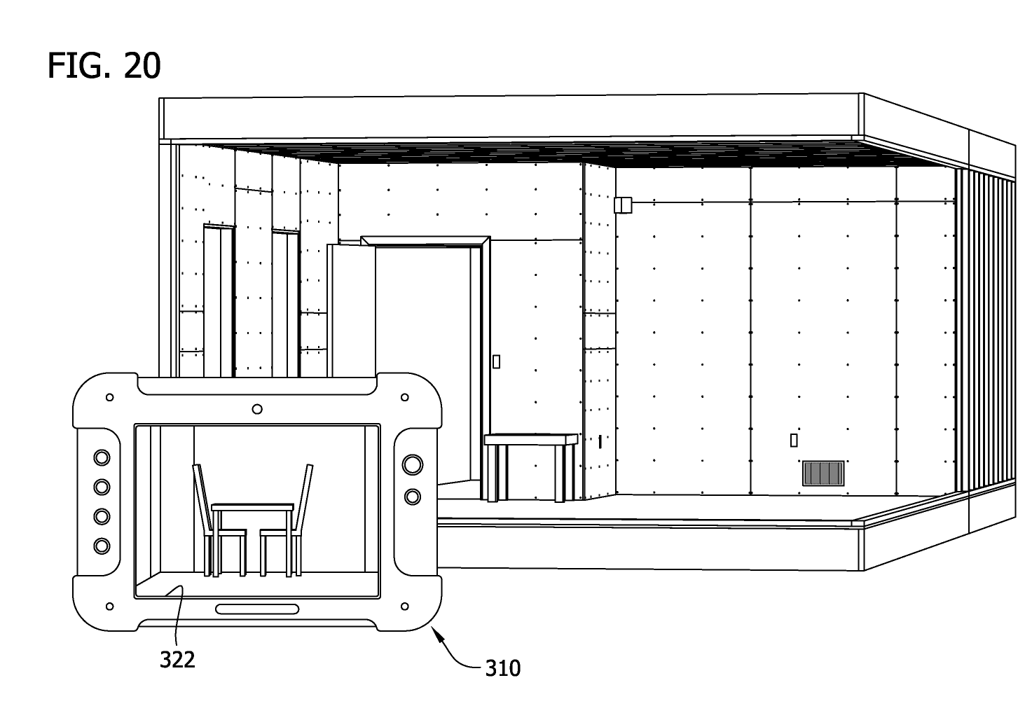

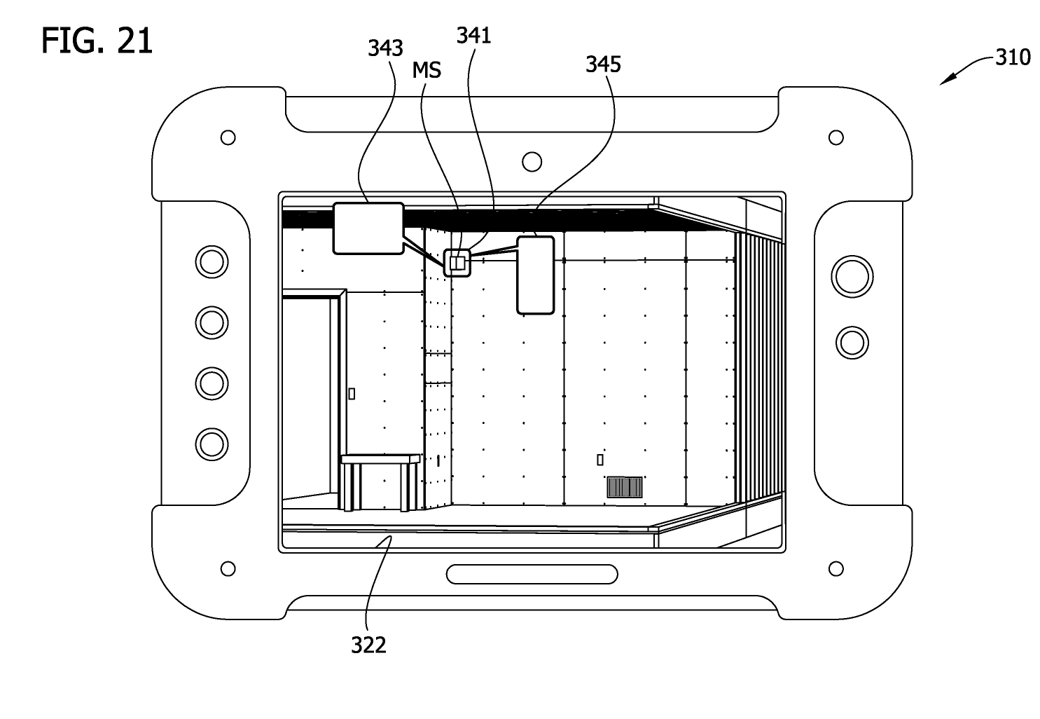

Using the user input interface, such as by selecting various options on the menu shown in FIG. 11, the user may select to display a view of the model representative of the real subject matter and/or of various types of augmented reality. For example, FIG. 16 illustrates an augmented reality view in which subsurface structure of a wall is shown behind a transparent wall created in the augmented reality view. The subsurface items shown behind the transparent wall surface include framing F, wiring W, ducting D, piping P, and sheathing fasteners SF. Dimensions between framing components and major dimensions of the wall may be displayed. Other dimensions or information associated with the room, such as its volume may also be displayed. Moreover, in the view of FIG. 16, furniture (a table) which was in the room when scanning occurred and is included as part of the model is not shown. FIG. 17 illustrates an augmented reality view of the same wall having the front sheathing removed to expose the interior components of the wall. FIG. 18 illustrates a view of the same wall having the front and rear sheathing removed to permit viewing of the adjacent room through the wall. A table and two chairs are shown in the adjacent room. FIG. 19 illustrates a similar view as FIG. 18, but the wall is entirely removed to provide clear view into the adjacent room. FIG. 20 provides a different type of view than the previous figures. In particular, the scanner illustrated in FIG. 20 is shown as displaying a view from the adjacent room looking back toward the scanner. Such a view may be helpful for seeing what is on an opposite side of a wall. In this case, the table and chairs are on the opposite side of the wall.

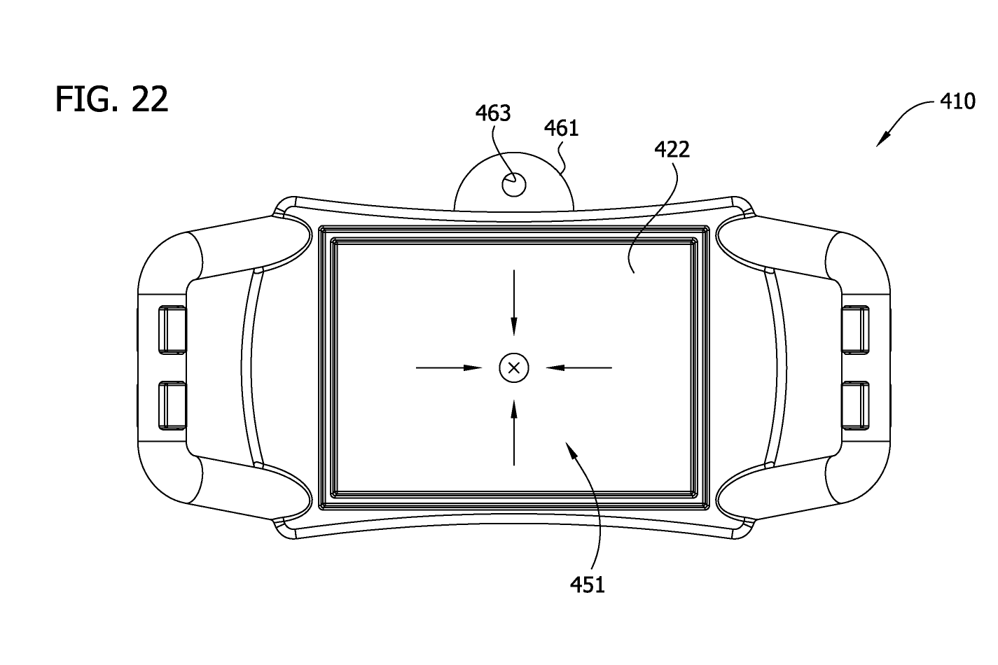

The scanner 310 knowing its location and orientation with respect to modeled subject matter may also be useful in enabling the user to locate structure and objects included in the model and display related information. For example, as shown in FIG. 21, when the display 322 is used as a viewfinder, features of the model shown on the display according to the view of the camera may be selected by the user. In the illustrated case, a motion sensor MS has been selected by the user, as indicated by a selection box 341 placed around the sensor through the scanner's software interface, and annotations 343, 345 such as a name/label and information associated with the motion sensor are displayed. Alternatively, the viewfinder may show a reticule such as the selection box 341 for selecting the motion sensor MS by positioning (aiming) the reticule on the display with respect to the sensor.

In another aspect of the present invention, the scanner may be used to locate positions with respect to scanned subject matter. An embodiment of a scanner 410 particularly adapted for this purpose is illustrated in FIG. 22. For example, it may be desirable to locate positions for laying out points, lines, and/or other markings where a hole is to be drilled or a surface is to be cut or so forth. For example, the model may be modified to indicate where the marking is to be made. The scanner 410 can be moved relative to where the marking is to be made by reference to the view of the model on the display 422. Using this technique, the user is able to move the scanner 410 to the position where the marking is to be made. The scanner 410 may provide visual instructions 451 and/or audible instructions for assisting the user in moving the scanner to the desired position. As explained above, the scanner 410 may determine in real time its position and orientation with respect to the modeled subject matter by reference to the model. Once at the desired position, a mark may be formed or some other action may be performed, such as drilling or cutting. The scanner 410 may be placed against the surface to be marked for very precisely locating the position, and the scanner may include a template 461 of some sort, including an aperture 463 or some other mark-facilitating feature having a known position with respect to the camera and/or radar device for facilitating the user in making the marking. Accordingly, the model may be used to make relatively precise virtual measurements, and the scanner 410 can be used to lay out the desired positions without manual measurement.

Models generated from scans according to the present invention may be used for numerous offsite purposes as well as onsite purposes such as those described above. Because such high resolution and precise models are able to be generated using data collected by the scanners of the present invention, the models can eliminate the conventional need for a person to visit the site of the modeled subject matter for first hand observation, measurement or analysis. Moreover, the models may enable better observation and more precise analysis of the scanned subject matter because normally hidden features are readily accessible by viewing them on the model, features desired to be observed may be more readily identifiable via the model, and more precise measurements etc. may be performed virtually with the model than in real life.

Because the models eliminate the need for onsite presence for observation of the scanned subject matter, an expert located remotely from the scanned subject matter may be enlisted to analyze and/or inspect the subject matter for a variety of reasons. A relatively unskilled person (untrained or unknowledgeable in the pertinent field) can perform a scan onsite, and the scan data or the model generated from the scan may be transmitted to the remote expert having training or knowledge in the pertinent field. This convention may apply to a multitude of areas where expert observation or analysis is needed. Several example applications are described below. Taken one step further, the remote expert may be able to have a “presence” onsite by manipulating a view of the model shown on the display of the scanner. The expert may also communicate (e.g., by voice) with the user viewing the model on the display via the communications interface of the scanner or other device such as a telephone. Scanning according to the present invention provides a fast, cost-effective, accurate means to create models of the mapped environment such that detailed and accurate analysis and manipulation of the model may replace or in many cases improve upon the expert analyzing the actual subject matter scanned.

As will become apparent, models generated according to the present invention may be used for several types of inspection purposes. Depending on the type of inspection desired, more or less model resolution and correspondingly more or less image data may need to be collected in the scan. A variety of types of inspection functions for which the scanner and modeling may be used are described below.

A scan may be used to identify and map current conditions of an environment, structure, or object such that an inspection may be conducted. If the inspection indicates action is required, such as construction, remodeling, or damage remediation, the expert can use the model to prepare relatively precise estimates for the materials and cost necessary for carrying out the action. The analysis of the model may include reviewing it to determine whether a structure or building has been constructed according to code and/or according to specification or plan. For example, a “punch list” of action items may be prepared based on the analysis of the model (e.g., remotely from the site at issue). Such punch lists are traditionally prepared in construction and/or real estate sales situations. The precision of models generated according to the present invention may enable such close review of the modeled subject matter that an offsite expert reviewing the model may prepare such a list of action items to be completed. Moreover, follow-up scans may be performed for generation of an updated model for enabling the expert to confirm that the actions were performed properly as requested.

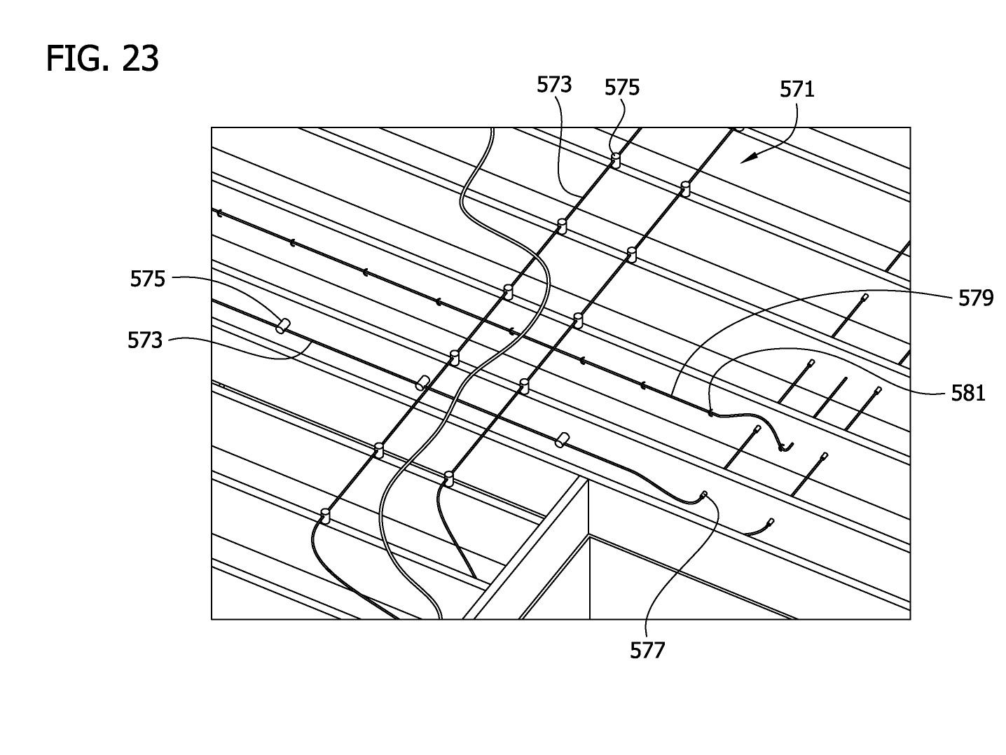

Referring to FIG. 23, in another aspect of the present invention, scanners such as those described above may be used in detecting knob and tube wiring 571 (broadly, an interior element). Knob and tube wiring was an early standardized method of electrical wiring in buildings, in common use in North America from about 1880 to the 1930s. It consisted of single-insulated copper conductors run within wall or ceiling cavities, passing through joist and stud drill-holes via protective porcelain insulating tubes, and supported along their length on nailed-down porcelain knob insulators. Example wiring 573 and knobs 575 and tubes 577 are illustrated in FIG. 23. Where conductors entered a wiring device such as a lamp or switch, or were pulled into a wall, they were protected by flexible cloth insulating sleeving called loom.

Ceramic knobs were cylindrical and generally nailed directly into the wall studs or floor joists. Most had a circular groove running around their circumference, although some were constructed in two pieces with pass-through grooves on each side of the nail in the middle. A leather washer often cushioned the ceramic, to reduce breakage during installation. By wrapping electrical wires around the knob, and securing them with tie wires, the knob securely and permanently anchored the wire. The knobs separated the wire from potentially combustible framework, facilitated changes in direction, and ensured that wires were not subject to excessive tension. Because the wires were suspended in air, they could dissipate heat well.

Ceramic tubes were inserted into holes bored in wall studs or floor joists, and the wires were directed through them. This kept the wires from coming into contact with the wood framing members and from being compressed by the wood as the house settled. Ceramic tubes were sometimes also used when wires crossed over each other, for protection in case the upper wire were to break and fall on the lower conductor. Ceramic cleats, which were block-shaped pieces, served a purpose similar to that of the knobs. Not all knob and tube installations utilized cleats. Ceramic bushings protected each wire entering a metal device box, when such an enclosure was used. Loom, a woven flexible insulating sleeve, was slipped over insulated wire to provide additional protection whenever a wire passed over or under another wire, when a wire entered a metal device enclosure, and in other situations prescribed by code.

Other ceramic pieces would typically be used as a junction point between the wiring system proper, and the more flexible cloth-clad wiring found in light fixtures or other permanent, hard-wired devices. When a generic power outlet was desired, the wiring could run directly into the junction box through a tube of protective loom and a ceramic bushing. Wiring devices such as light switches, receptacle outlets, and lamp sockets were either surface-mounted, suspended, or flush-mounted within walls and ceilings. Only in the last case were metal boxes always used to enclose the wiring and device.

As a result of problems with knob and tube wiring, insurance companies now often deny coverage due to a perception of increased risk, or not write new insurance policies at all unless all knob and tube wiring is replaced. Further, many institutional lenders are unwilling to finance a home with limited ampacity (current carrying capacity) service, which is often associated with the presence of knob and tube wiring.

Discovery, locating and mapping of knob and tube wiring installations is an important objective of building inspectors, prospective occupants, prospective purchasers of real estate, architects, and electrical contractors. However efforts for discovery, locating and mapping of knob and tube wiring installations are confounded by several problems inherent to these installations. Knob and tube wiring by practice is located out of view of occupants in inaccessible locations, including attics, wall cavities and beneath floors.

Further, expertly qualified electricians are required to determine presence and relevance. Such determinations can be especially difficult and time consuming for even experienced electricians when some remediation/replacement of knob and tube wiring has been previously performed, as replaced wiring structures are often left in place when newer, modern wiring is installed. And, in many instances visible knob and tube wiring, such as in accessible attics, has been replaced, but spliced with existing knob and tube concealed from view in walls. An example of modern wire 579 (e.g., copper or aluminum wire) is shown in FIG. 23 as replacing the knob and tube wiring 571. The modern wire is secured directly to structural members using staples 581 and runs along the structural members in engagement with the structural members.

According to the present invention, the scanner may be used to detect and image by synthetic aperture radar relevant building structural elements along with electrical wiring structures, contained within the optically opaque spaces and volumes of walls, floors and ceilings. The radar device of the scanner provides image data including three dimensional point cloud representations of these relevant structures. The images are converted by the processor using techniques such as those described above into a model for visualization, analysis, and inclusion in building information models data bases. The model provides a three-dimensional map of all metallic wiring. Relevant wiring structures are then contextually analyzed to determine presence and location of knob and tube wiring.

Knob and tube wiring construction is contextually differentiated from modern wiring by positional relationship of wires in regards to building structural elements such as wall studs, floor joists and ceiling rafters. By design, knob and tube wiring is mounted on knobs, in a standoff spaced relationship when installed normal to wall studs, floor joists and ceiling rafters. Modern flexible wiring is affixed directly to these structural members such as by direct stapling. Further, knob and tube wiring includes at least two spaced conductors communicating to, and converging in, each electrical outlet, switch or light fixture. When knob and tube wiring is detected and modern wiring updates have been properly performed, then the modern wiring installation and connections are also recognized.

The scanner of the present invention enables detection of the presence of knob and tube wiring. Scans including steps such as described above may be performed including collection of radar image data of walls, ceilings and floors, and mapping their interior volumes and spaces. Wires are observed in the scan results (e.g., a model or map of the scanned structures), and knob and tube construction is detected by its differentiated spaced standoff from structural building components such as joists, studs and rafters, as well as the presence of screw fasteners in the knobs forming the standoffs. The presence of modern wire which has been installed to replace the knob and tube wiring may be detected by identifying wiring which is secured directly to structural members (e.g., by staples) adjacent the knob and tube wiring.

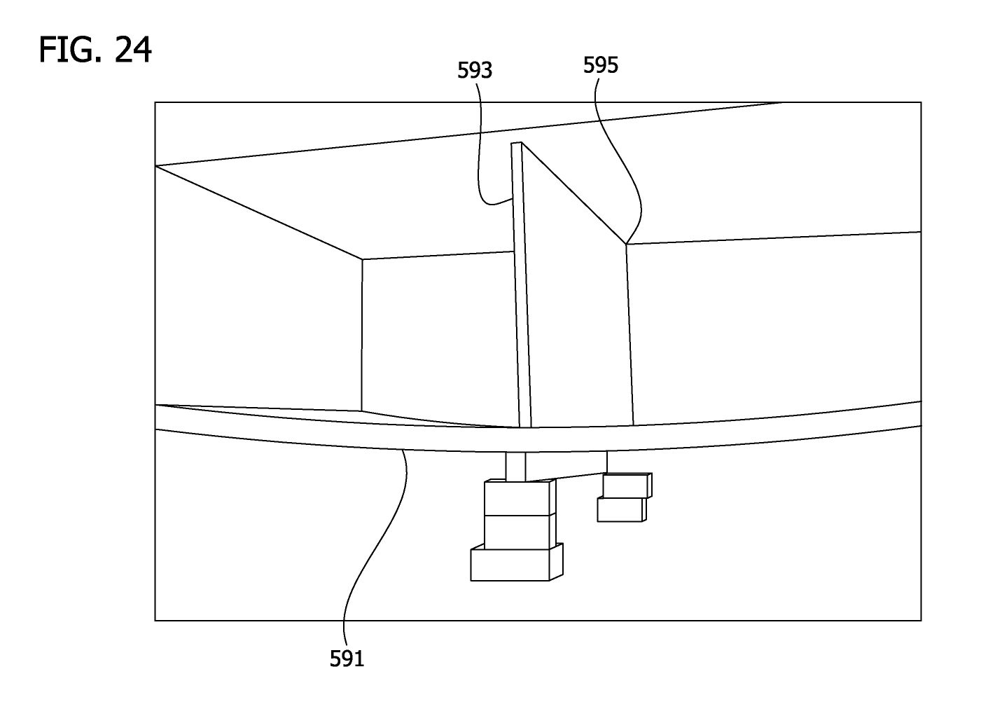

Referring to FIG. 24, in another aspect, a model according the present invention may be used to detect the effects of subsidence. For example, subsidence may be detected by detecting on the model bowed or curved structural members 591, building components such as walls and other members that are out of plumb or off-vertical 593, and/or corners formed by building components which are non-square 595 (i.e., do not form 90 degree intersections between adjoining plane surfaces). Moreover, it may be determined that the building as a whole is leaning or off vertical.

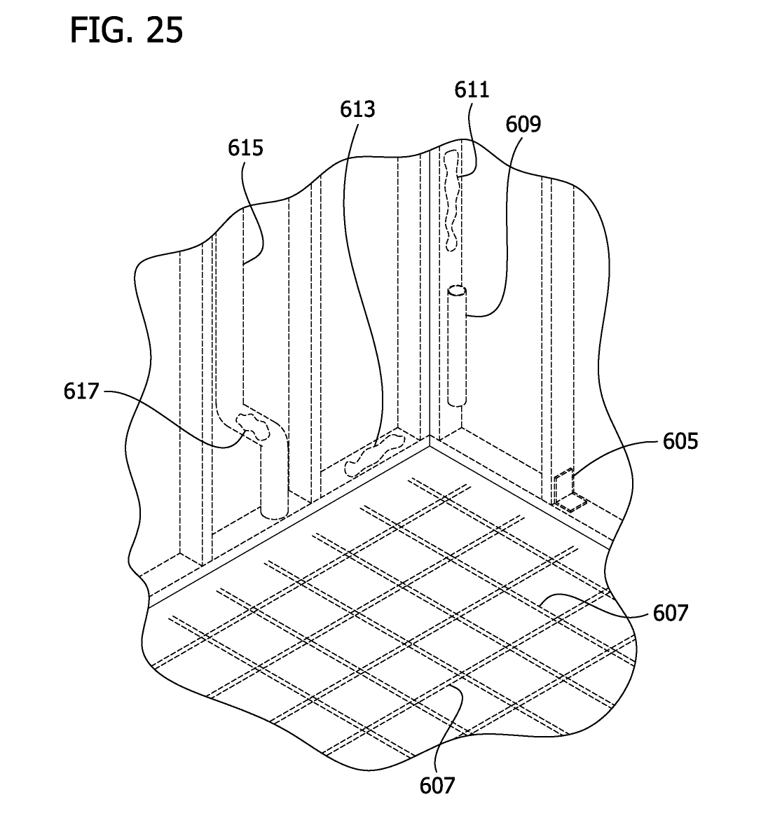

Several other features which may be inspected using a model according to the present invention are illustrated in FIG. 25. For example, a structural reinforcing member in the form of an L-brace 605 is shown in a frame wall. In addition reinforcing steel 607 in concrete, also known as rebar, is illustrated in phantom in a concrete floor adjacent the wall. Structural designs of buildings frequently require proper specification and installation of metal structural brackets and embedded reinforcements such as deformed surface reinforcement rods known as rebar in order for building s to be constructed to adequately resist weight, wind, seismic and other structural loads. Metal structural brackets and embedded reinforcements provide essential life safety risk and property risk mitigations.

While important, metallic structural brackets and embedded reinforcements are typically concealed from view as building construction is completed. In order to save time and costs, builders are known to skimp on installation of structural brackets and embedded reinforcements. Further, buildings are rarely exposed to structural design capacities, so deficient installation of structural brackets and embedded reinforcements may not appear until catastrophic failure during extreme loading conditions. The presence and proper installation of structural brackets and embedded reinforcements may not be easily evident in post construction building inspections.

A model according to the present invention would indicate the presence or lack of structural reinforcing members such as brackets and rebar. It may be determined from the model whether the reinforcing members were installed in the correct positions. The reinforcing members are typically made of metal, which would be readily identifiable in a synthetic aperture radar scan and thus the model.

In another aspect of the present invention, scanners such as described above may be used in a process of identifying termite presence and/or damage. Although termites are ecologically beneficial in that they break down detritus to add nutrients to soil, the same feeding behaviors that prove helpful to the ecosystem can cause severe damage to human homes. Because termites feed primarily on wood, they are capable of compromising the strength and safety of an infested structure. Termite damage can render structures unlivable until expensive repairs are conducted.

Referring to FIG. 25, a tube 609 formed by termites is shown schematically, and a schematic outline 611 representing termite damage to a wood framing member or stud is also shown.

Homes constructed primarily of wood are not the only structures threatened by termite activity. Homes made from other materials may also host termite infestations, as these insects are capable of traversing through plaster, metal siding and more. Termites then feed on cabinets, floors, ceilings and wooden furniture within these homes.

Interior damage may not become apparent until infestations are full-blown. Termite damage sometimes appears similar to water damage. Outward signs of termite damage include buckling wood, swollen floors and ceilings, areas that appear to be suffering from slight water damage and visible mazes within walls or furniture. Termite infestations also can exude a scent similar to mildew or mold.

Presence of termites is often not identified before considerable damage has occurred as infestation and damage is often concealed from view. Presently the only means of detection for many infestations is by professionals conducting an onsite inspection. Generally these professionals are also engaged in the sale of termite abatement services. Relying on termite presence determination by the same person who will sell services creates potentials for conflicts of interest.

In an aspect of the present invention, scanners such as those described above may be used to scan a structure or part of a structure to collect image data representative of the structure. The image data may be used to generate a model, using steps similar to those described above. If a model is intended to be used to detect presence of termites and/or termite damage, the scan used to collect image data for the model should be sufficiently data rich for generating a precise and detailed model.

The model may be analyzed to detect the presence of termites such as by detecting the types of damage referred to above as being created by termites. For example, the model may be analyzed to detect tunnels formed by termites. Termite damage may be located in a model by indication of differences in material density of building components. For example, differences in density of wood in individual building components such as joists or studs may indicate termite damage. The model may be examined by an expert trained for identifying termite damage remotely from the structure modeled. If an analysis of a model is inconclusive whether termites or termite damage is present, it may at least be a means of identifying areas of a structure where termites and/or termite damage may be present and which should be subjected to traditional visual and other types of inspection for confirmation.

In another aspect of the present invention, models according to the present invention may be used in a process of identifying water damage. Referring to FIG. 25, an outline of water damage to a wood framing member is shown schematically at 613. Structural water damage includes a large number of possible losses caused by water intruding where it will enable attack of a material or system by destructive processes such as rotting of wood, growth, rusting of steel, de-laminating of materials such as plywood, and many, many others. The damage may be imperceptibly slow and minor such as water spots that could eventually mar a surface, or it may be instantaneous and catastrophic such as flooding. However fast it occurs, water damage is a very major contributor to loss of property.

Water damage may have various sources. A common cause of residential water damage is often the failure of a sump pump. Water damage can also originate by different sources such as: a broken dishwasher hose, washing machine overflow, dishwasher leakage, broken pipes, clogged toilet, leaking roof, moisture migration through walls, foundation cracks, plumbing leaks, and weather conditions (e.g., snow, rain, floods).

Different removal and restoration methods and measures are used depending on the category of water. Due to the destructive nature of water, restoration methods also rely heavily on the amount of water, and on the amount of time the water has remained stagnant.

Water damage restoration can be performed by property management teams, building maintenance personnel, or by the homeowners themselves. However, in many instances damage is not covered by insurance, and often concealed during home sale transactions. Slight discolorations on the walls and ceiling may go unnoticed for a long time as they gradually spread and become more severe. Even if they are noticed, they often are ignored because it is thought that some discoloration will occur as a part of normal wear and tear in a home. This may lead to molds spreading throughout the living space leading to serious health consequences.

In an aspect of the present invention, scanners such as those described above may be used to scan a structure or part of a structure to collect image data representative of the structure. The image data may be used to generate a model, using steps similar to those described above. The model may be analyzed to detect the presence of water damage such as by detecting the types of damage referred to above as being representative of water damage. For example, the model may be analyzed to detect differences in material density of building components such as framing members and sheathing members. The model may be examined by an expert trained for identifying water damage remotely from the structure modeled.

In another aspect of the present invention, scanners such as described above may be used in a process of identifying water inside structures, including clogs in piping and leaks from piping and/or roofs. Referring again to FIG. 25, a drainage pipe 615 is shown inside the wall, and a backup of water is shown at 617. The backup of water indicates a clog in the pipe. If the pipe were not clogged, water draining through the pipe would not collect in the pipe as shown. Water is readily identifiable by synthetic aperture radar and may be detected in drainage pipes for precisely locating clogs in the pipes.

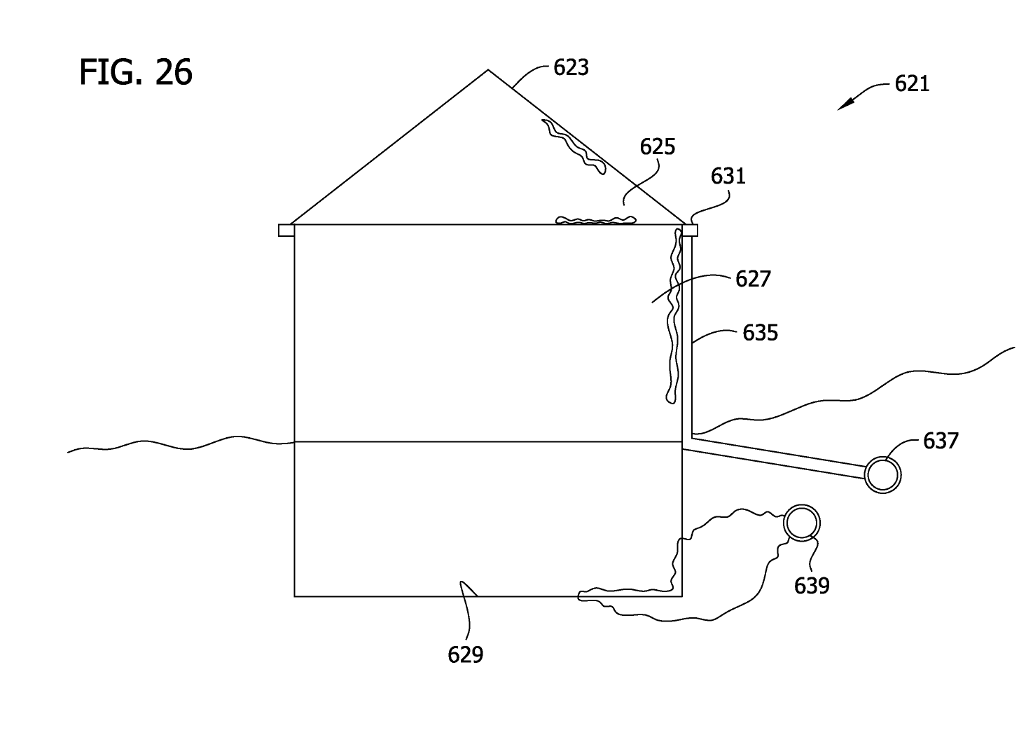

Referring now to FIG. 26, modeling according to the present invention may be used to detect, precisely locate, and determine the source of water inside structures such as buildings. The building 621 illustrated in FIG. 26 is a home having water on a roof 623 of the home, in an attic 625 of the home, in a wall 627 of the home, and in a basement 629 of the home. A scan of the home 621 or pertinent areas of the home could be used to generate a model in which the water and sources of water may be apparent.

Some conventional methods for detecting water include nuclear and infrared technologies. Some nuclear moisture detectors are capable of detecting moisture as deep as 20 cm (8 inches) beneath a surface of a roof. In situations where one roof has been installed over another, or on multi layered systems, a nuclear moisture survey is the only conventional moisture detection method that will accurately locate moisture located the bottom layers of insulation installed to the deck. Nuclear metering detects moisture in the immediate area of the meter, thus many readings must be taken over the entire roofing surface to insure that there are no moisture laden areas that go undetected.

Thermography is another prior art means of roof leak detection and involves the use of an infrared imaging and measurement camera to “see” and “measure” thermal energy emitted from an object. Thermal, or infrared energy, is light that is not visible because its wavelength is too long to be detected by the human eye; it is the part of the electromagnetic spectrum that humans perceive as heat. Infrared thermography cameras produce images of invisible infrared or “heat” radiation and provide precise non-contact temperature measurement capabilities.

Roof moisture survey technologies of the prior art share several substantial limitations. Both technologies require direct visible access to the area to be scanned for water leaks or water presence, such as a roof top. This can mean the operator is exposed to very dangerous locations. Also, both technologies require onsite, expert sensing and interpretation of results, which further limit practical use to onsite professionals.

In another aspect of the present invention, scanners such as described above may be used in a process of identifying water leaks through cracks in underground walls of structures, such as through basement walls. Most basement leaking is caused by some form of drainage problem outside the home, not a problem underneath or inside the basement itself. Older basements are often shoddily constructed and rife with thin walls and multiple cracks. Poor drainage outside can easily penetrate floors and walls, causing water damage and annoying leaks. Newly built basements are also prone to leaking if water buildup occurs under the floor or outside of the basement walls.

In most cases, basements leak because soil surrounding the basements becomes overly saturated with water, and leakage can be particularly problematic after long rainy seasons, particularly those preceded by drought. However, basement leaks tend to not be as prevalent during dry seasons. Soil surrounding foundations packed deep into the ground can take months to dry.

In an aspect of the present invention, water saturated soil, which produces a high contrast radar reflective signature, may indicate presence of unwanted water buildup and sources of basement leakage problems.

By mapping the presence and location of unwanted water buildup, sources and solutions can be identified. Scanning by the present invention can be done on the building exterior and or in the basement, and may be necessary during dry as well as wet seasons in order to map water accumulation contrasts.

One common reason for basement leakage relates to gutter system drainage. Old and improperly installed gutters tend to promote pooling water outside foundation walls. As it accumulates this standing water may leak into the basement. Repair or cleaning of gutters and gutter drain lines may restore functionality and eliminate pooling.

Another reason for basement leakage relates to the slope of land surfaces of land surrounding a basement. Surrounding land must slope away from foundations so rain water is directed away from foundations and can't accumulate in pools. Scanning of land surface slope grades around the foundation by the present invention can detect inadequate surface drainage conditions. Scanning by the present invention may also provide suitable topographic modeling to enable remediation designs (remote expert) to be created and implemented.

In an aspect of the present invention, scanners such as those described above may be used to scan a structure or part of a structure to collect image data representative of the structure. The image data may be used to generate a model, using steps similar to those described above. In scans such as this one which pertain to water, the scan may be performed based on the recent occurrence of rain. In the case of the home illustrated in FIG. 26, the model may include the pertinent portions of the home 621, such as the roof 623, attic 625, walls 627, gutter 631, downspout 635, and basement 629. The model may also include portions of the soil surrounding the home and include a storm sewer drainage pipe 637 and a water supply pipe 639. Upon analysis of the model it may be determined that the source of the basement leak is not drainage caused by the slope of the ground toward the basement because the soil is not damp between the surface and the location of the leakage. Moreover, it can be determined that a clog in the lower part of the downspout is not the cause of the leakage. Instead, the cause of the basement leak is water leaking from the water supply line 639. Based on analysis of the model, the expert may also inform the home owner that a clog is present in the gutter 631 which is causing the water to leak into the wall 627 rather than down the downspout 635. After remediation activities, another scan may be performed for the expert to confirm the leaks have been remedied.

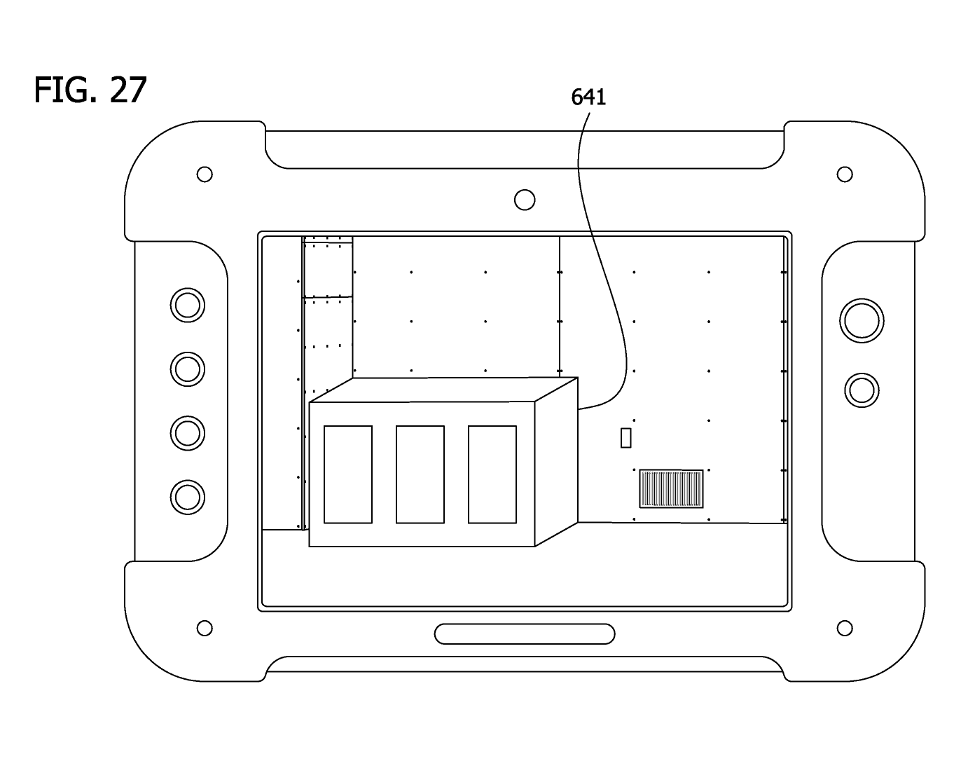

In another aspect of the present invention, a scan may be performed and an associated model may be created for the purpose of interior design and/or construction. As described above, scanning according to the present invention enables precise virtual measurement from the model rather than measuring by hand. A model may be used to determine various aspects of interior design, such as the gallons of paint needed for painting a room or the square yards of carpet needed to carpet the room, which may be determined by calculating the wall area and floor area, respectively, using the model. Moreover, the model may be used to display to the home owner potential furniture and/or various arrangements of furniture or other home furnishings. For example, in FIG. 27, the cabinet 641 shown may be a virtual reality representation of a cabinet to enable the homeowner to determine whether it fits properly in the space and/or whether the homeowner likes the aesthetics of the cabinet in the suggested position. In another aspect, custom manufacturing may be performed to precise standards using the model. For example, referring again to FIG. 27, the cabinet 641 may be an unfinished cabinet in need of a countertop. Very precise measurements of the top of the cabinet, and the bows or other deviations in the walls adjacent the cabinet may be made using the model. This enables manufacturing of a countertop, such as cutting a slab of granite, to exacting standards. The measurement capabilities using the model are far superior to traditional measurement by hand. It will be understood these techniques would apply to other construction applications, including building custom book cases, or even room additions or larger scale remodeling projects.

In an example application of a scan of the present invention, in preparation of listing a building for sale, a scan may be performed of the entire building. The scan may be desired for use in modeling the building for providing a map of the floor plan to prospective purchasers. The model could be displayed in association with a listing of the building for sale on the Internet. Although a relatively low resolution model may be required to prepare the floor plan model, a more in-depth scan may be performed at that time for later use. For example, a prospective buyer may ask for various inspections of the building, such as termite or other structural damage inspections. The model could then be used to prepare a termite inspection report, and optionally a cost estimate for material and labor for remediating the damage. The detail of the model would enable such precise analysis of the building that it could be determined exactly which structural features need to be replaced or repaired. Moreover, other models of the building may be provided or sold to prospective buyers, or provided or sold to the ultimate purchaser. These may include maps of the utilities infrastructure, and any other maps or models the party might desire.

In another aspect of the present invention, a scan of an object may be performed for generation of model of the object with reference to subsurface references adjacent the object. Referring to FIG. 27, a human is shown schematically standing against a wall with their arms spread out and against the wall. A scanner 710 is shown schematically as if it were collecting image and position data from multiple positions and perspectives with respect to the person. Image data and position data of the human alone may be challenging to resolve into an accurate model of the human. According to the present invention, references adjacent a scanned object may be used in generating a model of the object not including the references. In the illustrated embodiment, the human is standing adjacent the wall, which includes several references. The positioning of the human against the wall not only provides a support surface against which they can lean for remaining motionless while a scan is performed, but also provides a reference-rich environment adjacent the human. Some of the references are subsurface references, including wiring W, piping P, ducting D, framing F, sheathing fasteners SF, etc. Others of the references are surface references, such as the electrical outlet W1, switch W2, and HVAC register D1. The benefit of these references is two-fold. In a first aspect, the references may be used for correlating image data of different types (e.g., photo image data and radar image data) and/or for correlating image data gathered from different positions/perspectives. For example, the wall fasteners SF as seen by the radar form a grid behind the human which enables accurate determination of the positions from which image data was captured. Moreover, the references may be used in determining dimension and scale aspects for modeling the human. In particular, the subsurface references having the features of modularity of construction discussed above may be particularly helpful in determining dimensions and perspective. The known dimensions of the modular building components such as the framing members F and the sheathing fasteners SF may be a reliable source for a dimensional standard. Use of the synthetic aperture radar in combination with photogrammetry enables the scanner to “see” the reference-rich subsurface environment of the wall and thus enables more accurate model generation. The subsurface may be used even though it is not desired to model the subsurface with the object.

It may be desirable to model the human for various reasons. For example, the fit of clothes on the human could be virtually analyzed. Standard size clothes could be fitted to the human to determine which size fits the best. Moreover, the accuracy and resolution of the model could be used for custom tailoring of clothes. A tailor in a remote location from the person could make custom clothes for the human tailored exactly to their measurements. The person may be fitted to their precise measurements for a pair of shoes, a ring, or a hat. For example, the model of the human may be uploaded to an Internet website where virtual clothes may be fitted to the model from a library of clothing representative of clothing available for purchase from the website.

The scan of the person may also be used for volumetric or body mass index measurements. For example, the volume of the person could be determined precisely from the model. The synthetic aperture radar may include frequencies which provide radar returns indicative of bone, muscle, and/or fat. If a person were weighed, their body mass index could be determined from such information.

Human form scanning and modeling of the prior art is accomplished by a variety of technologies. Some prior art technologies only measure body mass, and do not provide suitable dimensional models of the human body. Others only measure small surfaces such as the soles of bare feet. Some full body scanners utilize distance measuring lasers to develop point clouds of body surfaces. Other prior art scanners utilize extremely high frequency backscatter radars. Most technologies of the prior art require disrobing, at least of scanned surfaces. And technologies of the prior art tend to be very expensive and often require onsite skilled users to operate.

Providing accurate, practical, low cost, low user skill and dignified human form body surface scanning and modeling are objectives of the present invention. The technology and method of the present invention for human form body surface scanning and modeling utilizes technology fusions of synthetic aperture radar, synthetic aperture photogrammetry and lasers. Further, the present invention utilizes manmade walls and floors to assist the human subject in remaining motionless during scanning, as well as providing a matrix of sensible reference points, both visible and within the optically opaque volumes of walls and floors.

Some scans of the present invention may be accomplished by using tight fitting clothing, while others can rely on radar imaging to measure through the clothing. The devices of the present invention are suitable for consumer home use, so if partial disrobing is necessary it can often be done in the privacy of one's home.

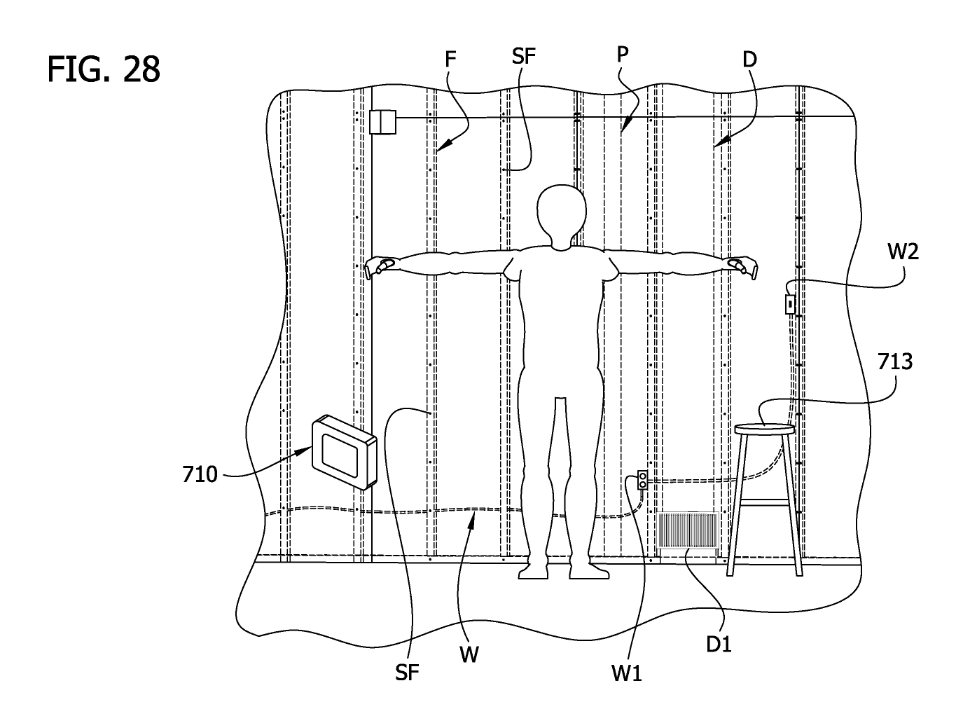

In another aspect of the present invention, an object other than a human may be modeled in essentially the same way described above with respect to the human. For example, in FIG. 28, the stool 713 may be scanned and modeled. Such a model may be made accessible in association with a listing for the object for sale. For example, if the object were listed for sale on the Internet, a link may be provided to view the model of the object for inspection by the potential buyer. In this way, a remote potential buyer could very accurately make an assessment of the condition of the object without traveling to view the object in person. This would increase customer assurance in online dealings and potentially lead to increased sales. Moreover, the position data gathered from various sources during the scan may be used to authenticate the model. The model may include information indicative of the global position of the location where the scan took place. This location could be resolved down to the building, room, and location within the room where the scan took place, based on locating features of the scanner described above. Accordingly, the prospective purchaser could authenticate that the model is a model created at the location from which the object is being offered for sale, which may also increase buyer assurance.

In another aspect of the present invention, a vehicle or a fleet of vehicles may be equipped with scanners of the present invention for capturing location geo-tagged, time-stamped reference data. The data is utilized to form GIS (Geographic Information System) databases. GIS data is accessed and utilized in many ways. The means is passive in that the primary function of the vehicles is dedicated to other transportation purposes. Mapping data capture can occur automatically and passively, as vehicle operators simply go about their ordinary travels related to their primary occupation. In a preferred embodiment, the primary occupation is unrelated to mapping or forming GIS databases. While fleets comprised of a single vehicle are possible, more significant mapping effectiveness is obtained by equipping multiple vehicles in an area for passive mobile mapping.

Owing to operational and labor costs, data collection location passes for dedicated GIS mapping vehicles are typically made quite infrequently. For this reason, typical dedicated platform mapping activities occur in most locations every few years. Given the high costs and infrequency of data collection associated with dedicated GIS mapping devices, mapping precision requirements and system sophistication are high, as data from single passes must suffice for final mapping output. Since passive mapping fleets are deployed in the first instance for other reasons than mapping, the operational costs of passive mapping are largely limited to the equipment mounted on vehicles. Further, the frequency of mapping passes for locations can be vastly greater and more frequent than is possible with dedicated mapping technologies.

Generally the precision of GIS data collected on individual passes in passive mapping is not as accurate or detailed as data collected by conventional dedicated mobile mapping device vehicles. Further, various GIS mapping equipped passive vehicles may have different types of positioning and mapping technologies. However the frequency of repeated location passes in passive fleet mapping enables data accumulated from multiple passes, and from multiple modes of positioning and map sensoring to be analyzed in aggregate, resulting in overall mapping precision not attainable in single pass mapping. The increased frequency of location passes attainable in passive fleet mapping also permits frequent updating of GIS data, and also makes use of many time and condition sensitive events. Updating may be selective for filtering data so as to acquire images from a desired time or during desired weather conditions, for example.

The passive fleet GIS mapping technology consists of several fundamental components; vehicle equipment, network (Internet) connectivity, network connectivity portal, and a central GIS database management system. Vehicle equipment components at the minimum have at least one positioning determination sensor such as GPS, at least one data capture sensor such as a digital camera and/or radar scanner, a data storage drive, a clock for time stamping data and a remote network connectivity modem such as Wi-Fi. While data can be streamed wirelessly in real time, it is much more economical and practical to store data throughout vehicle travels, and download data when the vehicle is parked and not performing its primary duty. A wireless Internet network portal located within range of parking forms the network portal. These can be existing conventional Wi-Fi modems connected to Internet service which are authorized to access the passive fleet vehicle when it is parked. While all data collected while driving could be downloaded at each parking session, it is not necessary to do so. It will be understood that other ways of downloading the data, including wired connections, jump drives etc. may be used within the scope of the present invention.

The central GIS system controller can automatically determine if the fleet vehicle passed lean data locations, locations where an important event occurred such as a crime, or when an event such as rain was occurring and the rain factors into the data acquisition need. The mobile equipment would be capable of storing a number of days of data so the determination of relevant retrieval can access earlier data.

It is important to note that the operator of the mapping vehicle normally has no involvement in the data collection, retrieval, or use of data. Ordinarily vehicle operators simply go about their day in the normal fashion just as they did before the installation of the passive system. If data did not connect or if the data is corrupted for some reason such as a camera with a dirty lens, then the operator of the vehicle could be contacted. While normally vehicle operators simply drive without regard to the mapping system, in events of data deficiencies in certain locations it is possible to suggest or instruct operators to alter their travels to a desired route such as in the lean data locations. Such altered travel patterns could be communicated in mass to all fleet vehicles, or in a preferred manner an analysis of most likely and most convenient fleet vehicles could be used to cause the lean areas to be mapped. In addition, it could be determined that more than a preset period of time has elapsed since a particular area was last scanned. This could also form the basis for instructing the operator to travel an altered route to re-scan this area. Further, it is possible for the vehicle's onboard location system to determine that an operator is traveling near a data lean area and suggest an altered path.

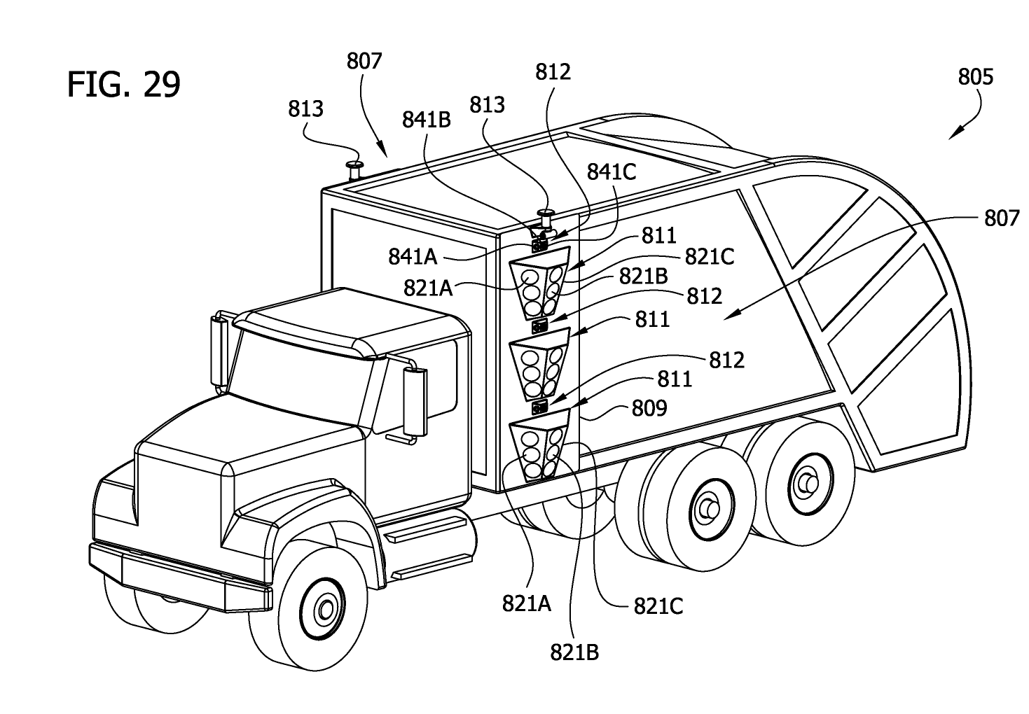

Referring now to FIG. 29, a fleet vehicle in the form of a garbage truck 805 (broadly, “a garbage collection vehicle”) is shown with two scanners or pods 807, one mounted on each of two sides of the truck. The scanning pods 807 are preferably constructed for easy removal and attachment to a conventional truck, so that no or minimal customization of the truck is required. The garbage truck 805 has as its primary function the collection of garbage and is not primarily purposed for scanning. Other types of vehicles can be used, such as mail delivery vehicles and school buses, as well as other types of vehicles described hereinafter. It will be understood that the possible vehicles are not limited to those described in this application. The garbage truck as well as the mail delivery vehicle and school bus may be characterized by generally have the same, recurring routes day after day. This type of vehicle is highly desirable for building up substantial amounts of image data for the same areas that can be used to produce accurate models of the areas traveled by the vehicle.

The scanning pod 807 includes a base 809 mounting image data collection sensors in the form of three radar scanners 811, three camera units 812 and a GPS sensor unit 813. The scanning pod 807 on the opposite side of the garbage truck 805 may have the same or a different construction. Only the top of the GPS sensor unit 813 can be seen in FIG. 29. The radar units 811 are arranged one above the other to provide vertical variation in the image data collected. In a scan using for example a boom that can be pivoted as described elsewhere herein, vertical variation can be achieved by raising and lowering the boom. Used on the garbage truck 805, it is much preferred to have no moving parts. Accordingly, the vertical arrangement of the radar units 811 can give the same effect as vertical movement of a boom-mounted pod. The travel of the garbage truck 805 along a roadway supplies the horizontal movement, but it will be appreciated that only a single pass is made. Therefore, multiple passes may be needed to build up sufficient image data to create and accurate, three dimensional model of the roadway and areas adjacent thereto and including modeling of underground regions.

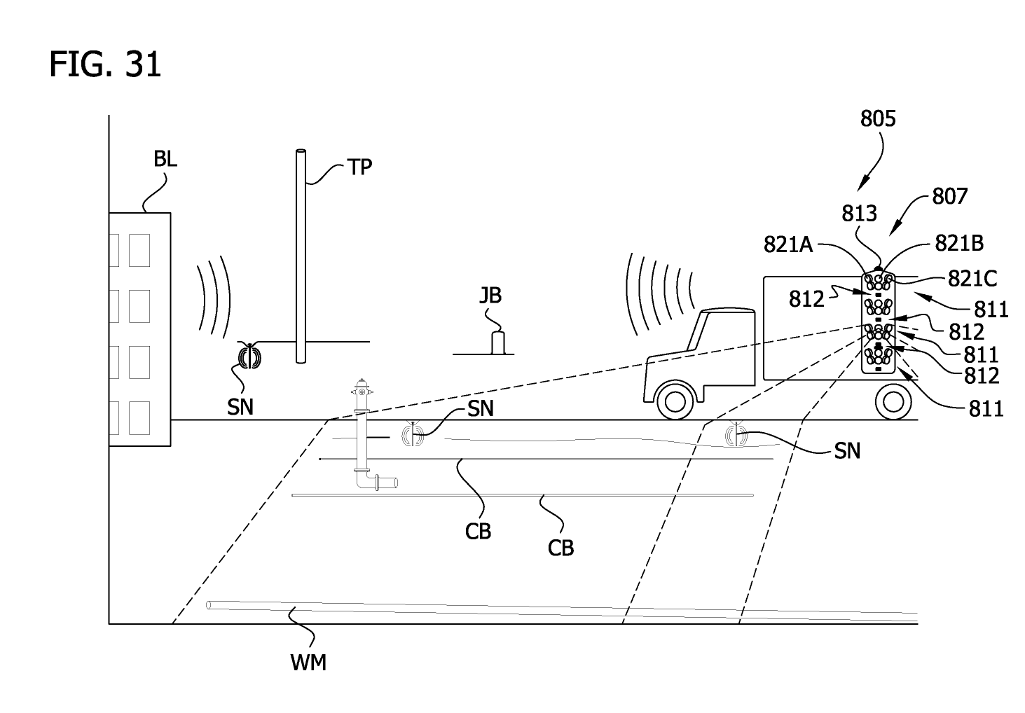

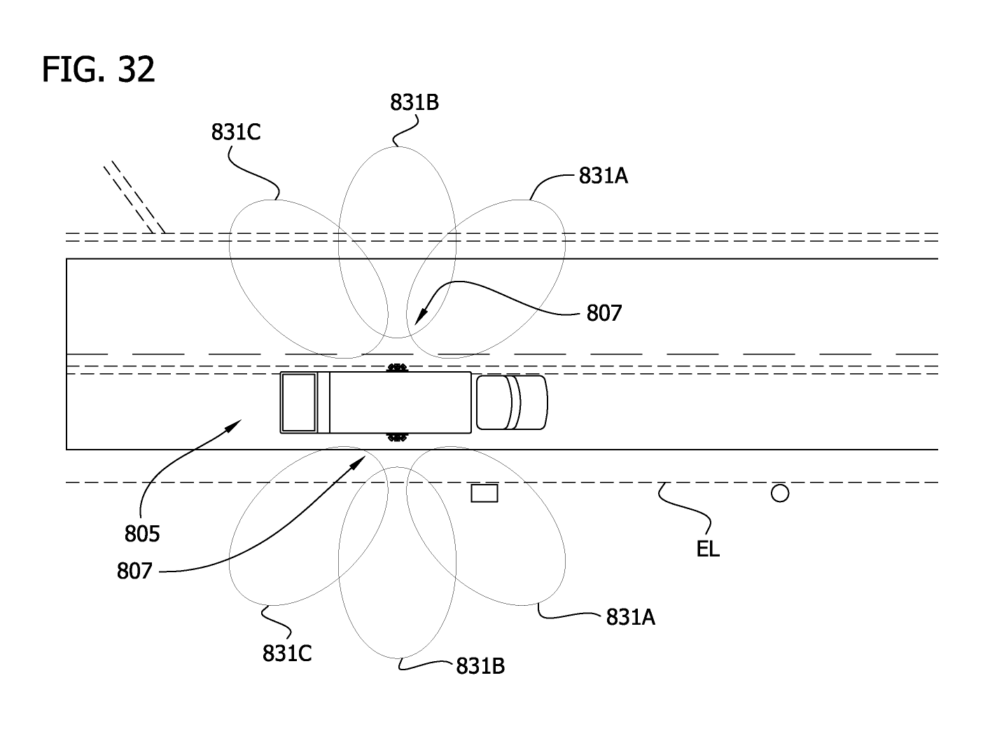

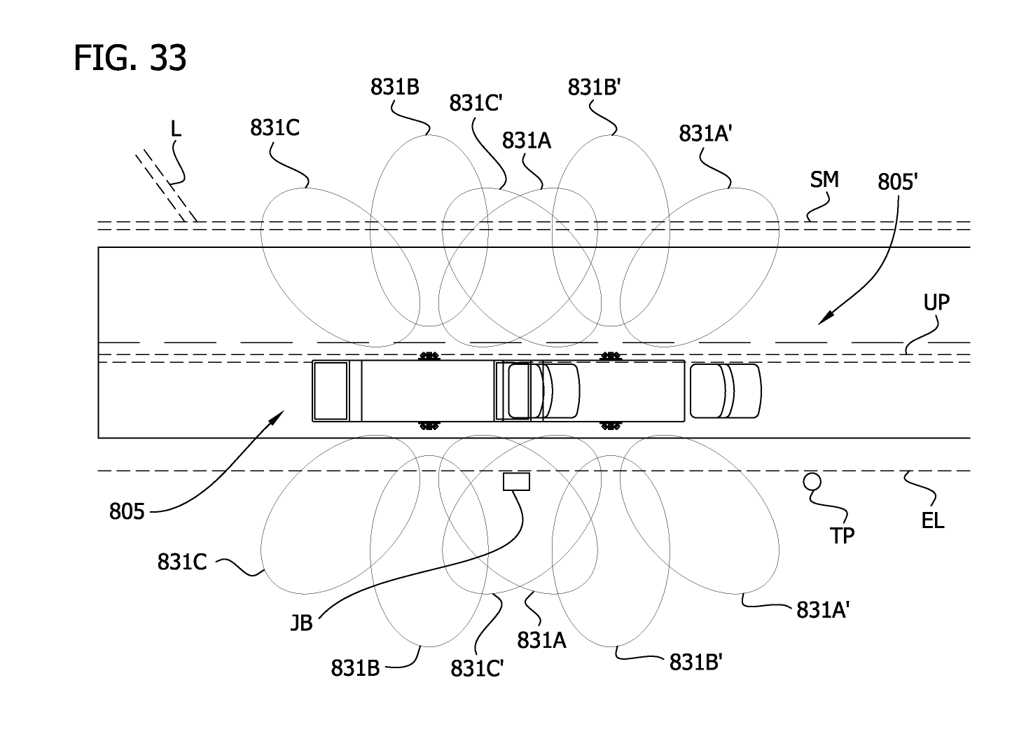

The configuration of each radar unit 811 also helps to make up for the single horizontal pass. More specifically, each radar unit includes three separate radars 821A-821C, which are most easily seen in FIG. 31 and only two of which may be seen in FIG. 29. Each radar 821 is oriented in a different lateral direction. A forward looking radar 821A is directed to the side of the truck 805 but is angled in a forward direction with respect to the direction of travel of the vehicle, and also slightly downward. A side looking (transverse) radar 821B looks almost straight to the side of the garbage truck 805 but also is directed slightly downward. A rearward looking radar 821C is directed to the side of the truck 805 but is angled in a rearward direction and also slightly downward. All three radars 821A-821C on all three of the radar units 811 operate at the same time to generate multiple images. FIG. 32 illustrates the scan areas 831A-831C of each of the radars 821A-821C of one radar unit 811. FIG. 33 illustrates how these scan areas 831A-831C may overlap for two different positions of the vehicle 805 as the vehicle would be moving to the right in the figure. This figure is not intended to show scanning rate, but only to show the direction of scanning and how the scan areas 831A-831C, 831A′-831C′ overlap. In other words, there may be many more scans between the two positions shown in FIG. 32. Considering the first, leftward position of the garbage truck 805, it may be seen that for each of the three scan areas 831A-831C of the radar unit 811, there is some overlap to provide common data points useful in correlating the image data from the scan areas. Now considering the second, rightward position of the truck 805′ it may be seen that the scan area 831C′ of the rearward looking radar in the second truck position overlaps much of the scan area 831A of the forward looking radar from the first position, and a part of the side looking scan area 831B of the first position. In addition, the side looking scan area 831B′ of the second truck position 805′ overlaps part of the forward looking scan area 831A from the first position. This also provides common data points among different scans useful in building up a model. While not illustrated it will be understood that there will be even more overlapping scan areas when the scan areas of the radars 821A-821C on the other two radar units 811 is considered.

The three camera units 812 are similarly constructed. Each camera unit 812 has a forward looking lens 841A, a side looking lens 841B and a rearward looking lens 841C. All three lenses 841A-841C acquire a photographic image at each scan and have similar overlapping areas. The photographic image data can be used together with the radar image data or separately to build up a model of a zone to be scanned. The GPS sensor unit 813 functions as previously described to provide information about the position of the scanning pod 807 at the time of each scan.

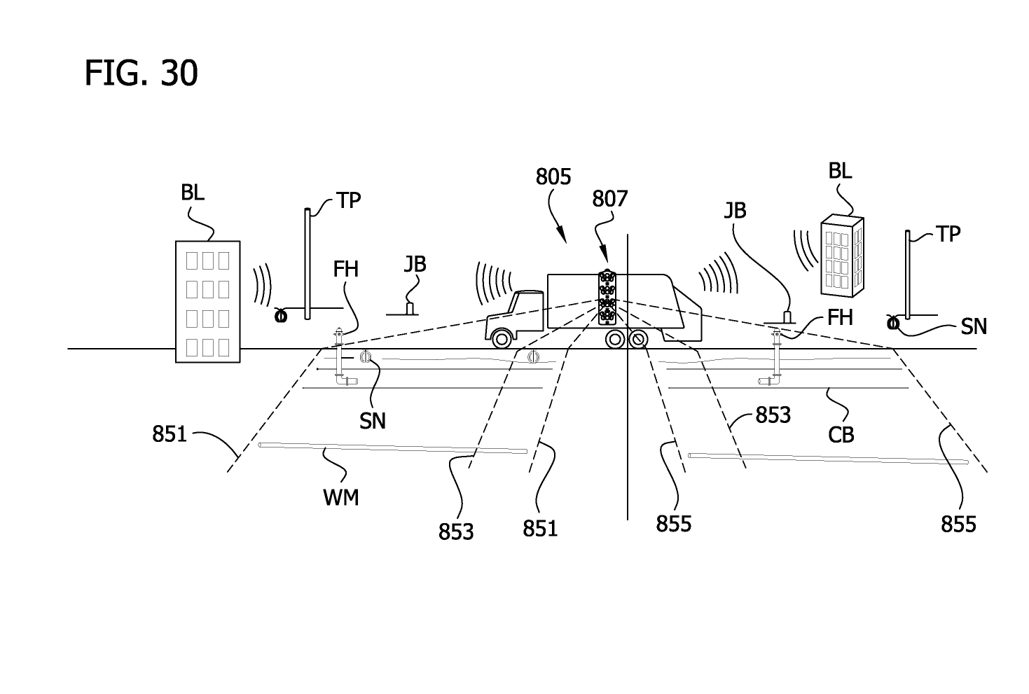

Generally speaking, at least in the aggregate of multiple trips along the same route, the scanning pods 807 mounted on the garbage truck 805 will work like the other scanners for creating a model of the scanned volumes. More particularly a three dimensional model is created that includes underground structures, which is schematically illustrated in FIGS. 30 and 31. Referring first to FIG. 30, the overlapping scan areas 831A-831C of the forward, side and rearward looking radars of each radar 821A-821C unit 811 are shown by dashed lines. The dashed lines associated with the forward looking radar 821A and camera lens 841A are indicated at 851. The dashed lines associated with the side looking radar 821B and camera lens 841B are indicated at 853. The dashed lines associated with the rearward looking radar 821C and camera lens 841C are indicated at 855. It may be seen that areas bounded by these dashed lines include a considerable overlap as is desirable for the reasons discussed above.

The model created from the image data provided by the pod 807 may show, for example, surface features such as buildings BL, utility poles TP, junction boxes JB and fire hydrants FH. FIG. 31 provides an enlarged view showing some of the features in more detail. These features may be mapped in three dimensions, subject to the limitations of the scanning pod 807 to see multiple sides of the feature. The radar units 811 can map underground structures. In the case of the fire hydrants FH, the water mains WM supplying water to the hydrants are shown in the model with the attachment to the above-ground hydrant. Other subterranean features may be mapped, such as a water main WM and two different cables CB. The scanning pod 807 also is able to see surveying nails SN in the ground along the mapped route. The nails can provide useful reference information for mapping.

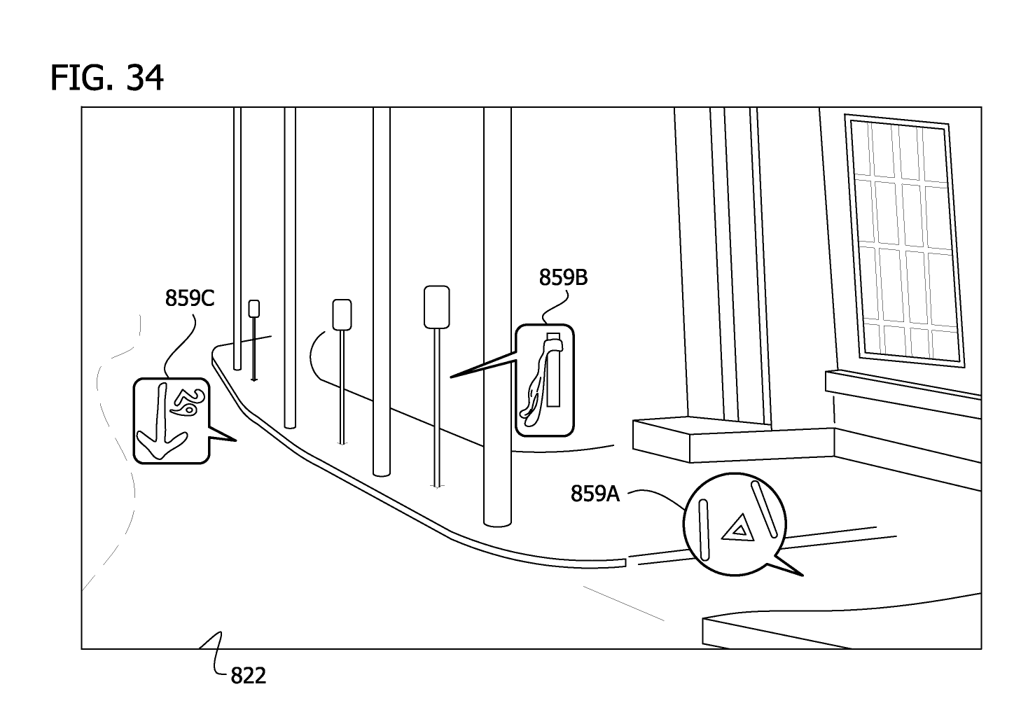

Referring again to FIG. 33, it may be seen that the scan has revealed a utility pipe UP directly under the road, a sewer main SM off the top side of the road and a lateral L connected to the sewer main. On the bottom side of the road as illustrated in FIG. 32, the scan reveals an electrical line EL leading to a junction box JB. A utility pole TP is also shown. FIG. 34 illustrates information that could be provided in a modeled area. The model can as shown produce three dimensional representations of the sidewalk SW and curb CB, of signs SN and utility poles TP. A representation of a building BL along the road and a center stripe CS of the road are also provided on display screen 822 that could be used in conjunction with a scanner. As illustrated in FIG. 34, the display 822 also provides bubbles 859A-859C indicating surface features that would be hard to see in video, or indicating subsurface features. For example, bubble 859A shows the location of a survey marker that could be at the surface or below the surface of the sidewalk. The position of a surveying stake is indicated by bubble 859B, and the location of a marking on the ground is shown by bubble 859C. Other features not readily seen in video, but available in the model could be similarly indicated. Other uses for a fleet mapping vehicle are described hereinafter.

As previously discussed, other types of vehicles could be used for fleet mapping as described. Other types of vehicles may be used on non-recurring, specific job routes, such as for specific delivery, pickup or site service visits. Such vehicles may include parcel delivery, pickup, food delivery, taxi, law enforcement, emergency assistance, telephone service and television service vehicles, to name only some. Just as with the garbage truck 805, these vehicles have primary purposes which are unrelated to mapping or scanning. They may move along substantially random, non-predetermined routes in response to needs unrelated to collecting image data. However, as noted above any of these vehicles could be temporarily routed to a particular location for the purpose of collecting image data. Certainly dedicated scanning vehicles could be used within the scope of the present invention.

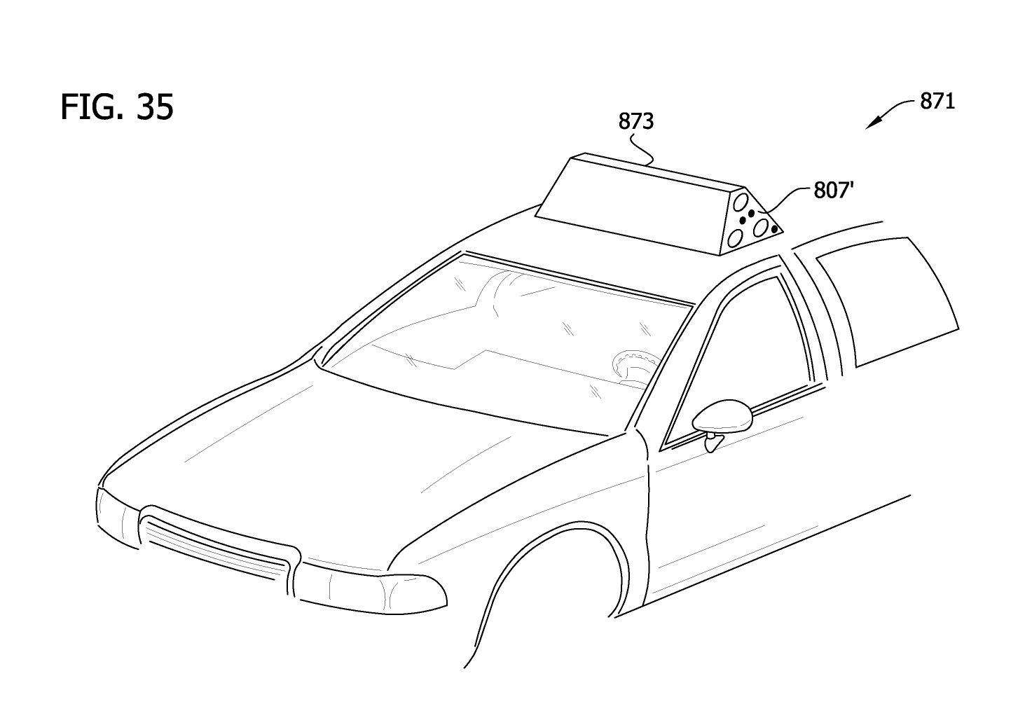

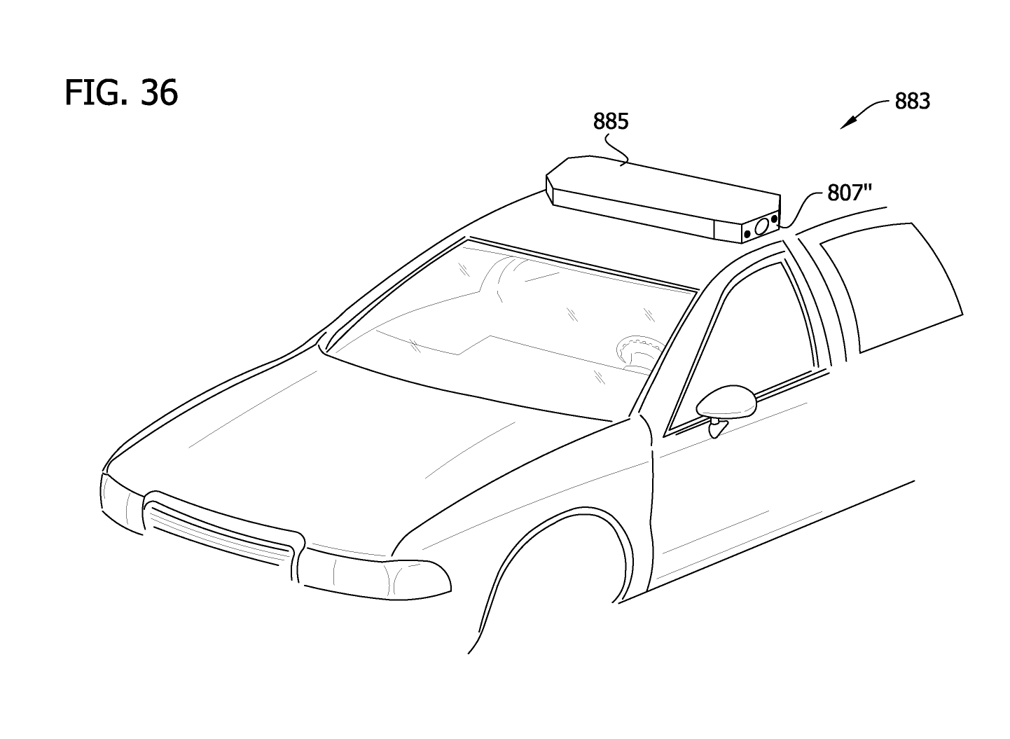

In another embodiment, the scanning pod could be incorporated into an attachment to the vehicle, where the attachment itself also serves a purpose unrelated to mapping and scanning. FIG. 35 illustrates a taxi 871 that has a sign 873 for advertising on top of the taxi. The laterally looking scanning pod 807′ can be incorporated into our housed under the sign 873 for unobtrusively obtaining scanning data. Although not shown, the scanning pod 807′ would include sensors directed away from both sides of the vehicle, just like the scanning pods 807 used with the garbage truck. FIG. 36 shows a law enforcement vehicle 883 in which the scanning pod or pods 807″ are incorporated into a light bar 885.

The synthetic aperture surveying methods of the present invention are a spatial imaging methods in that they observe and acquire mass data points that are geopositionally correlated from within the target areas in scans. The primary sensing technologies include radar and photography. The principle of synthetic aperture involves moving the transmit/receive system in the case of radar and the receive system in case of photography to several known positions over an aperture, simulating the results from a large sensing device.

As with all surveying methods and technologies there are specific environmental conditions under which each technology is limited, reducing its capabilities, or not permitting it to work at all. These limitations require augmentations or alternate adaptive methods in order to produce acceptable results. These augmentations and adaptive methods are addressed by the present invention by providing adaptive multiple modalities through the integrated presence of several surveying technologies, giving the user many more options due to the technologies themselves, but also by their availability, to additional methods of surveying.

The special environmental conditions are many. Some highly relevant features important to execution of a survey, such as prior survey marks engraved on pavement surfaces may be imperceptible to the mass area synthetic aperture scanning mode of the present invention. Other features may be low visibility or sensibility cross sections from particular perspectives but not from alternate perspectives. Three dimensional modeling often requires scanning from multiple perspectives, as terrain or feature objects may conceal, because of the geometry involving the sensor position, other objects that one wishes to survey. This is particularly true when line of sight views from single perspective scanning positions are obstructed. Further, there are situations where relevant features are located adjacent but outside of the effective range of a particular technology. And even further, it is often necessary to perform multiple areas of scanning, and to accurately correlate one area to another, or to correlate to common reference points such as survey monuments that appear in more than one scanned area.

In addition to the previously discussed sensing environmental challenges, the various positioning technologies utilized also have specific environmental limitations which are addressed in the present invention. Cameras, radars, lasers and optical sensing systems like robotic total stations are utilized in various modalities of the present invention. However, these systems and technologies require un-interrupted line of sight visibility from sensor to target which may result in functionally limited or unusable survey technology for particular survey.

Global positioning technologies such as GPS are also utilized for positioning in the present invention. While providing some indication of position, mobile GPS as used in the present invention, in isolation of other augmentations or corrections, is generally not accurate enough for use in high precision surveys. Further, environmental limitations such as buildings, trees and canyons may impair or obstruct visibility to GPS satellites, or localized radio signals may introduce interferences, which may limit or deny effective use of GPS.

Referenced augmentation and corrections may enable sufficient accuracy of GPS. GPS corrections referencing may in some instance be provided by networks of fixed continuously operating reference stations CORS. Correcting GPS signal references may also be provided by local fixed reference stations.

In the present invention various targets, poles, tripods and booms are utilized in static modes to receive GPS signals and provide correctional references to dynamic sensor positioning GPS. These various static mode targets, poles, tripods and booms may also provide GPS positioning references to the points occupied for use in sensing, signal processing and correlation of data taken from different sensing technologies within a synthetic aperture scan, as well as other surveys. If there is GPS on board the boom, then there is further redundancy in the determination of positions of the pole using the GPS on the boom as a GPS base station.

In the present invention in order to improve accuracy of locations of “control” points in a surveying or mapping project, or to register single or mass points that are on a surface that cannot be scanned with synthetic aperture technology, the surveyor can take static positional observations a pole or poles that are set up with support bipods/tripods, or which are handheld by the surveyor. The pole has special targets that make it stand out in a radar scan.

Additionally isotropic shaped spherical or cylindrical translucent targets of the present invention are used which can be clearly identified on photographic images. The isotropic shaped sphere or cylinder may also have a GPS antenna at the top of the sphere or cylinder, to enable GPS positioning of the pole. Another implementation is to flash a strobe or high-intensity LED at the same time that the camera shutter is fired.

In one mode the position of mobile “roving” sensors may be determined, or the GPS on the roving sensor augmented, by utilizing another static sensor of the present invention to capture photographic images of the roving sensor and at the same time capturing range distance measurements by radar or other distance measuring systems, from static sensor to roving sensor. The photographic image can be analyzed to determine relative angular positioning relationships of the rover, and when analyzed with the distance measurements can determine the three dimensional relative position of the rover. When correlated with GPS or other reference points, the position of the rover can be geo-referenced with this method. In some instances the two-sensor method may provide sufficient positional determinations independent of other positioning technologies, and in other instances may provide augmented correctional data to enhance GPS positional observations of the rover sensor.

Using the positioning determination of the mobile rover scanner enables the rover scanner to determine feature positions such as topography, and to also perform scans beyond the range of the target area of the static pod or to scan the same target area from different perspectives.

Another implementation is where there is a GPS base station on board the boom to facilitate GPS positioning. Other GPS implementations for the corrections used by the rover include setting up a GPS base station on a tripod nearby or using widely available real time network GPS corrections via a wireless communications system, typically a cellular modem.

Another refinement of the present invention involves the taking of synthetic aperture images of static targets to map specific points. The static targets may be of the dedicated types as disclosed such as tripods, cones, barrels etc., or may include rover pole mounted or other mobile forms of the present invention which are momentarily held static for positional point observation. While static, synthetic aperture scans of these positional targets may be accomplished by use of another synthetic aperture sensor, as well as by activation of a boom mounted synthetic aperture pod of the present invention.

The present invention has particular application to outdoor surveying. Referring to FIG. 37, a schematic illustration 910 of a synthetic aperture radar scanning system used with targets in the scanning zone is given. A synthetic aperture radar scanning pod 912 is mounted on the end of a boom 914 of a boom vehicle 916. The scanning pod 912 and boom vehicle 916 are in one embodiment capable of being operated as previously described herein for use in creating an image of a zone to be surveyed. In the zone are located several different targets 918. The targets include cones 918A, barrels 918B, a tripod 918C, a first scanning survey pole 918D, a two target element survey pole 918E and a second scanning survey pole 918F. The survey poles 918D-F are shown being held in place by a person, but may be held in any suitable manner, such as one described hereinafter. All or many of the targets 918 may be particularly adapted for returning a strong reflection of radio waves that illuminate the target. Having the targets 918 well defined in the return reflection data is useful in processing the data to establish locations of other objects in the zone.

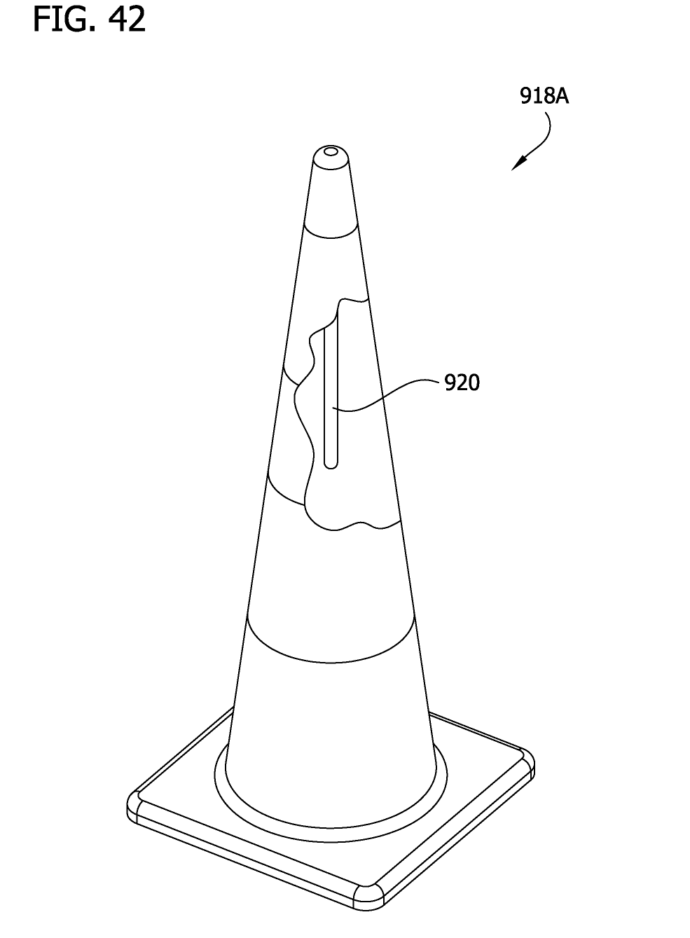

Referring to FIGS. 37 and 42, the cone 918A may be of generally conventional exterior construction. In the illustrated embodiment, the cone 918A includes a metal foil 920 on its interior that is particularly resonant with the bandwidth of radio wave frequencies with which the scanning pod 912 illuminates the target. It will be understood that wire or some other radar resonant material could be used in the cone 918A instead of foil. In one embodiment, the exterior surfaces of the cone 918A are formed from a material which is highly transparent to radar radio waves. The cone will show up prominently in return reflections of the radio waves that impinge upon the cone. This can be used for processing the image data from the radar.

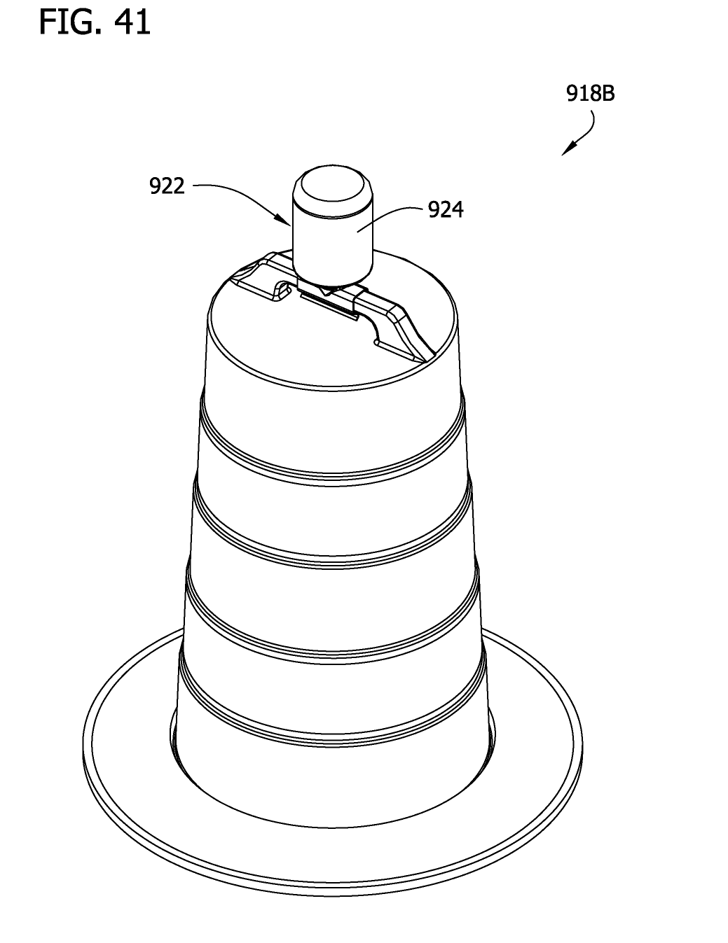

The barrel 918B shown in FIGS. 37 and 41 could be constructed in a fashion similar to the cone 918A, having an internal radar reflecting material. However in the illustrated embodiment, the barrel 918B includes a target element 922 mounted on top of the barrel. As used herein “target” may refer to the combination of a support, such as barrel, and a target element, or the target element or support individually. The target element 922 is particularly constructed to be prominently visible to both radar and to a camera (broadly, a photographic scanner). As described elsewhere herein certain embodiments of the synthetic aperture radar scanning system include both a radar scanner and a camera. Image data from the radar scanner and camera can be correlated to produce a model of the zone scanned. Providing well-defined reference points within the zone can facilitate the correlation. Referring now also to FIG. 41, a target element 922 is shown to include a cylindrical housing 924 that in the illustrated embodiment is transparent to both radio waves and electromagnetic radiation that is detectable by the camera. The cylindrical housing 924 (broadly, “a generally symmetrical structure”), has a shape that at least when viewed within the same horizontal plane appears the same regardless of the vantage within the horizontal plane. Although the cylindrical housing 924 is not completely visually isotropic to the camera, it is sufficiently so that it is easy to recognize the cylinder from all vantages from which image data may be collected by the camera in a scanning operation using shape recognition software. Other shapes for the housing 924 are envisioned, such as spherical (which would be visually isotropic to the camera). The recognizable shape is one way for the camera to identify that it is seeing a target.

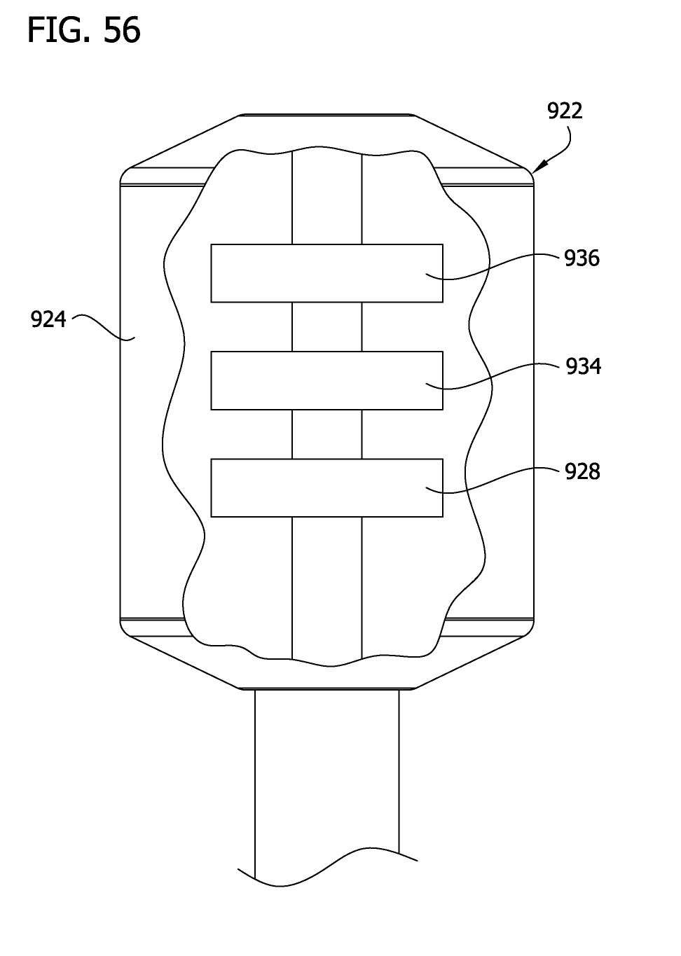

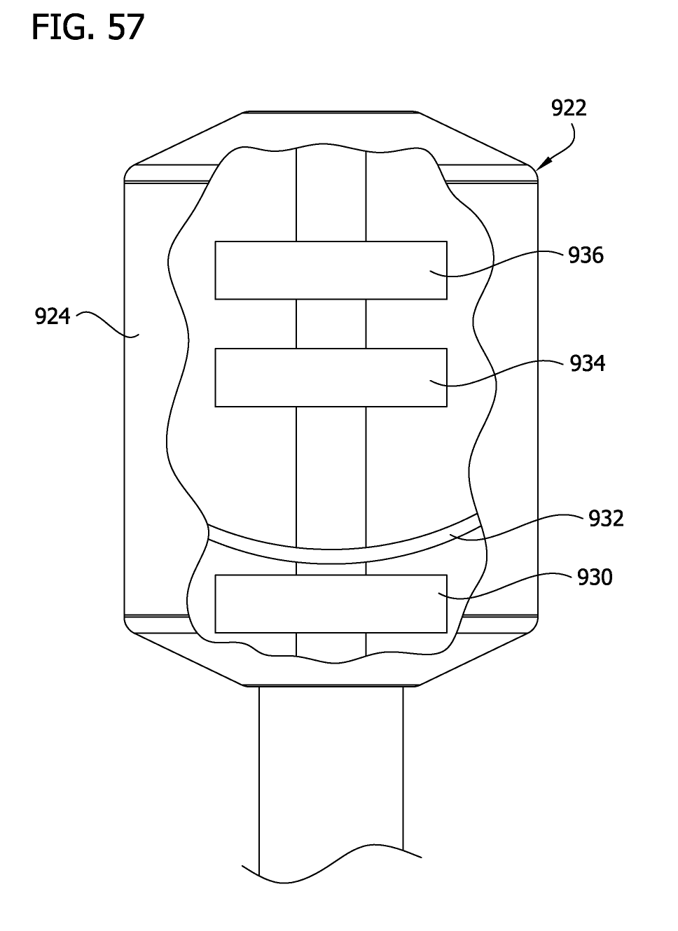

Another way that the target can show up for the camera is by having the target element 922 emit electromagnetic radiation which is highly visible to the camera. One way of doing this is by providing a light in the form of a flash source 928 schematically illustrated in FIG. 56. The flash source is preferably mounted on a centerline of the target element 922 as well as the centerline of the overall target (in this case the barrel 918B). Other positions for the flash source 928 may be used within the scope of the present invention. However, the centerline position provides good information to the camera regarding the location of the entire barrel 918B. In one embodiment, the flash source 928 communicates with the camera on the scanning pod 912 so that when the camera is actuated to obtain image data from the scanning zone, the flash source 928 is activated to give off a flash of light. The light may be in the visible range or outside the visible range (e.g., infrared) so as to avoid distraction to persons in or near the scanning zone. The flash source 928 will show up very well in the photograph for ready identification by the image software to locate a particular point. The flash source 928 may be a strobe light or other suitable light source. The light may not be a flash at all, but rather a constant or semi-constant light source. For example in another embodiment shown in FIG. 57, the visible light source is replaced with an infrared emitting source 930 located near the bottom of the target element 922 within the housing 924. The infrared source's radiation can be detected the camera. As shown, a deflector 932 is provided to guide the infrared radiation toward the sidewalls of the cylindrical housing 924 and away from other components.

The target element 922 may further include structure that is highly visible to radar (e.g., is strongly resonant to the radio waves impinging upon it). As schematically illustrated in FIGS. 56 and 57, the target element 922 includes a radar reflector 934 that may be, for example a metallic part. Similar to the flash device for the camera, the radar reflector would show up prominently in a reflected radar image received by the scanning pod 912. Thus, image software is able to identify with precision this location of the radar reflector (and hence of the barrel 918B) for use in creating model of the scanning zone. Moreover, the common location of the radar reflector 934 and flash source 928 on the centerline of the target element makes it much easier to correlate the radar images with the camera images for use in building up the model of the scanning zone. The radar reflector 934 is also preferably arranged on the centerline of the target element 922 and of the barrel 918B, although other positions are possible.

The radar reflector 934 may include a transponder, illustrated in FIG. 56 that is excited by or activated by radio waves impinging upon the transponder to transmit a signal back to the scanning pod 912 or to another location where a receiver is present. It will be understood that both a dedicated reflector 934 and a transponder may be provided in the target element 922 or otherwise in association with the target. The transponder 934 could function as a transmitter, that is, sending a signal out without being stimulated by impinging radio waves. In one embodiment, the transponder 934 is an RFID tag or wireless activated tag that receives the energy of the radio waves and uses that to transmit a return signal that contains information, such as the identity of the target. However, the transponder 934 may have its own power and provide additional information. For example the transponder 934 could provide position information from a GPS 936 device that is also mounted in the cylindrical housing 924 of the target element 922. A stationary target, such as the barrel 918B could function as a GPS reference station that can be accessed by the scanning pod 912 or processing equipment associated with the scanning pod to improve the accuracy of the position data for the scanning pod. It may be seen from the foregoing, that the targets are interactive with the scanning pod 912.

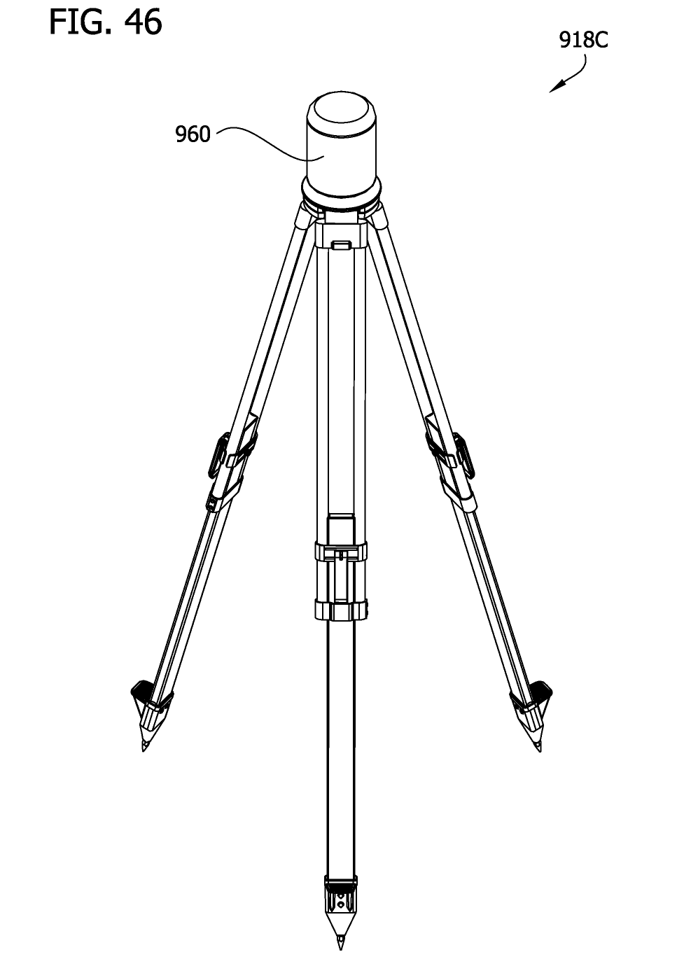

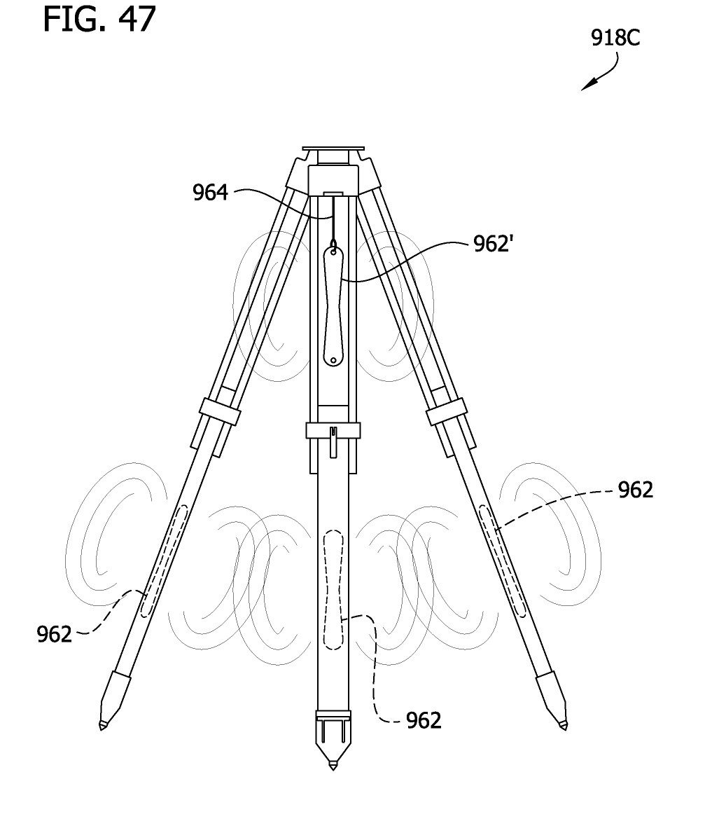

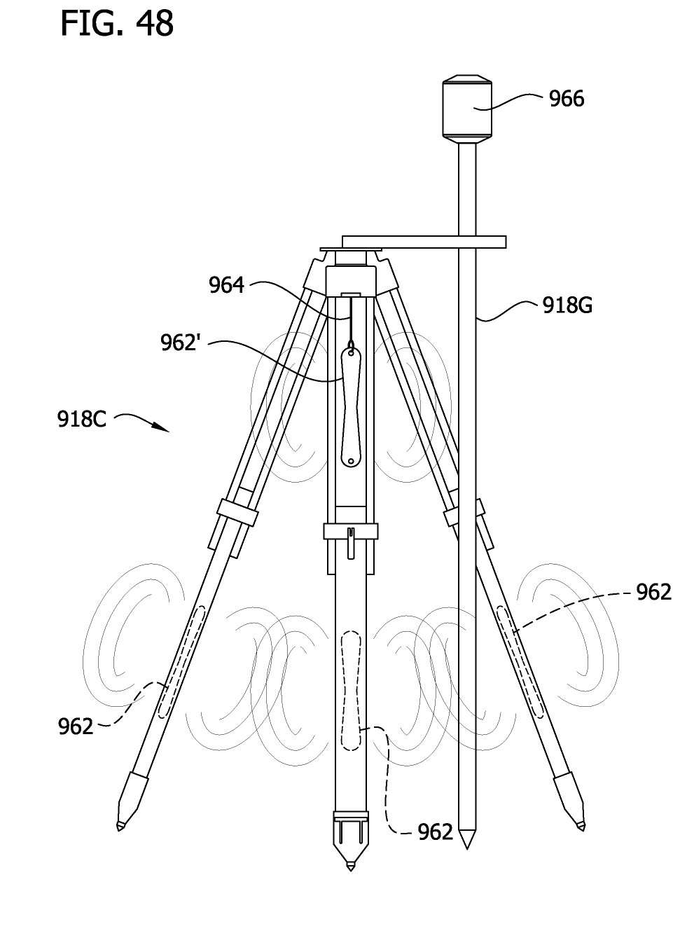

Referring to FIG. 46, the tripod 918C is shown to include a target element 960. The target element can have the constructions described above for the target element 922 associated with the barrel 918B. However, other suitable constructions for the target element 960 are also within the scope of the present invention. As further shown in FIG. 47, the tripod 918C may include radar reflectors 962 within legs of the tripod. The radar reflectors 962 (e.g., radar reflectors) can be embedded in the legs of the tripod 918C, or they (e.g., radar reflector 962′ shown in FIG. 47) may be separate from the tripod and hung on it by a hook 964 associated with the reflector. As shown in the FIG. 47, the radar reflectors are the target elements. However, a target element having the structure of the target element associated with the barrel 918B and the tripod 918C of FIG. A11 may also be used. The tripod 918C can also be used to support a survey pole 918G that includes target element 966, as may be seen in FIG. 48.

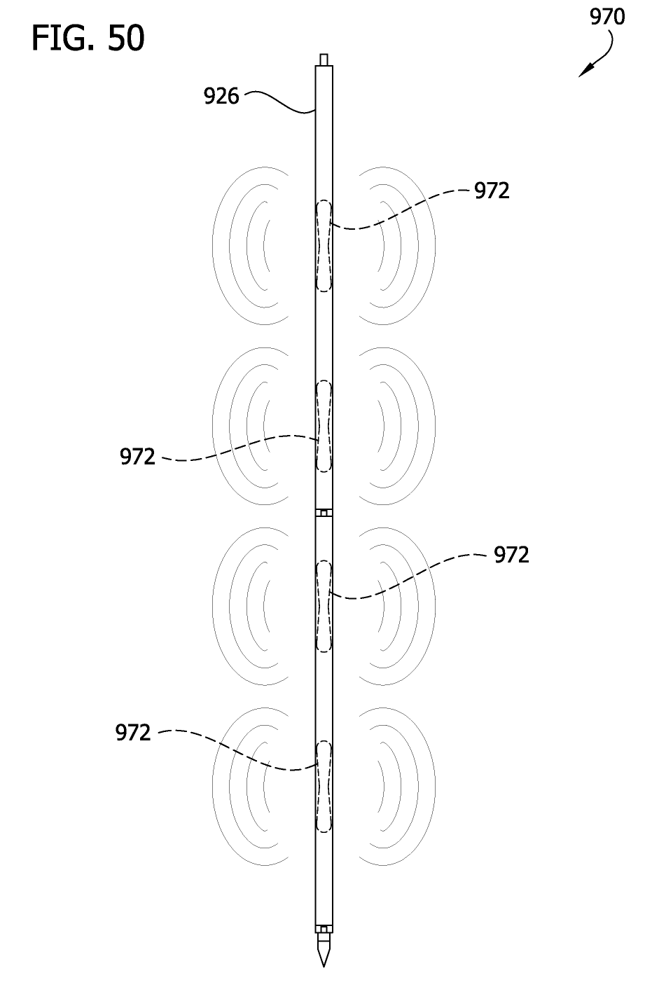

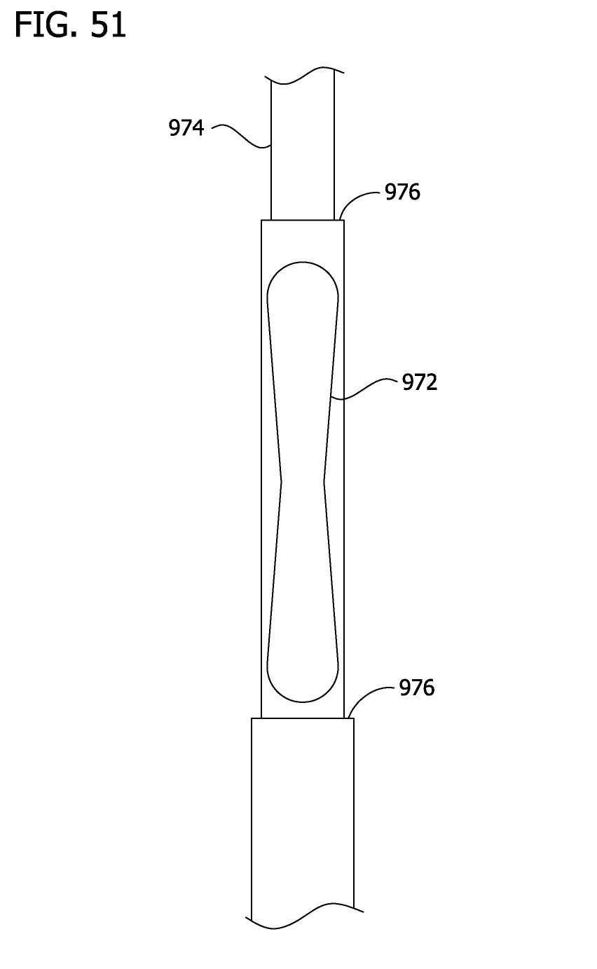

A survey pole 970 shown in FIG. 50 includes embedded radar reflectors 972 like those used in the tripod 918C. In the embodiment illustrated, there are four spaced apart, bow-tie shaped reflectors 972 on one side of the pole 970. The number and or spacing of the reflectors 972 can be used to identify the particular pole being scanned with radar. Other poles or targets may have different numbers and/or different arrangements of reflectors to signify their own unique identity. Bow-tie shaped reflectors are preferentially selected because of their strong resonance to radio waves. FIG. 51 illustrates one way in which the radar reflectors 972 may be embedded in the survey pole 970. A pole 974 may be formed by wrapping material on a mandrel. The material is later cured or hardened to produce the finished pole. In the illustrated embodiment, a radar reflector 972 is placed between adjacent turns 976 of a material wrapping. When the material is cured, the reflector is fixed in place. The material may have a cutout (not shown) or be thinned to accept the reflector without causing a discontinuity in the shape of the pole. It will be understood that the material of the pole is preferable radar transparent.

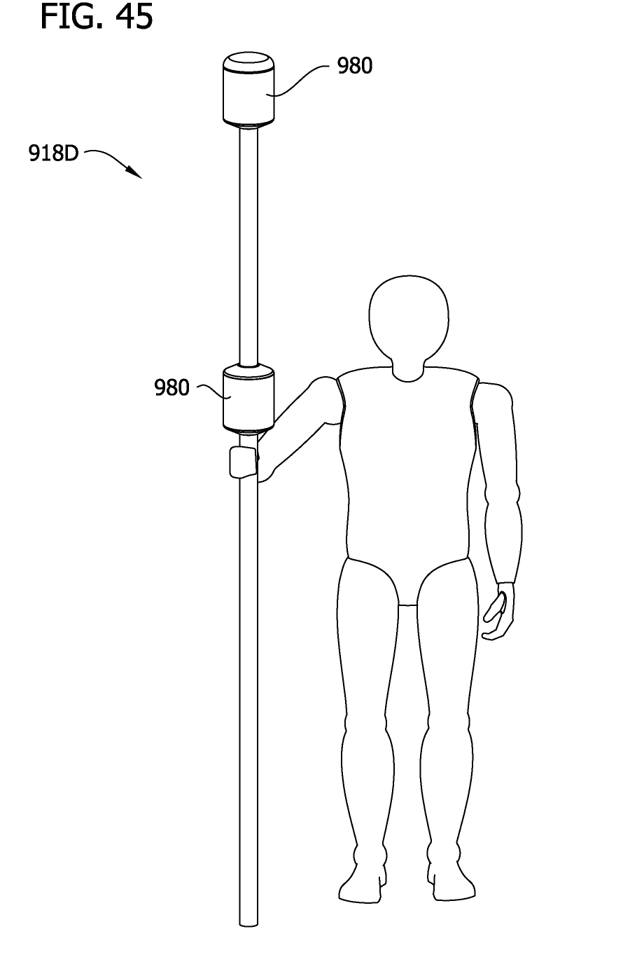

The two target survey pole 918D is shown in more detail in FIG. 45. This survey pole 918E includes two, vertically spaced target elements 980. The target elements may have the same internal construction as described for the target element 922 associated with the barrel 918B, or another suitable construction. By providing target elements 980 that are vertically spaced, precise elevation information can be obtained. As noted above, the target elements 980 may be highly visible to both the radar and the camera. The spacing between these two elements 980 can be precisely defined and known to the image data processing software. This known spacing can be used as a reference for calculating elevation throughout the scanning zone.

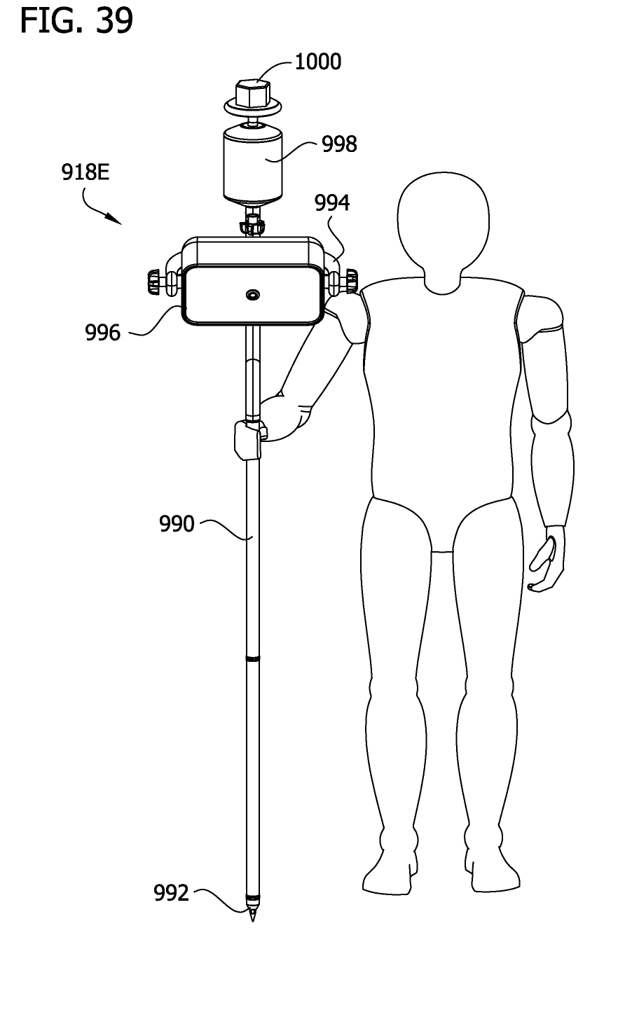

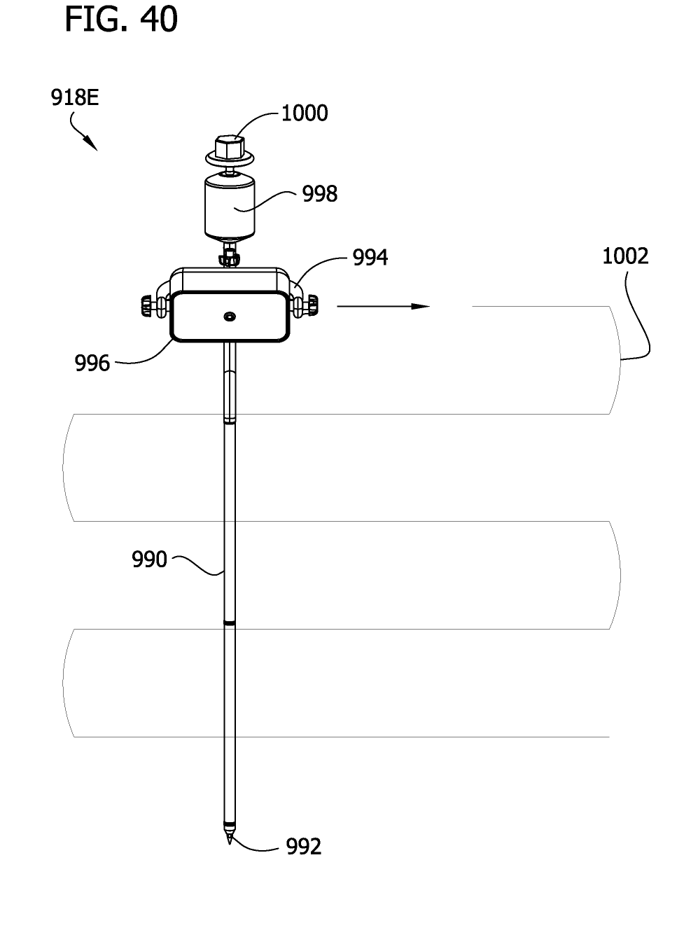

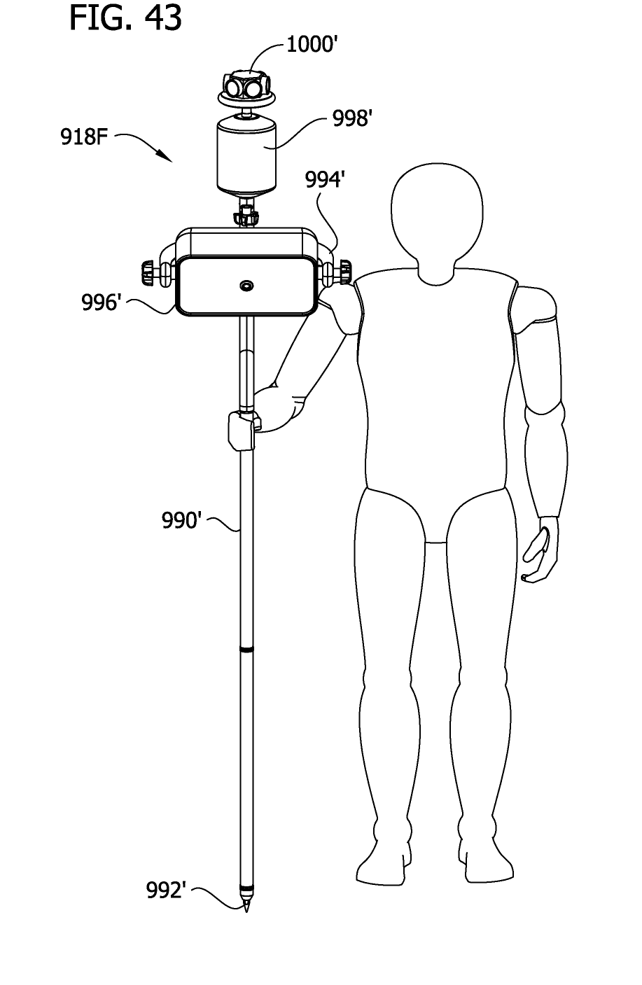

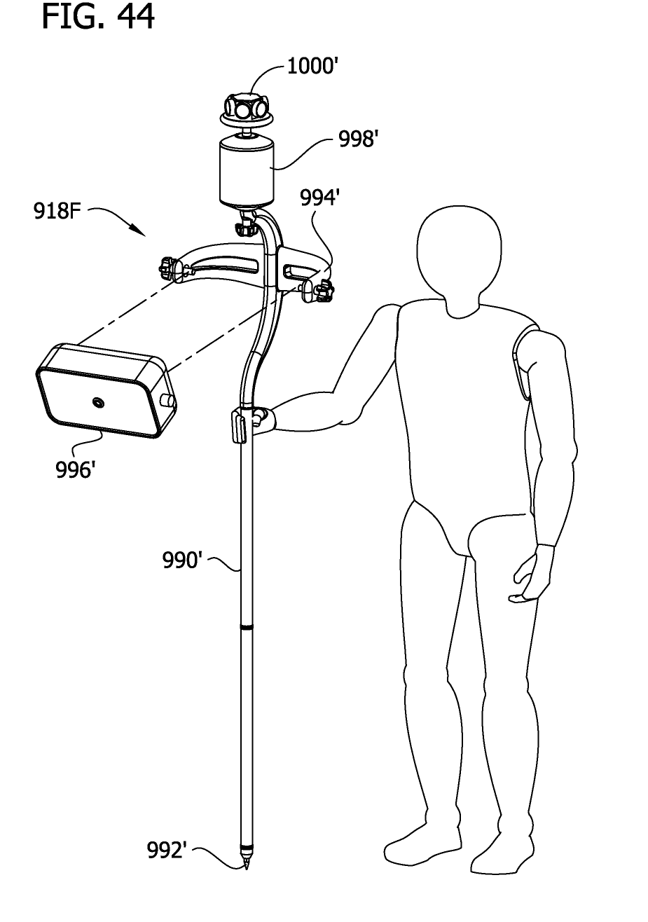

The first and second scanning survey poles 918E, 918F have additional functionality beyond that of the targets previously described. Referring now to FIGS. 39 and 40, the first scanning survey pole 918E includes a pole portion 990 having a tip 992 for placement on the ground or other surface. The first scanning pole 918E further includes a bracket 994 for releasably mounting a scanner 996 such as a synthetic aperture radar scanner. The pole portion 990 also supports a target element 998 that can be similar to the target element 922 described for the barrel 918B. However, in this embodiment, the GPS device 1000 is located on top of the cylindrical housing of the target element 998. It will be understood that other devices could be supported by the first scanning survey pole 918E. For example, a scanning surveying pole 918F may have a corner cube retroreflector 1000′ as shown in FIGS. 43 and 44.

The first scanning survey pole 918E can be used alone or in conjunction with another scanner, such as the synthetic aperture radar scanner 996 shown in FIG. 39 to model the scanning zone. As illustrated in FIG. 40, the first scanning survey pole 918E can be used to generate a synthetic aperture radar image by moving the pole so that the radar scanner 996 sweeps out a pattern sufficient to build the image. A raster type pattern 1002 is shown, but other patterns may be used that give sufficient overlap among separate images. The first scanning survey pole 918E may also include a camera (not shown) so that an image that combines radar and photographic data may be used. The rodman (the person holding and operating the scanning survey pole) may need to perform the scanning action at several different locations in order to get a model of the zone. A display (not shown) may be provided that can guide the rodman to appropriate locations. Targets as described above could be used with the first scanning survey pole 918E in the same way they are described herein for use with the scanning pod 912. Although the first scanning survey pole 918E may have onboard computing capability, in a preferred embodiment the image data is transmitted to a remote processor (not shown) for image data processing. If the boom mounted scanning pod 912 is stationary, the GPS aboard the scanning pod can serve as a reference station to improve the accuracy of the GPS position data on the first scanning survey pole 918E. The first scanning survey pole 918E may be useful in areas where it is difficult or impossible to get a boom or other large supporting structure.

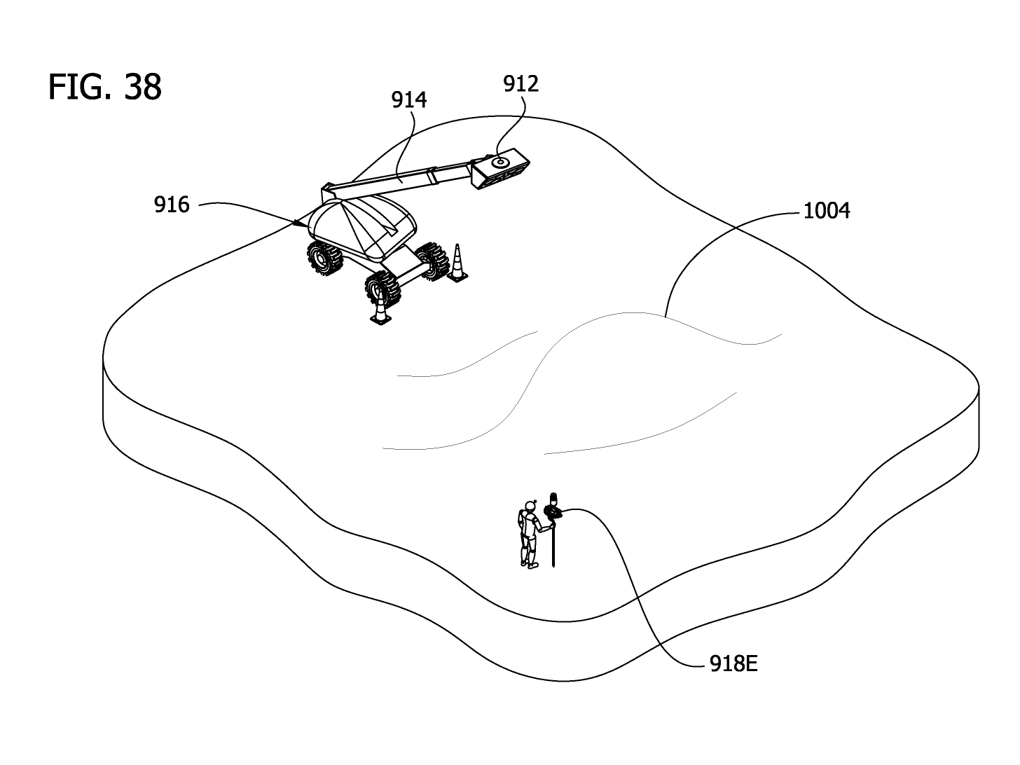

FIG. 38 illustrates a situation in which the first scanning survey pole 918E can be used in conjunction with the boom-mounted scanning pod 912. In this case, the zone to be surveyed includes a rise 1004 which causes a portion of the zone to be opaque to the radar (and camera) on the scanning pod 912. Of course, if possible the boom 914 could be moved to a vantage where the obstructed portion of the zone is visible. However it may not be convenient or even possible to locate the boom 914 so that the obstructed part of the zone can be scanned. Instead of that, the first scanning survey pole 918E could be used in to scan the obstructed portion of the zone. The scan may be carried out in the way described above. The image data from the scanning pod 912 and the first scanning survey pole 918E can be combined to produce a three dimensional model of the entire scanning zone.

The second scanning survey pole 918F is shown in FIGS. 43 and 44 to comprise a pole portion 990′ having a tip 992′ for placement on the ground or other surface. The second scanning pole 918F further includes a bracket 994′ for releasably mounting a scanner 996′ such as a synthetic aperture radar scanner. The pole portion 990′ also supports a corner cube retroreflector 1000′ for use in finding distances to the second scanning survey pole 918F when the second scanning survey pole serves as a target for an electronic distance meter (EDM) using an optical (visible or infrared) light source. Other configurations are possible. For example the second scanning survey pole 918F may include a target element 998′ as previously described.

The scanner 996′ is shown exploded from the bracket 994′ and pole portion 990′ in FIG. 44. The same scanner 996′ (or “pod”) that is mounted on the pole portion 990′ of the second scanning survey pole 918F can be used as a hand held unit for surveying outside or for interior surveying as described elsewhere herein. It will be understood that a scanner or pod of the present invention is modular and multifaceted in application.

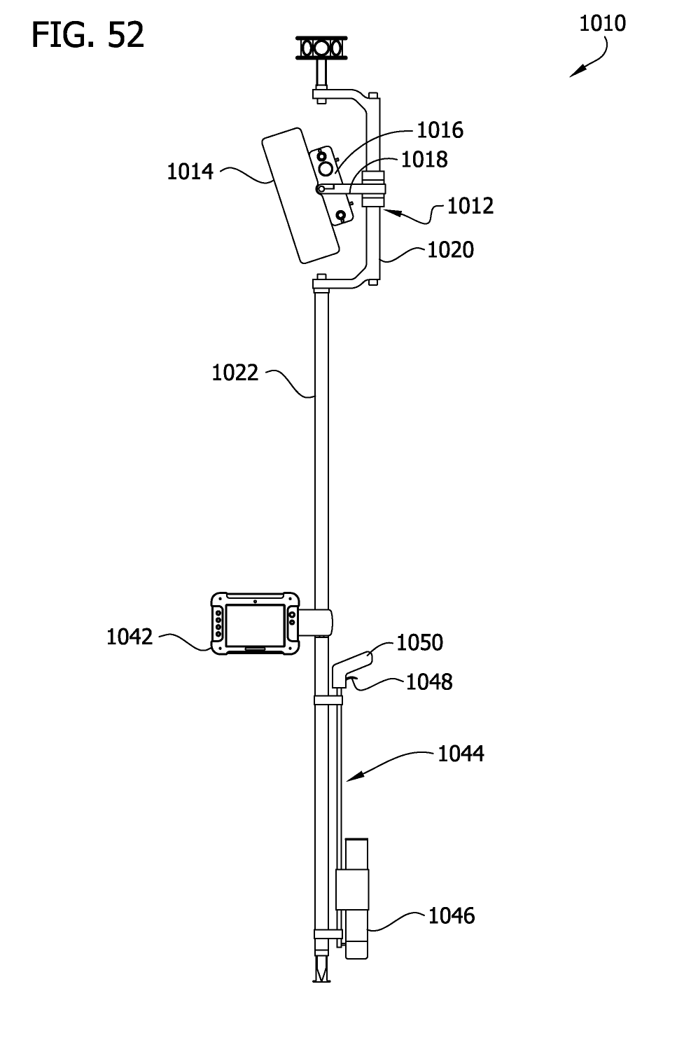

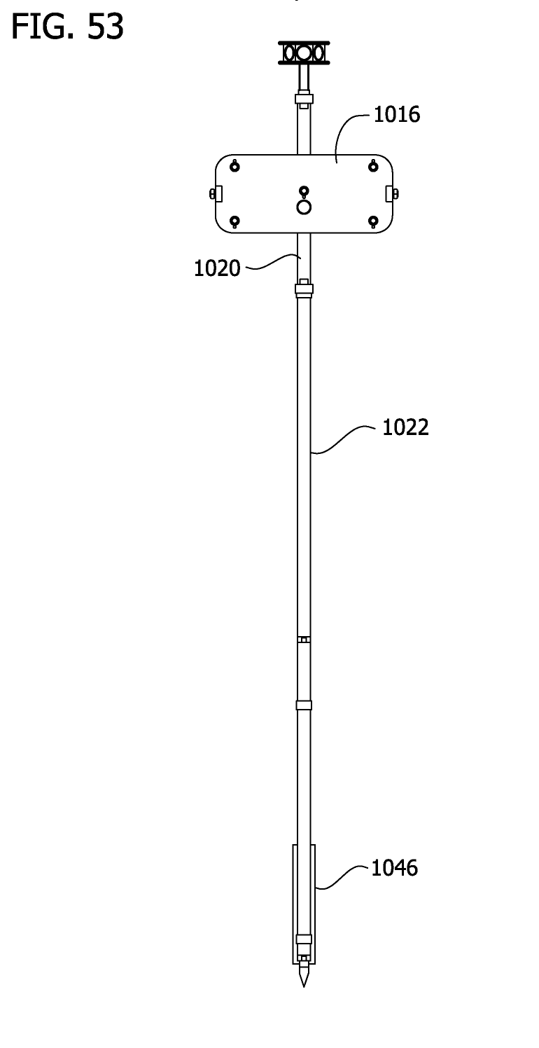

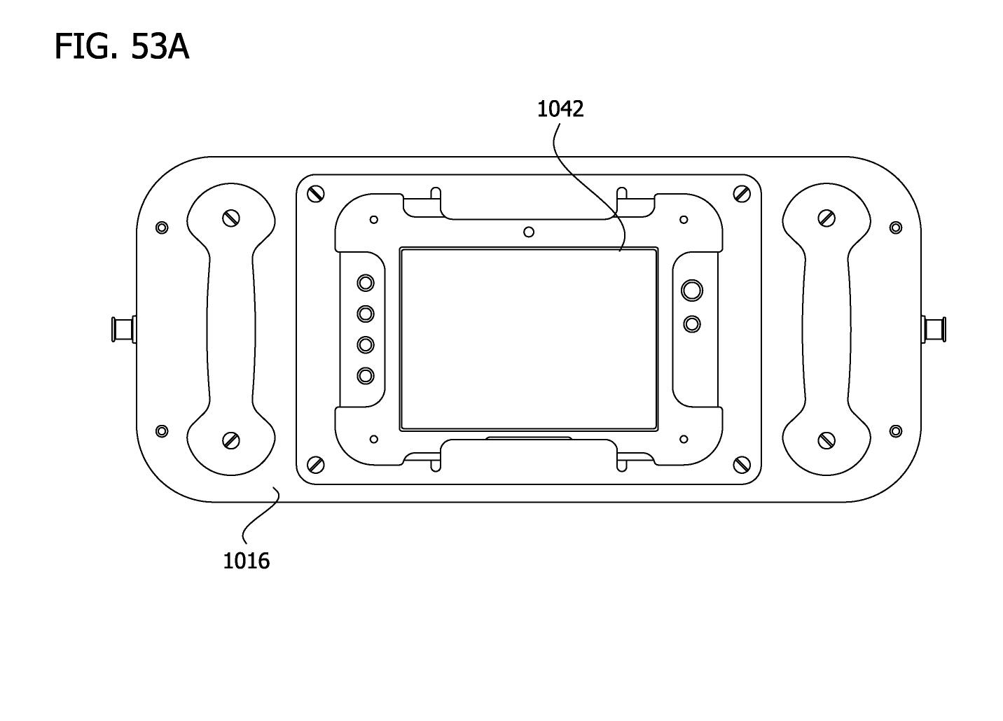

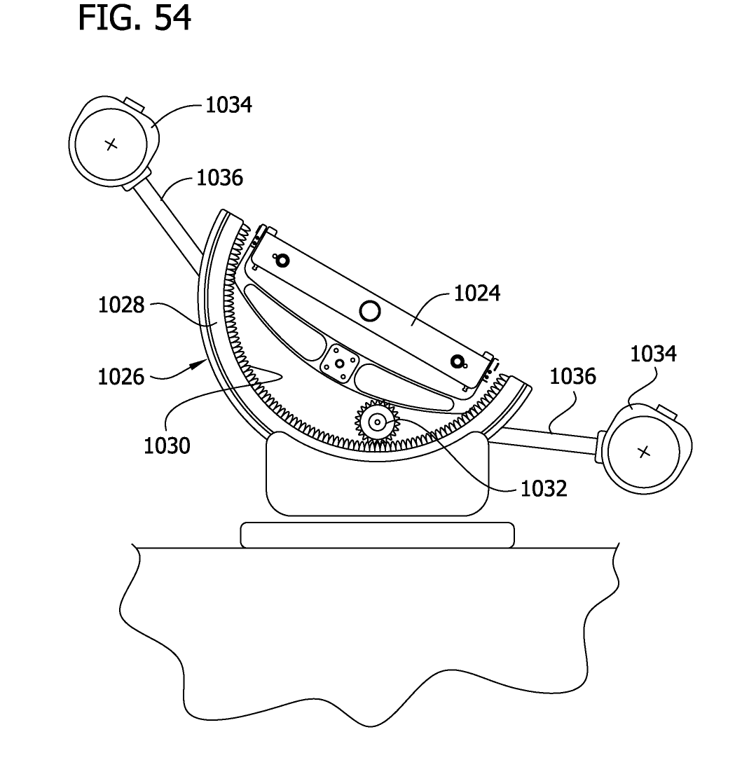

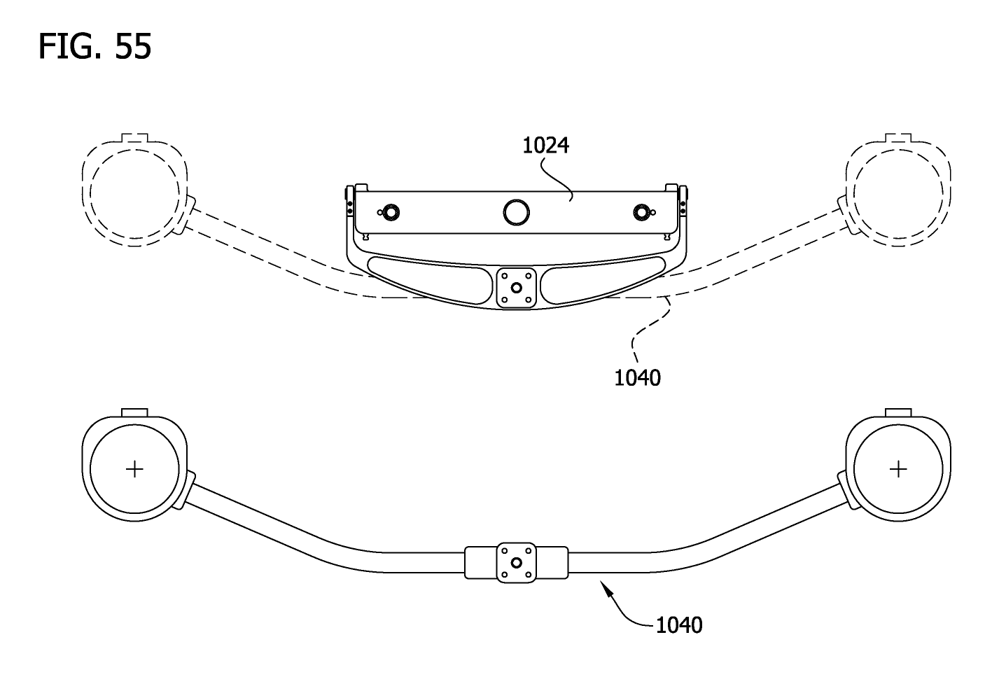

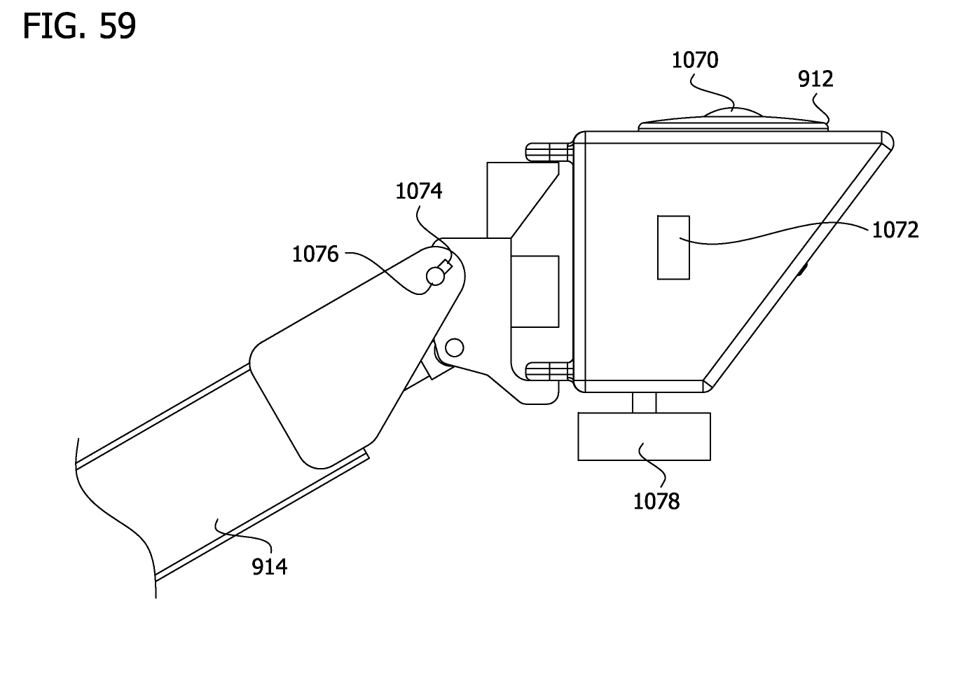

A survey pole 1010 having a different bracket 1012 for releasably mounting radar scanner 1014 is shown in FIGS. 52 and 53. In this embodiment the bracket 1012 is a plate 1016 attached by arms 1018 to a bent portion 1020 of a pole 1022. The scanner 1014 can be bolted or otherwise connected to the plate 1016 to mount on the pole 1022. FIG. 54 illustrates that a modular scanner 1024 may also be mounted in a pivoting base 1026, such as might be used for a swinging boom to keep the scanner pointed toward a target. A fragmentary portion of the boom is shown in FIG. 59. The base 1026 includes a cradle 1028 that releasably mounts the scanner 1024. The base 1026 has teeth 1030 meshed with a gear 1032 that when rotated pivots the cradle 1028 and reorients the scanner 1024. The cradle 1028 also mounts two GPS devices 1034 at the ends of respective arms 1036. Thus, by mounting the scanner 1024 in the cradle 1028, the device has GPS sensor units that give position and azimuth information regarding the scanner. FIG. 55 illustrates that the same hand held scanner 1024 could be equipped with a dual GPS sensor unit 1040 independently of the pivoting base 1026. The scanner 1024 in this configuration can be used for hand-held scanning with the benefit of the dual GPS sensor unit 1040.

The scanner 1014 shown in FIGS. 52 and 53 includes a separable display unit 1042 that can be mounted on the pole 1022 at different locations as suitable for viewing by the rodman. The display unit 1042 can be used as a location for the controls for the scanner 1014. In addition, the display unit 1042 can show the rodman what the scanner 1014 is currently scanning (e.g., the scanner 1014 may have a video camera to facilitate this). Also the display unit 1042 can display information to the rodman to show how to move to a new position for radar scanning, while maintaining sufficient overlap with the last position to obtain sufficient image data for a good resolution model. In one embodiment, the display unit 1042 can be releasably mounted on the scanner 1014 when, for example, the scanner is used as a hand-held unit and is not supported by a survey pole 1010 or any other support. The display unit 1042 may be connected to the scanner 1014 wirelessly or in any other suitable manner. The display unit 1042 may also be releasably attached to the plate 1016 (FIG. 53A). As attached, the scanner 1014 and display unit 1042 can be used as a hand-held scanning device as described elsewhere herein. It is to be understood that instead of being merely a display, the unit could including the control for operating the scanner. The scanner could be elevated to a high position while control of the scanner remains at a convenient level for the rodman. The display may communicate wirelessly or otherwise with other devices, including the Internet. This would allow for, among other things, transmitting data to another location for process to produce an image or model. Data from remote locations could also be downloaded.

The survey pole 1010 of FIGS. 52 and 53 may also include a marking device 1044 mounted on the pole portion 1022 of the survey pole 1010. The marking device 1044 comprises a spray can 1046 arranged to spray downward next to the tip of the survey pole 1010. A trigger 1048 and handle 1050 are also mounted on the pole portion 1022 so that the rodman can simply reach down and squeeze the trigger 1048 to actuate spraying. Having the marking device 1044 on the survey pole 1010 assures that the marks on the ground or other surface will have an accuracy corresponding to the accuracy of the location of the survey pole itself. In FIG. 37, there is a mark 1052 on the ground that could be formed using the survey pole 1010. The center of the “X” could be made when the pole is located using one or more of the scanners 1014 of the present invention. The marking device 1044 can be used, for example to mark on the surface the location of an underground pipe located by the scanners 1014. The display unit 1042 on the survey pole 1010 can tell the rodman when he is properly located relative to the underground structure, and then a mark can be made on the surface using the marking device 1044. If the survey pole 1010 is out of position the scanners 1014 can locate the survey pole and compare its actual location to the desired location from the previously acquired model of the scanning zone. Directions may be made to appear on the display unit 1042 telling the rodman which way to move to reach the correct location for marking.

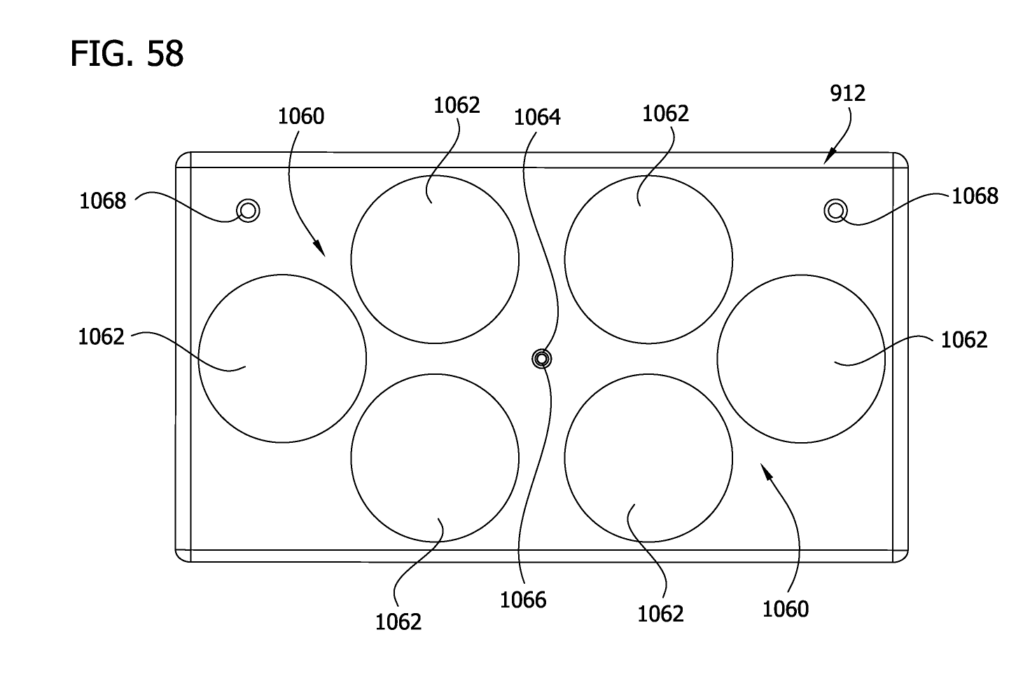

Referring now to FIGS. 58 and 59, the synthetic aperture radar scanning pod 912 is shown in greater detail. FIG. 58 shows that the scanning pod 912 has two radar units 1060, each including three antennas 1062. One radar unit may be dedicated to, for example, emitting radio waves while the other radar unit is dedicated to receiving return reflections. Near the center of the scanning pod front face is an opening 1064 through which a laser 1066 emits light for ranging or other purposes described elsewhere herein. In the particular embodiment of FIG. 58, the scanning pod 912 is equipped with two cameras 1068 indicated by the two openings in the front face of the scanning pod. By providing two cameras 1068 at spaced apart locations, two images are obtained by the camera for each exposure or activation of the camera. The images would be from slightly different perspectives. As a result fewer different positions of the scanning pod 912 may be required to obtain enough image data for generating at least a photographic model.

The scanning pod 912 also includes a GPS sensor unit 1070 mounted on top of the pod. Additionally as shown in FIG. 59, one or more inclinometers and/or accelerometers 1072 (only one is shown) may be provided to detect relative movement of the scanning pod 912. An encoder 1074 can be provided on a pivot shaft 1076 of the boom 914 mounting the pod 912 so that relative position about the axis of the shaft is also known. All of this information can be used to establish the position of the pod 912. In one embodiment, multiple different measurements can be used to improve the overall accuracy of the position measurement.

The scanning pod 912 may also include a rotating laser leveler 1078. The leveler is mounted on the underside of the scanning pod 912 and can project a beam in a plane to establish a reference elevation that can be used in surveying. The beam's intersection with a scanning pole or other target shows the level of the level plane relative to the target and vice versa.

The scanners described herein permit new and useful procedures, including many uses out of doors. The preceding paragraphs have described systems and methods for surveying a zone using one or more scanners and targets. The system just described is useful to collect data representative of survey monuments which may be processed to generate a map or model of the survey monuments. Survey markers, also called survey marks, and sometimes geodetic marks, are objects placed to mark key survey points on the Earth's surface. They are used in geodetic and land surveying. Informally, such marks are referred to as benchmarks, although strictly speaking the term “benchmark” is reserved for marks that indicate elevation. Horizontal position markers used for triangulation are also known as trig points or triangulation stations. They are often referred to as horizontal control marks as their position may be determined using technologies that do not involve triangulation. Historically, all sorts of different objects, ranging from the familiar brass disks to liquor bottles, clay pots, and rock cairns, have been used over the years as survey markers. Some truly monumental markers have been used to designate tripoints, or the meeting points of three or more countries. In the 19th Century, survey markers were often drill holes in rock ledges, crosses or triangles chiseled in rock, or copper or brass bolts sunk into bedrock. These techniques may still be used today when no other modern option is available.

Today in the United States the most common precise coordinate geodetic survey marks are cast metal disks (with stamped legends on their face) set in rock ledges, sunken into the tops of concrete pillars, or affixed to the tops of pipes that have been sunk into the ground. These marks are intended to be permanent, and disturbing them is generally prohibited by federal and state law. These marks were often placed as part of triangulation surveys, measurement efforts that moved systematically across states or regions, establishing the angles and distances between various points. Such surveys laid the basis for map-making in the United States and across the world. Geodetic survey (precise coordinate) markers are often set in groups. For example, in triangulation surveys, the primary point identified was called the triangulation station, or the “main station”. It is often marked by a “station disk”, a brass disk with a triangle inscribed on its surface and an impressed mark that indicated the precise point over which a surveyor's plumb bob should be dropped to assure a precise location over it. A triangulation station is often surrounded by several (usually three) reference marks, each of which bore an arrow that points back toward the main station. These reference marks make it easier for later visitors to “recover” (or re-find) the primary (“station”) mark. Reference marks also make it possible to replace (or reset) a station mark that has been disturbed or destroyed. Some old station marks are buried several feet down (e.g., to protect them from being struck by plows). Occasionally, these buried marks have surface marks set directly above them.

In the U.S., survey marks that meet certain standards for accuracy are part of a national database that is maintained by the National Geodetic Survey (NGS). Each station mark in the database has a PID (Permanent IDentifier), a unique 6-character code that can be used to call up a datasheet describing that station. The NGS has a web-based form that can be used to access any datasheet, if the station's PID is known. Alternatively, datasheets can be called up by station name. A typical datasheet has either the precise or the estimated coordinates. Precise coordinates are called “adjusted” and result from precise surveys. Estimated coordinates are termed “scaled” and have usually been set by locating the point on a map and reading off its latitude and longitude. Scaled coordinates can be as much as several thousand feet distant from the true positions of their marks. In the U.S., some survey markers have the latitude and longitude of the station mark, a listing of any reference marks (with their distance and bearing from the station mark), and a narrative (which is updated over the years) describing other reference features (e.g., buildings, roadways, trees, or fire hydrants) and the distance and/or direction of these features from the marks, and giving a history of past efforts to recover (or re-find) these marks (including any resets of the marks, or evidence of their damage or destruction).

Current best practice for stability of new precise coordinate survey markers is to use a punch mark stamped in the top of a metal rod driven deep into the ground, surrounded by a grease filled sleeve, and covered with a hinged cap set in concrete. Precise coordinate survey markers are now often used to set up a GPS receiver antenna in a known position for use in Differential GPS surveying. Further, advances in GPS technology may make maintenance of precise coordinate survey marker networks obsolete, and many jurisdictions are cutting back if not abandoning these networks.

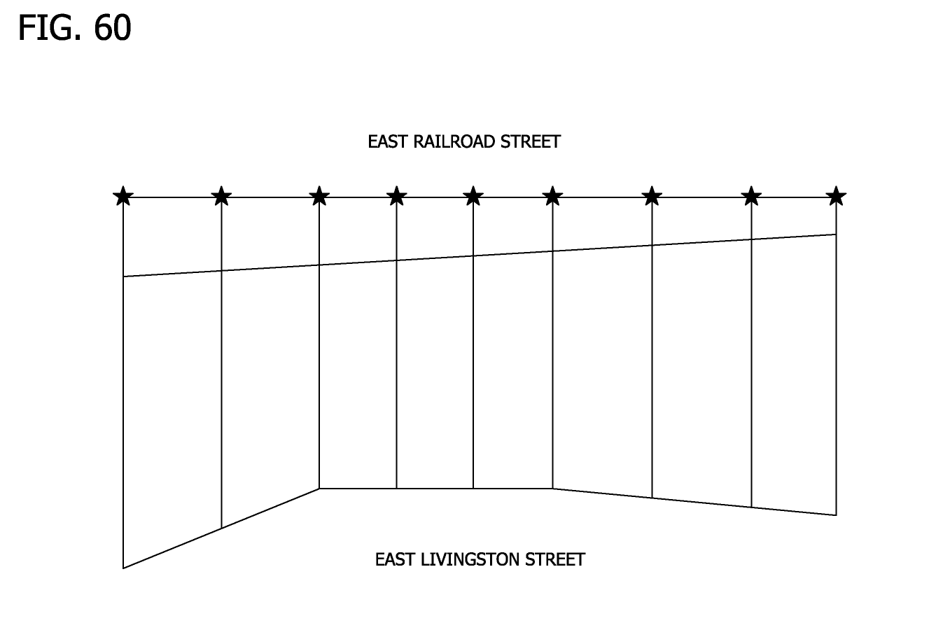

While utilization and maintenance of geodetic precise coordinate survey marker networks may be fading, such is not the case for local property boundary and construction control survey markers. FIG. 60 illustrates a survey plat (or map) with a street right of way (East Railroad Street). Stars are placed to indicate locations of buried survey monument pins along the boundaries of the street. There are several important reasons for the continued importance of local property boundary and construction control survey markers. For one, such monuments may serve as evidence of an accepted boundary, which may be contrary to written land descriptions. Many jurisdictions require professional land surveyors to install local monuments, and often mandate minimum requirements. Further, builders and land owners often rely on the placement of these monuments as a physical reference. The survey pins tend to be more reliable indicators of accurate boundary locations as they are placed by surveyors and are located in the ground below terrain surface, thus avoiding most damage from above ground activities.

Local survey markers are typically provided with simpler construction than those found in geodetic precise coordinate survey marker networks. Modern larger local survey markers are constructed of metallic pipe or metallic reinforcement commonly known as rebar, and usually have metal or plastic caps containing identification such as the name or number of the surveyor that placed the monument. Smaller modern local survey markers are typically provided in wide top nails and tacks, and often have a wider metallic ring just under the wide head, or have inscriptions on the heads containing identification such as the name or number of the surveyor that placed the monument. While important to locate, conventional local and geodetic precise coordinate survey markers can be quite difficult to actually find with conventional means. While typically located near the earth's surface, monuments are most often buried just below the earth surface in order to prevent damage from surface activities such as tampering, vandalism, digging or mowing. Further vegetation growth often further obscures monument locations.

Conventionally hand-held electromagnetic probes are the most common means of searching for monuments. These probes are quite limited in range, and often require significant time to locate monuments, and are often hampered by local metal structures such as fences. Conventional ground penetrating radar devices have also proven to be quite ineffective in location of monuments, as the typically vertical orientation of monuments presents a very small radar cross section (RCS), and normally insufficient to distinguish from surrounding clutter returns. Shallow digging is also employed, however has practical limitations unless high certainty of monument presence is indicated. Further, shallow digging tends to be destructive to the environment and landscape, and often objected to by land owners. Since some monuments have been previously obliterated, many surveyors abandon searches after a period of time, even though important monuments may be present. Also, the location of a single monument at an anticipated general location doesn't rule out the possibility of multiple monuments previously being set by multiple surveyors, a rather frequent occurrence.

The synthetic aperture radar scanners of the present invention use radio waves that are directed along a line that is relatively shallow angle with respect to the ground. A major reason for this is to keep the incidence angle of the radio waves at or near the Brewster angle of the soil that allows more maximum coupling of the radio waves with the soil so that it will enter the ground. Another advantage of this is that the angle of the radio waves relative to the ground will illuminate a greater portion of a vertically arranged object. As noted above, many survey markers are vertically oriented rods or nails. Seen from a vertical vantage, they would show up almost as points and be difficult to locate. Seen from the side, as with the current invention, a much more significant profile will emerge making them easier to detect. If the marker has a metal head, such as would be the case for a nail, a particularly unique and strong return over a greater range of frequencies may be encountered as explained previously herein in relation to locating nails in a building wall. Moreover, a vertical orientation of a survey marker can be more readily distinguished from underground pipes or cables that extend horizontally. Survey nails and tacks are typically set in wood, asphalt and concrete materials. Mount stems of geodetic monuments are often embedded in concrete, and presence and location of monuments are more predictable appearing in or near surface of contrasting material volumes. The proximity of two different materials can also provide a unique radar signature that is helpful in identifying a survey marker. In addition, survey markers tend to be at a relatively shallow depth providing an opportunity for good radar resolution of the markers. Still further, the scanner and method of the present invention may be able to see more than one survey marker in a single scan.

The configuration of survey markers can be programmed into the recognition software so that markers and monuments can be automatically recognized, labeled and annotated. Scanning systems including GPS or other suitable global positioning information may reference the markers in a global or other broader context for later use. Where the markers are automatically recognized field surveyor could be notified by the scanning system of the presence of survey markers or monuments. The markers and monuments could be referenced on a display in relation to objects visible to the field surveyor on the surface to permit rapid physical location of the underground marker or monument. In addition, the field surveyor could be advised as to the probable presence of multiple markers at a single location. Multiple markers at a single location can and do occur where multiple surveys are done in which there is insufficient information regarding a prior survey or efforts to find a prior marker are unsuccessful. The scan may also be able to determine that the survey marker has moved or has been damaged by detecting the orientation and shape of the marker. The field surveyor could be notified of the presence of a damaged marker to prompt replacement or repair. In developed areas where there are roadways, building fences and/or other manmade structures scanning can be facilitated by general contextual knowledge regarding where survey markers are likely to be placed. For example, one would expect to find markers at property corners and along boundary lines and public right of ways. It would be expected that markers are located in positions that are consistent with spacing of markers in adjacent lots. General knowledge can be supplemented by notes from prior surveys regarding the placement of survey markers. Valuable information such as intentional offsets of a marker from a boundary line or corner can be reflected in the surveyor's notes. Using this information, scanning may be sped up by doing a course scan (e.g., a scan in which less image data is collected) in areas where the marker is not expected to be, and fine scan in areas where the marker is expected to be located.

In a preferred embodiment the scanner uses circularly polarized radio waves. When circularly polarized radio waves are emitted by the radar system, a reflection off a single surface causes the radar waves to reverse circular polarization. For example, if the radar emits right-hand circularly polarized radio waves, a single surface return would cause the received energy from that surface to be left-hand polarized. Where a target is being sought that would result in a single surface reflection, signals being received that have been reflected from two or other even number of surfaces would have the same polarity as that emitted. By equipping the radar with receiving antennas that can receive the desired polarity, some of the received energy that should not be analyzed to assess the target can be excluded simply through this means.

In another aspect of the present invention, scanners as described herein may be used to collect data representative of utility taps which may be processed to generate a map or model of the utility taps to determine whether the taps are authorized. Public utilities throughout the world provide customers with valuable services and commodities such as electricity, natural gas, water, telecommunications, CCTV, etc. via underground distribution networks. Legacy above-ground distribution networks were and remain common in some places and for some types of services and distribution infrastructure. For reasons of safety, aesthetics and damage resistance, underground distribution is becoming the preferred means of distribution. However, while safety, aesthetics and damage resistance objectives are well served, underground distribution has a serious limitation in that it tends to conceal unauthorized connections for services. The risk for utilities providers includes revenue loses, but also dangerously unsafe conditions resulting from improvised workmanship commonly associated with these unauthorized connections. The conduit mains of underground utilities are most commonly located in right of ways, such as in or along streets. Individual customer service lines extend from these conduit mains in the right of ways across subscriber's property to Points-of-Service (POS) at the customer premises.

Utilities derive revenues from several sources, but mostly through service tap fees and metered use fees. While some forms of utilities are prone to distribution system leaks, it is well known that all forms of utilities experience “shrinkage” (theft of service revenues) resulting from unauthorized, illegal service connections. These unauthorized, illegal taps can be made directly to the mains located in the right of ways, or occur on subscriber's premises on the un-metered portions of utility service lines. Many unauthorized, illegal taps are known as “double taps.” Double taps are where subscribers openly pay for metered utilities service, but also secretly and illegally obtain un-metered service, typically by, without authorization, connecting to legitimate service lines prior to metering to circumvent metering. Double tapping can be particularly difficult to police as a base utility connection for services are legitimately provided to subscriber premises, and unauthorized connections can be made unbeknownst to the utilities on property owned by subscribers.

Several remote sensing and database analytical type methods of screening and flagging locations of suspected unauthorized connections to utilities exist within the prior art. For instance subscriber billing records of multiple utility services can be compared against likely consumption, such as comparing energy utilities (i.e. gas and electric) billings for subscriber's premises to see if a rational amount of energy is being paid for to heat the subscriber's structure. Aerial surveys including thermography surveys are able to identify premises where energy is being consumed, as well as estimates of structure size and associated energy requirements.

While remote sensing and database analytical type methods of the prior art are capable of identifying potential sites for unauthorized utilities connections, the prior art methods can only indicate increased probabilities of presence of unauthorized connections at specific premises. However, prior art remote sensing and database analytical type methods cannot effectively account for many factors such as partial or limited occupancy of premises, or utilization of alternate forms of energy such as solar or wood fire. Although often useful for screening, and instigation of further investigations, the remote sensing and database analytical type methods of the prior art are insufficiently conclusive in determination of actual presence of unauthorized connections. The problem of conclusive discovery is compounded by the fact that most unauthorized connections are purposefully covered over, and all or at least some portions lie on subscribers' premises making speculative digging impractical. It is believed that there is currently is no effective technology to survey, investigate or discover many covered over unauthorized utilities connections. And once unauthorized utility connections are covered over, revenue losses and safety risks can occur for many years undetected.

In an aspect of the present invention, scanners such as those described above may be used to scan an outdoor environment to collect image data representative of the environment, including particular underground objects such as utilities and taps of the utilities present in the environment. The image data may be used to generate a model, using steps similar to those described above. The model may be provided for mapping utilities and taps of the utilities. From the model, the various types of taps to utilities described above, and other types of taps, may be directly identified, even though the taps may be underground or otherwise hidden. The detected taps can be compared to a database of authorized taps to create a list of exceptions. The taps indicated as exceptions can be further investigated to determine whether the taps are authorized. This provides a non-invasive and reliable method of detecting the presence of unauthorized taps of utilities, which of course would be subject to obtaining any required permission.

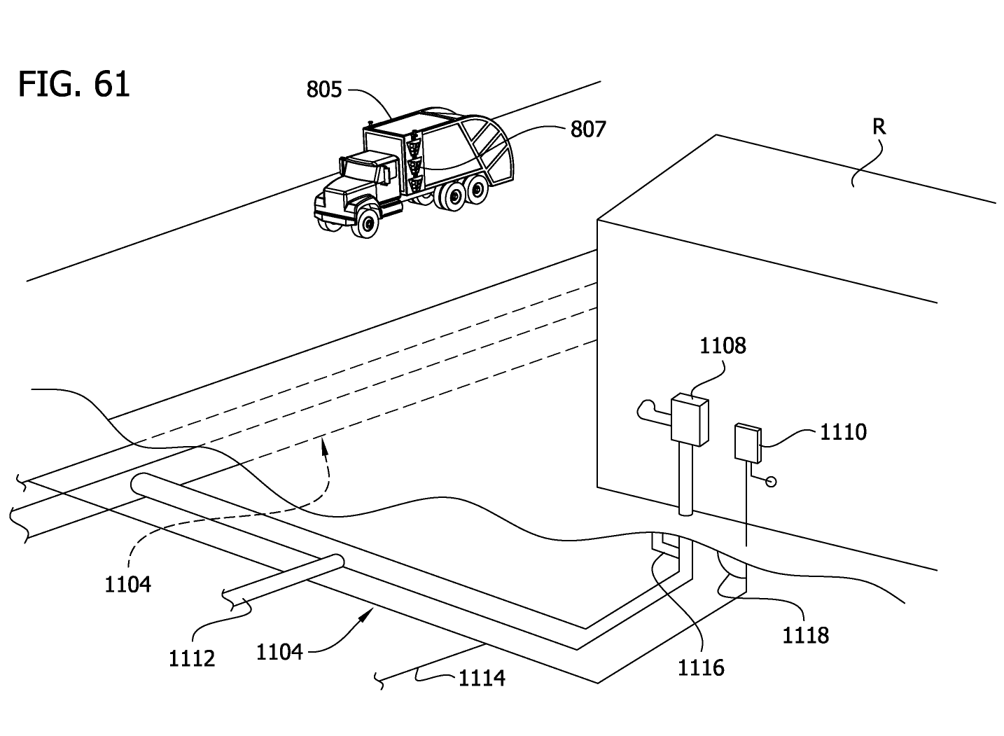

One example of the foregoing is illustrated in FIG. 61. In this example mapping information regarding utilities may be obtained from fleet mapping as described in greater detail elsewhere herein. In this case a scanner 807 is mounted on a garbage truck 805 that passes through a neighborhood. After a sufficient number of passes, a model may be created that shows main utilities 1104 running along the right of way. In FIG. 61 these include natural gas main and electricity main. In addition, the model can show laterals 1106 from the gas main and the water main running toward a residence R. Fleet mapping of this type might be supplemented (or replaced) by other forms of scanning such as hand-held or survey pole mounted scanners described elsewhere herein. It is noted that, at least in this illustration, a gas meter 1108 and an electric meter 1110 are readily observed above ground without any scanning, or could be part of the scan if photography or other above ground scanning is also employed. These appear to show ordinary, authorized connection of the gas lateral and the electric lateral to the residence R. It is possible that even detection of the lateral may show unauthorized usage where the residence R is not on a database of utility subscribers for either gas or electricity in the illustrated embodiment. The scan also reveals a first gas branch 1112 from the gas lateral and a first electrical branch 1114 from the electric lateral. These can be compared to a database of authorized laterals and it can be determined whether these branches are authorized. In addition, the scan reveals subterranean second gas and second electric branches 1116, 1118, respectively next to the residence R. These would appear clearly to circumvent the gas meter and electric meter and therefore be unauthorized taps. It would still be possible and desirable to compare the model information with records of authorized taps. Unauthorized taps might be detected using contextual information. For instance, a water lateral would be expected to go to a water meter vault (often located underground). If the lateral does not intersect the water meter vault, an unauthorized bypass may be indicated.

Other information may be obtained in the survey. Photographic images may be used to show whether the residence R is occupied. An occupied residence would be expected to use utilities. The scanner 807 could have thermal imaging that could show heating or cooling going on in the residence R as an indication of occupancy and use of utilities. It may also be possible to observe that a utility meter has been removed or covered up from the model generated, or that the ground has been disturbed around a meter or utility line that might suggest an unauthorized tap has been made.

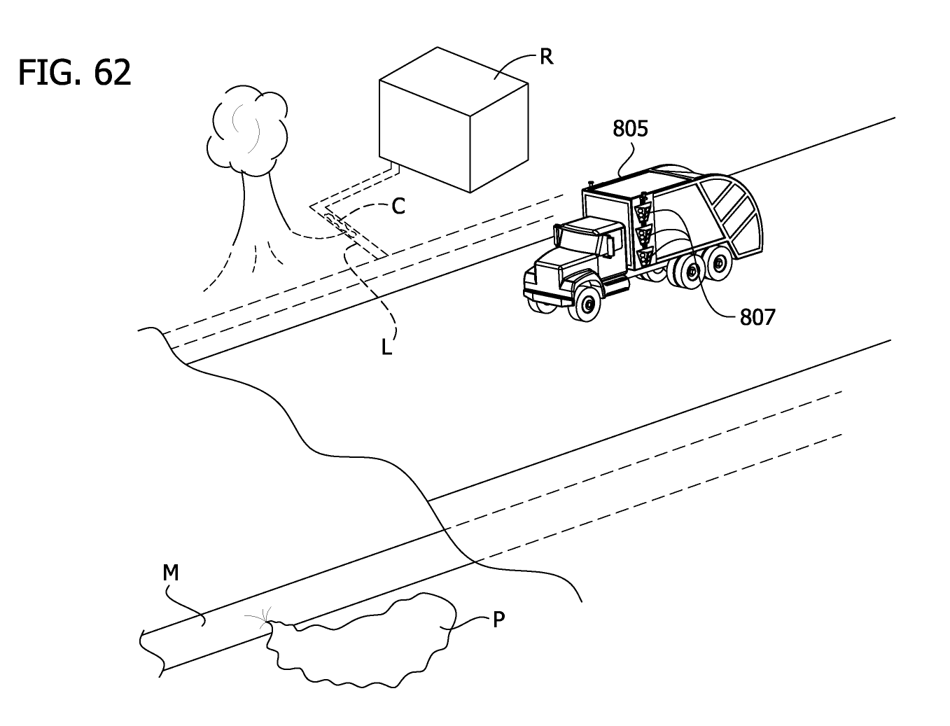

Referring now to FIG. 62, it is also possible to detect leaks or clogs in lines. As with the embodiment shown in FIG. 61, a model of a neighborhood, including both above-ground and underground features can be generated using a fleet mapping vehicle such as the garbage truck 805 having the scanner 807 shown in FIG. 62. Again, other scanners could be used. Water and other liquids are particularly resonant to radar. Thus a clog C in a lateral L could be readily detectable by a buildup of water in the sewer line from the residence R to the sewer main running along the street. In this case, roots of a tree have entered the lateral L, causing an obstruction. The owner or municipality could be advised of the need for repair prior to a serious consequence, such as sewage backing up into the residence R. Another main M is shown by the model on the opposite side of the street. Here the radar detects a plume of liquid P. The shape of the plume can be mapped with enough passes. The model can show not only that a leak is present, but by examining the shape of the plume P determine the location of the leak along the main M.

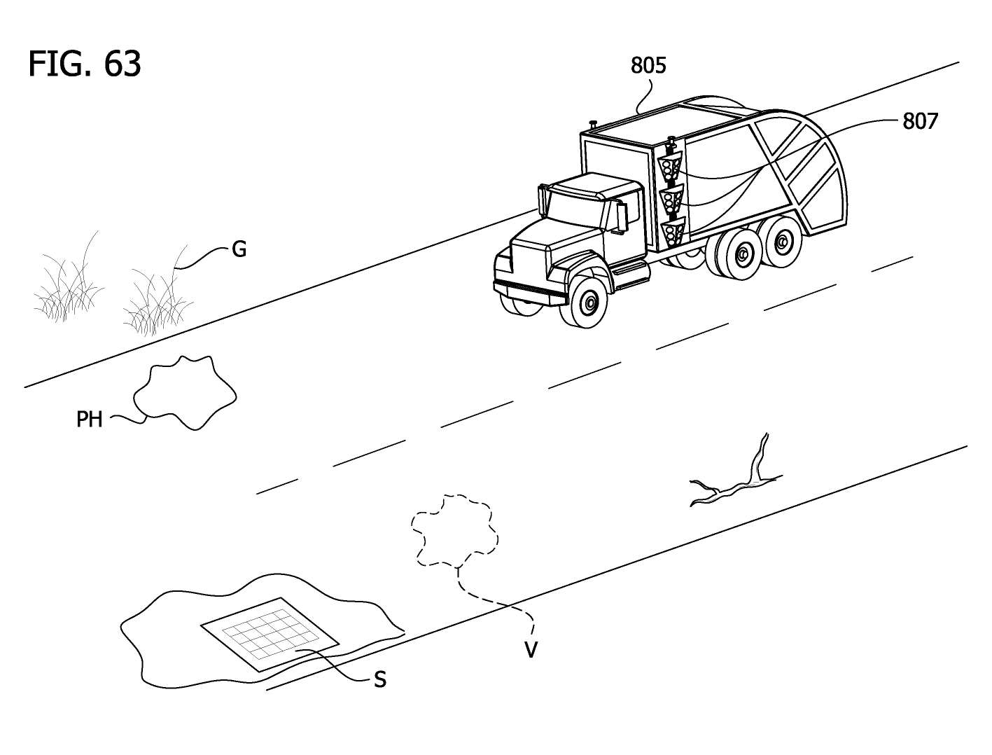

Scanners of the present invention have still further uses along rights of way. As shown in FIG. 63, the garbage truck 805 including a scanner 807 is traveling along a road with other detectable features. It will be appreciated that while the garbage truck scanner 807 can be useful for detecting the features described hereinafter, it does not have to be dedicated to that purpose. In one example, the scanner 807 is able to detect that grass G along the roadway has grown to unacceptable height. This can be used to schedule mowing on an as needed basis.

The scanners described herein may be used to collect data representative of roadway damage which may be processed to generate a map or model of the roadway damage to locate it for remedial purposes. Potholes are sometimes also referred to as kettles or chuckholes, are a type of disruption in the surface of a roadway where a portion of the road material has broken away, leaving a hole. Most potholes are formed due to fatigue of the road surface. As fatigue fractures develop they typically interlock in a pattern known as crocodile cracking. The chunks of pavement between fatigue cracks are worked loose and may eventually be picked out of the surface by continued wheel loads, thus forming a pothole.

The formation of potholes is exacerbated by low temperatures, as water expands when it freezes to form ice, and puts greater stress on an already cracked pavement or road. Once a pothole forms, it grows through continued removal of broken chunks of pavement. If a pothole fills with water the growth may be accelerated, as the water “washes away” loose particles of road surface as vehicles pass. In temperate climates, potholes tend to form most often during spring months when the subgrade is weak due to high moisture content. However, potholes are a frequent occurrence anywhere in the world, including in the tropics. Pothole detection and repair are common roadway maintenance activities. Some pothole repairs are durable, however many potholes form over inadequately compacted substrate soils, and these tend to re-appear over time as substrate supporting soils continue to subside.

Early detection of the formation of new potholes and monitoring of repaired potholes are important for several reasons. Keeping records of potholes can show a pattern of repeated pothole formation that can indicate a more serious problem with the roadway bed. Safety for drivers is much better assured if potholes can be repaired before becoming large. Further, costs of repairs are significantly lower if repairs can be scheduled in advance rather than made when they become an emergency. Traditionally pothole maintenance occurred along routes without mapping of specific potholes unless they had become large and dangerous enough that they were reported by inspectors, public officials or passerby travelers. Potholes would be repaired as indicated, however historically geo-specific records of potholes was not practical so little could be done to monitor repairs or predict future repairs.

As previously described, water is particularly radar resonant. Thus, the pothole PH shown in FIG. 63 when filled with water is highly visible to the scanner and so easily detected. Similarly a smaller crack precursor to a pothole is detectable, particularly when filled with water. In addition a subterranean void V, also a precursor to a pothole can be detected with the scanner 807. In all instances, early notification can be given to entities charged with repair. Early repair can reduce instances of serious vehicle damage, or even injury caused by potholes. FIG. 63 also illustrates that a clogged ground water sewer S may be detected. In this case, water backed up on the road at the location of a sewer drain shows the presence of a clogged or damaged sewer line.

The size and extent of potholes, cracks and potential troublespots identified with the radar, and their locations can be input into a database, which may underlie a geographical information system (GIS). To do this, GPS sensor units can be mounted on the vehicle that houses the radar or on the radar itself so that the geo-referencing of features (in this case problem areas) is done as part of the scanning, data recording and radar analysis process. When the potholes and other problems areas are identified, either automatically or manually, they will already have their geographic position attached to them. Thus the output of the processing system can be configured to output files that can be read by the target GIS so that clear identification of potholes and other problems, their condition and location is possible.

In another aspect of the present invention, scanners 807 as described herein may be used to collect data representative of soil compaction which may be processed to generate a map or model of the soil compaction for various purposes. Soil compaction is an important consideration in geotechnical engineering, and involves the process in which stresses are applied to soil volumes and causes densification as air is displaced from the pores between the soil grains. When stress is applied that causes densification due to water (or other liquid) being displaced from between the soil grains then consolidation, not compaction, has occurred. With regard to the present invention, the distinction between soil compaction and soil consolidation is minor as they form similar properties. Soil compaction is a vital part of the construction process as soil is used for support of structural entities such as building foundations, roadways, walkways, and earth retaining structures to name a few. For a given soil type certain properties may deem it more or less desirable to perform adequately for a particular circumstance.

Geotechnical engineering analysis and designs are typically performed to insure that when proper preparation is performed, preselected soils should have adequate strength, be relatively incompressible so that future settlement is not significant, be stable against volume change as water content or other factors vary, be durable and safe against deterioration, and possess proper permeability. Because the life and integrity of structures supported by fill are dependent on soil resistance to settlement it is critical that adequate soil compaction is achieved. To ensure adequate soil compaction is achieved, project specifications will indicate the required soil density or degree of compaction that must be achieved. These specifications are generally recommended by a geotechnical engineer in a geotechnical engineering report. Generally sound geotechnical engineering designs can avoid future subsidence problems. However insuring that proper compaction is uniformly achieved during construction is a much more difficult challenge.

If poor material is left in place and covered over, it may compress over a long period under the weight of the earth fill, causing settlement cracks in the fill or in any structure supported by the fill. Further, just relatively small areas of insufficient compaction can jeopardize the longevity and integrity of a larger supported structure. So insuring that all supporting soils are properly compacted is essential to long term construction project success.

During the construction process, when an area is to be filled or backfilled the soil is typically placed in layers called lifts. The ability of the first fill layers to be properly compacted will depend on the condition of the natural material being covered. Compaction is typically accomplished by use of heavy equipment. In sands and gravels, the equipment usually vibrates, to cause re-orientation of the soil particles into a denser configuration. In silts and clays, a sheepsfoot or flat surfaced roller is frequently used to drive air out of the soil. While these soil compaction process techniques are generally effective, it is essential that they be properly applied to the entire design area, and without having gaps or small areas of poor compaction.

Conventionally, determination of adequate compaction is done by determining the in-situ density of the soil and comparing it to the maximum density determined by a laboratory test. The most commonly used laboratory test is called the Proctor compaction test and there are two different methods in obtaining the maximum density. They are the standard Proctor and modified Proctor tests; and the modified Proctor is more commonly used. The limitation of these soil sample test methods are that they can only test very small samples of an overall volume, which may not detect smaller areas within the overall area where poor compaction may have occurred.

More recently in the prior art soil, adequacy of proper soil compaction may be better assured by monitoring, mapping and analyzing, the paths and elevations of heavy compaction equipment with the use of GPS or other positioning technologies. Path mapping and analysis technologies of the emerging prior art are capable of geo-flagging many suspected potential sites of insufficient soil compaction. However, path mapping and analysis technologies are limited in that they are not capable of measuring actual soil compaction conditions. Path mapping and analysis technologies are also limited in the types of heavy compaction equipment they can be utilized on, and typically are incompatible with vibration and sheepsfoot compactors.

The apparatus and methods of the present invention allow for a particularly complete survey of land to be conducted. In the first instance, topological features are found as before, but with much greater precision as a far greater number of points on the survey are examined. However, the survey is three dimensional including a survey of beneath the ground. For example, the presence and condition of utilities or building foundations can be established. Still further the scanner of the present invention can detect vegetation and show that on the survey.

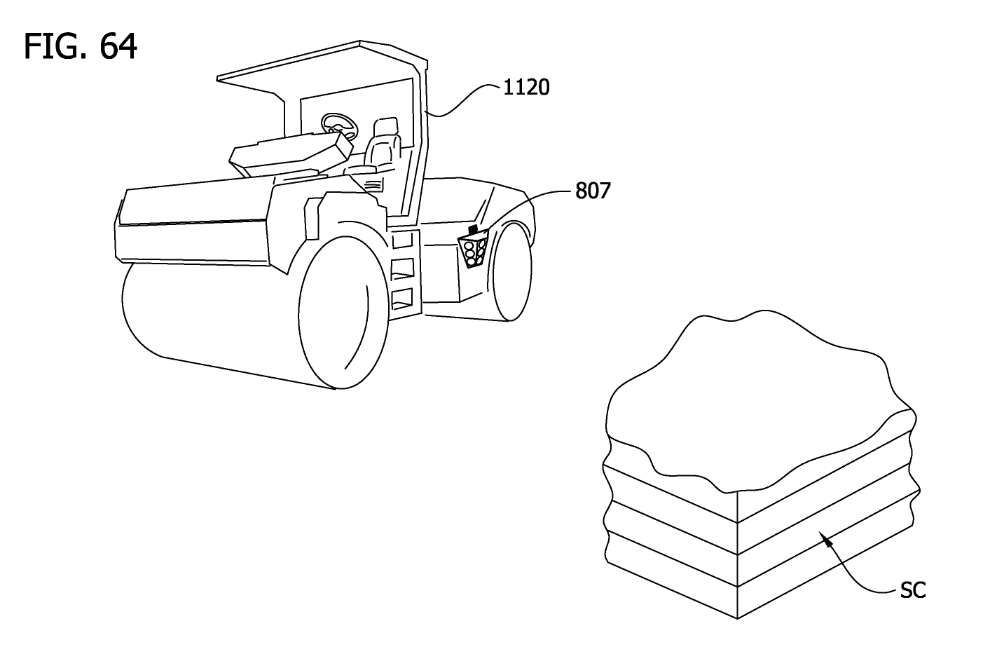

In an aspect of the present invention, scanners 807 such as those described above may be used to scan an outdoor environment to collect image data representative of soil and soil compaction. The image data may be used to generate a model, using steps similar to those described above. The model may be provided for mapping soil and various layers or zones of compaction. These are schematically illustrated in the lower right of FIG. 64. From the model, soil compaction SC can be directly determined based on density of the soil and/or water particles. The radar devices of scanners of the present invention may be used to scan volumes, measuring and mapping soil densities within the volumes. These densities can be observed at different soil compaction (lift) stratifications. The models permit soil densities to be compared to adjacent densities within the same scan volumes, as well as adjacent scans.

As illustrated in FIG. 64, in one example, a scanner 807 such as described above with respect to the garbage truck 805, may be provided on circulating construction equipment, such as a roller 1120. The scanner 807 may be provided on other circulating construction equipment without departing from the scope of the present invention. The circulating construction equipment may serve a data collection function much like the fleet described above with respect to FIGS. 61-63. The soil compaction SC may be passively mapped on the construction site as the construction equipment is moved about the site for other reasons. If a scanner is provided on a roller 1120 as illustrated in FIG. 64, the roller may monitor the soil compaction SC to achieve relatively precise desired values. The model of soil compaction would provide the roller operator and/or roller machine guidance equipment with more precise knowledge of soil densities than prior art methods of indirect estimation based on travel paths of the roller and/or discrete bore testing.

In another aspect of the present invention, a model analysis may be conducted representative of a certain area or zone identified by prior art techniques as needing a more precise determination of soil density or compaction. For example, prior art techniques such as discussed above may be used to flag potentially inadequate zones of inadequate soil compaction, and a scan may be performed of that area to provide a model and more precise analysis. The scan may be performed using a handheld scanner, vehicle mounted scanner, or a scanner on other types of supports, including a boom, tripod, or post. Moreover, if a prior art method of determining was inconclusive as to whether adequate soil compaction was achieved, a scan according to the present invention may be performed to supplement the analysis.

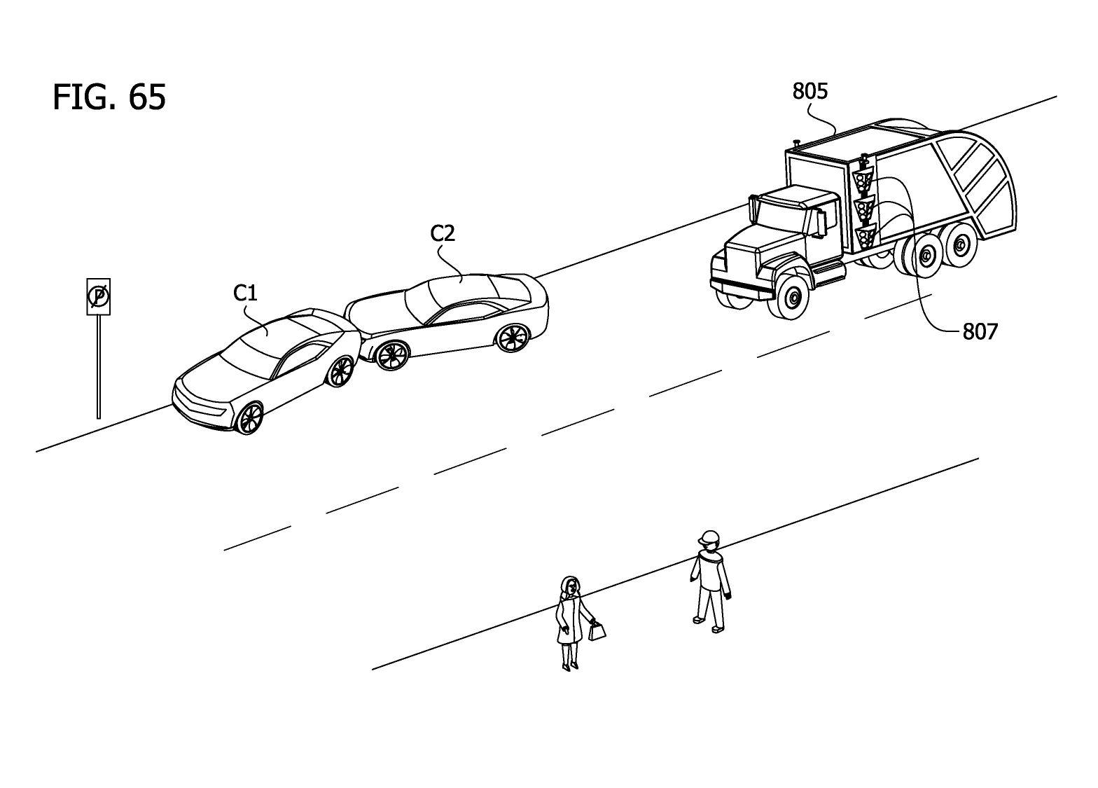

The scanners 807 may also be used to observe public activity. As shown in FIG. 65, a scanner 807 is again attached to a garbage truck 805 that travels along a city street. Again the scanner 807 may employ both radar and photography as well as other sensors. In this case, the scanner 807 may detect that a first car C1 is parked in a zone that is a no parking zone. This may be accomplished by comparing the location of the car with the previously mapped and marked no parking zones. Additionally, it may be observed that a second car C2 has run into the first car C1. This incident may be reported to the authorities. It would also be possible to track the speed of vehicles on the road for speed limit enforcement. The scanner 807 preferably can pick up the license plates on the cars so that specific identification can be made. The scanner 87 can make a record that might be used in a subsequent legal proceeding to establish liability or fault. Finally, the activities of individuals in public places may be observed. Illustrated in FIG. 65 is a man beginning the act of stealing a woman's purse. Such activity could be instantly relayed to authorities and identifying information could be recorded for later use. In all instances, scan data can be time stamped for precise identification of the event or condition observed in the scan data.

In another embodiment of the present invention, the platform for a scanner of the type described previously herein can be an unmanned aerial vehicle (UAV). Unmanned aerial vehicles are also commonly known as unmanned airborne systems (UAS) or drones, and are typically defined as aircrafts without human pilots on board. The flight paths of UAVs of the present invention can either be controlled autonomously by computers in the vehicle, or under the remote control of a pilot on the ground or in another vehicle. The present invention utilizes both fixed-wing and rotorcraft UAVs to perform synthetic aperture radar and synthetic aperture photogrammetry sensing into opaque volumes and of surfaces. Both fixed-wing and rotorcraft UAVs may be used outdoors, and rotorcraft may also be used for interior sensing. Fixed-wing and rotorcraft UAVs of the present invention may be used for spotlight synthetic aperture scanning, and also strip synthetic aperture scanning, however preferred embodiments of fixed-wing UAVs are applied to strip synthetic aperture scanning, and rotorcraft UAVs are for spotlight synthetic aperture scanning.

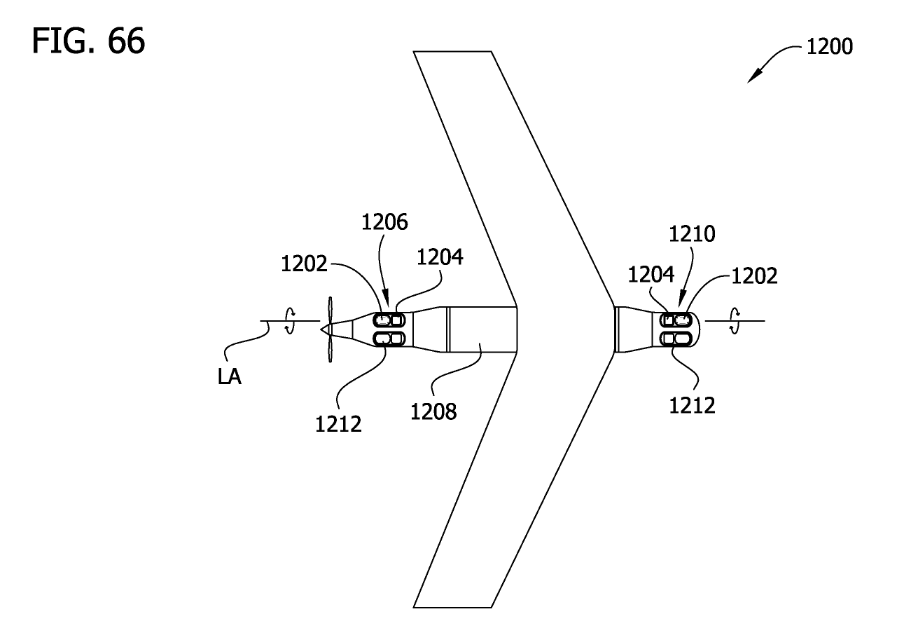

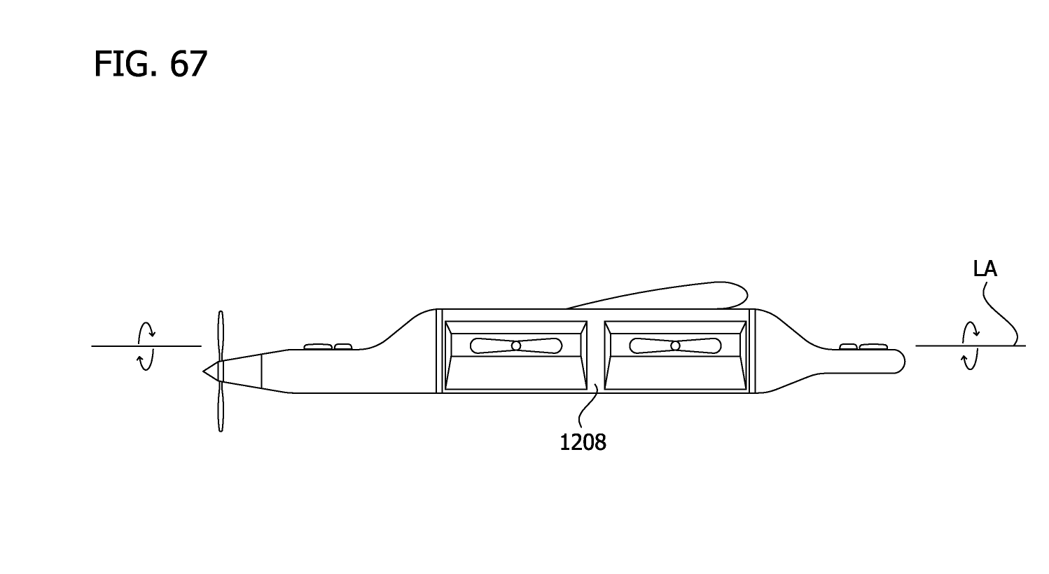

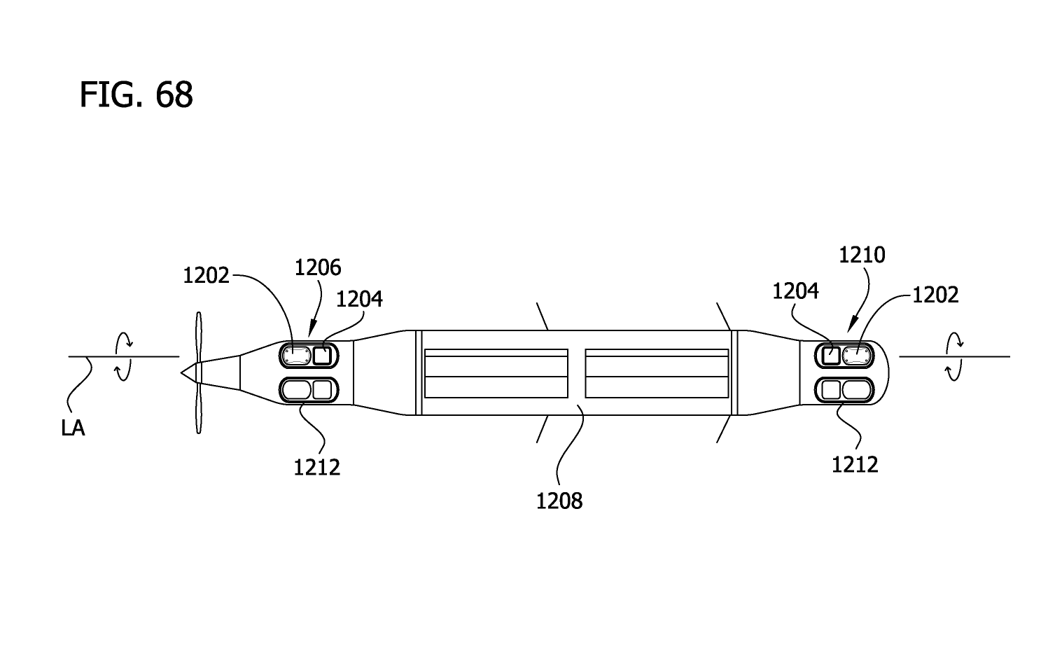

A fixed-wing UAV 1200 constructed according to the principles of the present invention is shown in FIGS. 66-69 and a fuselage, fixed airfoil wing, propeller, propulsion engine and at least one of a propulsion fuel storage or battery, wireless communicator, GPS navigation receiver, digital camera, although the preferred embodiment is two cameras 1212, and radar. Some versions also contain at least one inertial measurement sensor, compass and/or inclinometer, strobe light (broadly, a “flash source”), an isotropic photo-optical target structure, and ground station distance measurement system such as a laser, retroreflector optical target, radar, or radar target. The illustrated embodiment includes two GPS navigation receivers 1202 and two inertial measurement units 1204, with one combination GPS receiver and inertial measurement unit 1206 positioned forward of flight of the radar fuselage segment 1208, and a second combination GPS receiver and inertial measurement unit 1210 positioned rearward of flight of the radar fuselage segment. Preferably the GPS and inertial measurement units 1206, 1210 are located on the centerline of phase centers of the radar antenna structure, and can be moved to accommodate positional changes of the radar antenna structure. In one embodiment, the centerline is parallel to the longitudinal axis LA of the fuselage.

The preferred embodiment of the fixed-wing UAV 1200 provides mounting of the fixed wing generally above the fuselage, enabling radar and photographic sensors clear view of target areas below and to the lower sides. The high fixed wing placement also serves to limit multipath interference from radar backscatter reception, and enable the radar from two radar units to engage the target area surface at a Brewster angle without interference. The fuselage segment 1208 containing the radar units is formed of a tubular construction and contains the radar units entirely shielding them from any aerodynamic surface of the UAV 1200. The material of the fuselage can be of a radio frequency transparent and light translucent or transparent material such as fiberglass composite. The fiberglass, cylindrical fuselage can be of a white color, contrasting to the other externally visible structures of the aircraft. This makes the UAV 1200 readily visible to cameras in other locations such as on the ground. The radar unit structural segment of the fuselage forms both the main structural member of the UAV, serves as a radome, contains the radar units within the aircraft fuselage outside of the relative wind airflow of the UAV, and also forms a strobe light illuminated isotropic photo-optical target structure.

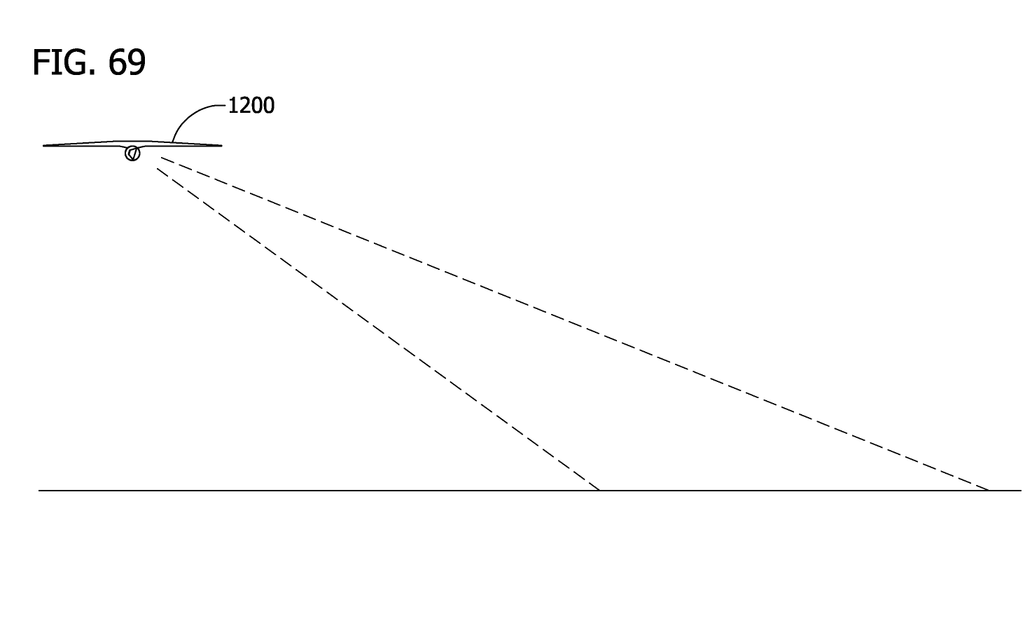

Referring to FIG. 69, it may be seen that in use the fixed-wing UAV 1200 flies relatively low, perhaps as low as 50 or 100 feet above the ground, and captures a series of overlapping images from scans. The radar looks to the side of the aircraft and intersects the ground at a shallow angle corresponding to the Brewster angle to give good coupling of the radio waves for entry into the ground. The photographic sensors will be installed to look vertically downward and along the path of the radar scans so that the path on the ground traversed by the aircraft as well as the strip of the earth's surface scanned with the radar are imaged. The scanning process illustrated in FIG. 69 is a strip scan similar to that conducted by the garbage truck 805 previously described herein. Although one pass may be sufficient, multiple passes might be necessary to obtain a high resolution model. As with other scanners described herein, the radar images beneath the surface of the ground while the photographic sensor captures the ground surface. Preferably, a three dimensional model is used.

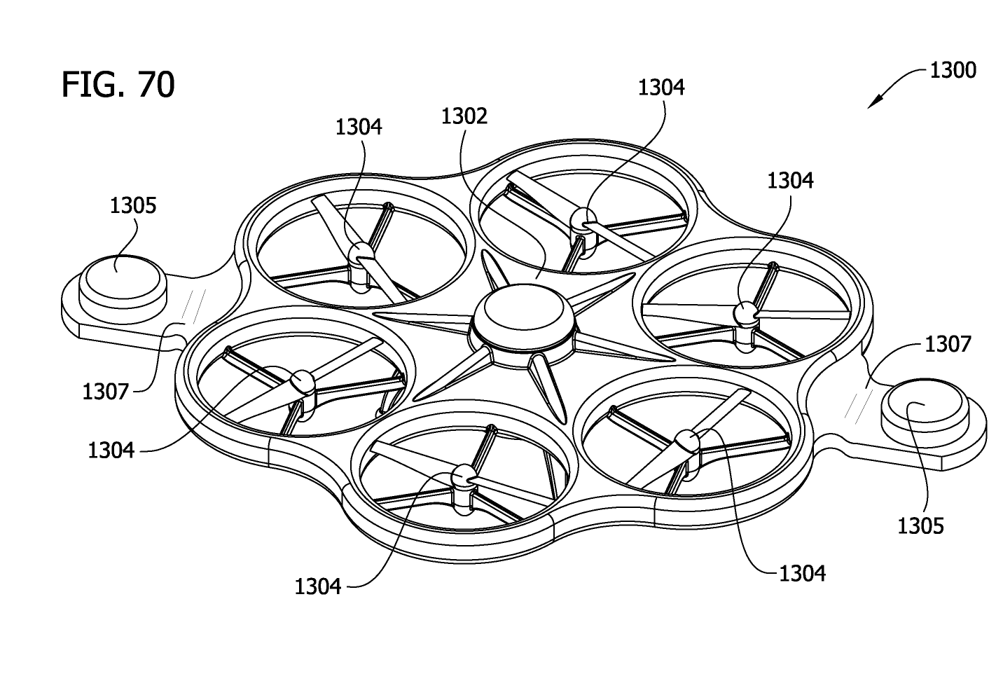

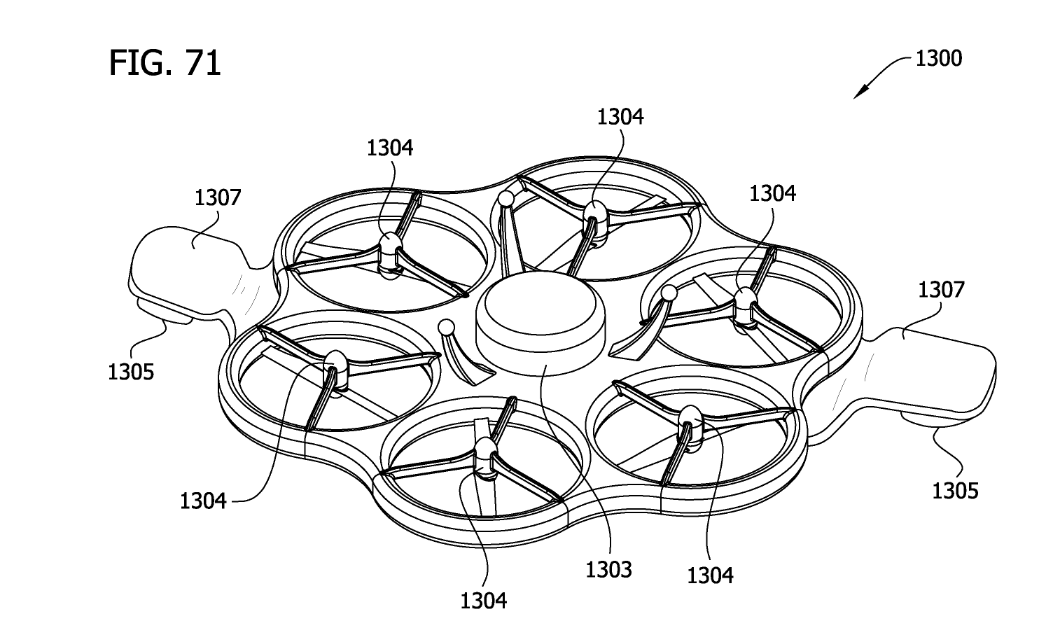

Referring now to FIGS. 70 and 71, a rotorcraft UAV 1300 constructed according to the principles of the present invention includes a central fuselage structure 1302, a propulsion engine driving air-moving propellers 1304 capable of providing sufficient lift and maneuverability, propulsion fuel storage or battery, digital camera, and synthetic aperture radar (not shown). Some versions also contain one or more of at least one inertial measurement sensor, compass, inclinometer, strobe light, isotropic photo-optical target structure, and ground station distance measurement system such as a laser, retro-reflective optical target, radar, or radar target (also not shown). The radar and camera are located centered and under a central dome 1303 of rotorcraft UAV 1300 of the preferred embodiment designed for synthetic aperture scanning into the earth. In non-earth penetrating versions, and not using a centered GPS receiver, the synthetic aperture radar and camera could be located above the central fuselage 1302 without departing from the scope of the invention.

In the illustrated embodiment of the present invention, multiple GPS and/or inertial measurement units are located away from the center of the central fuselage, and preferably forming a centerline passing through the phase centers of the synthetic aperture radar and camera system. In this embodiment, GPS units 1305 are mounted on arms 1307 extending outward from the fuselage structure 1302. This enables remote positioning determinations to find radar phase center position location and camera image exposure station location. In this case GPS sensor units are located at the ends of arms projecting out from the fuselage on opposite sides.

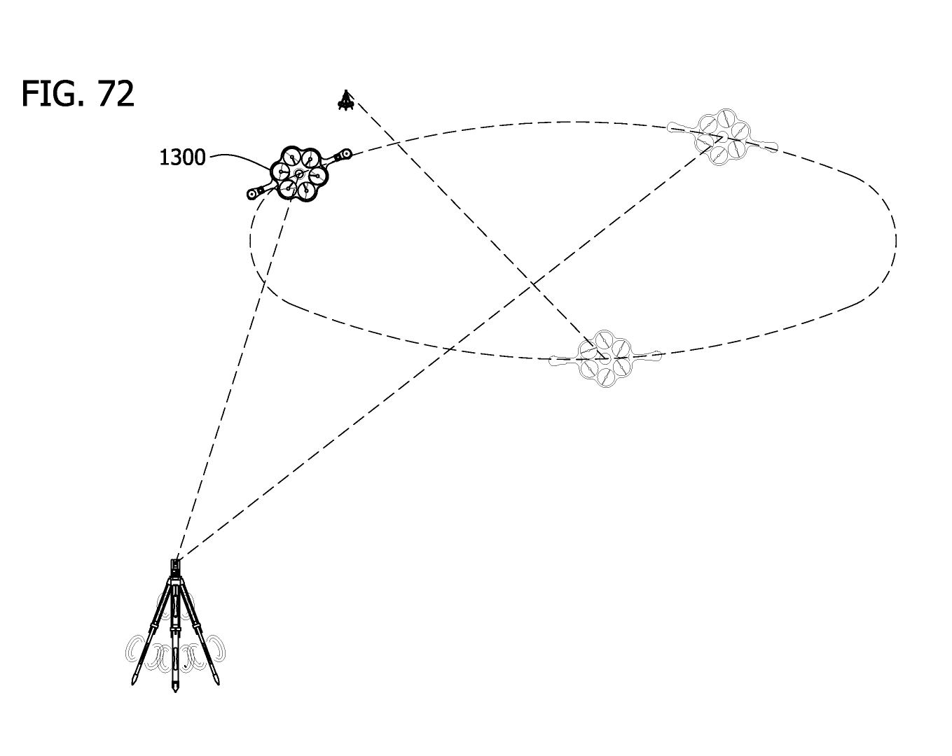

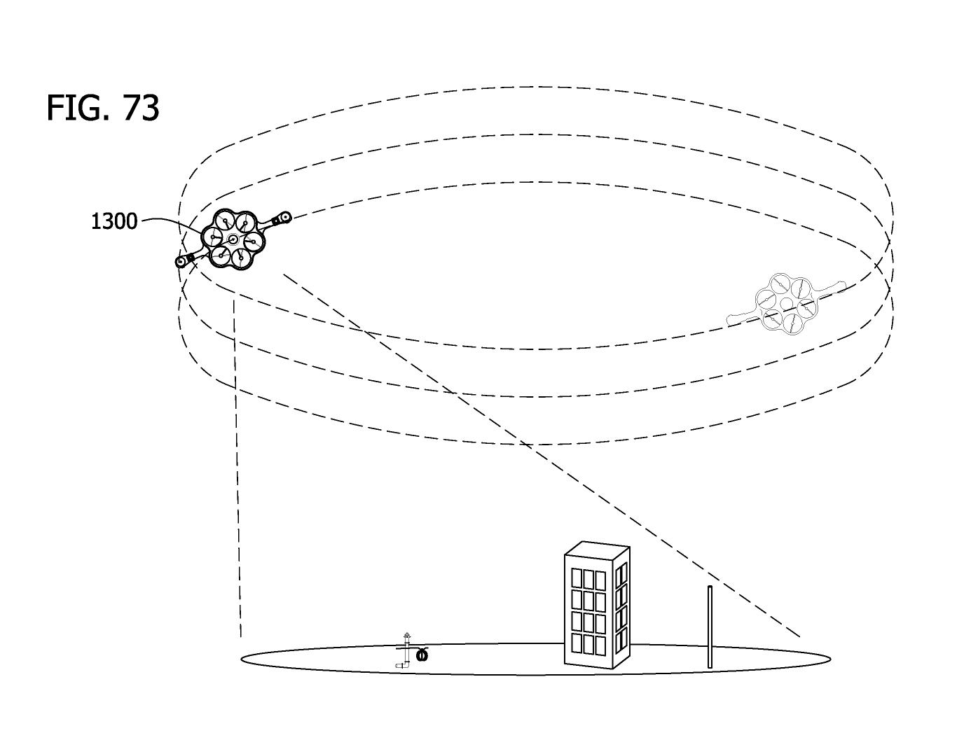

Referring now to FIGS. 72 and 73, the rotorcraft UAV 1300 is capable of taking numerous scans of the same volume by flying in the closed loop path around the zone to be scanned. The image data collected is preferably transmitted to a remote processing for creating a model. FIG. 73 shows that the scan can produce a model including a three dimensional image of a surface of objects on the ground such as a building, a utility pole and a fire hydrant. However, the radar scanning also reveals subterranean images, such as the main leading to the fire hydrant and a surveying nail in the model that is created. While the surface model is created using the pixels obtained from each photographic image, radar processing investigates and represents voxels, which are the three-dimensional equivalent of pixels. Pixels, short for picture element, a member of a 2-D array; voxels, short for volumetric pixel, are the basic element of the 3-D subsurface model. The data products obtained using this invention are both in three dimensions. That is because the pixels from the surface imaging process are given a third dimension of elevation. The voxels are inherently in three dimensions. Their use is required because of the opacity of the volume that is penetrated by the radar. The rotorcraft 1300 (as well as the fixed-wing UAV 1200) may be used as a target or make use of targets on the ground. Two total stations are shown mounted on tripods that have radar resonant reflectors, although it will be understood that other targets could be used within the scope of the present invention. As shown, the rotorcraft UAV 1300 can use the total stations as targets to more precisely locate items on the ground and to locate its own position. Similarly, the rotorcraft UAV 1300 can serve as a target for the total station. The functionality of targets has previously been described herein.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the invention may include different processor-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A target for use in combined radar and photographic scanning, the target comprising:
a support;
a generally symmetrical structure mounted on the support having the same appearance to a photographic scanning device from different vantages;
a radar reflector mounted on the support in a predetermined position with respect to the generally symmetrical structure whereby the target can be correlated between radar and photographic images.

2. A target as set forth in claim 1 wherein the generally symmetrical structure and the radar reflector are arranged to have a common center.

3. A target as set forth in claim 2 wherein the generally symmetrical structure is at least partially radar transparent.

4. A target as set forth in claim 3 wherein the radar reflector is located inside the generally symmetrical structure.

5. A target as set forth in claim 1 wherein the support comprises one of a surveying pole, tripod, cone, barrel and support bracket.

6. A target as set forth in claim 1 further comprising a global positioning system device mounted on the support.

7. A target as set forth in claim 6 wherein the global positioning system device is located on a central longitudinal axis of the generally symmetrical structure.

8. A target as set forth in claim 6 wherein the global positioning system device is capable of at least one of: storage of GPS data, wireless communication of GPS data, wirelessly communicating GPS position on sensor system demand and providing reference station corrections.

9. A target as set forth in claim 1 further comprising a transponder mounted on the support.

10. A target as set forth in claim 9 wherein the transponder comprises a wireless activated tag.

11. A target as set forth in claim 10 wherein the wireless activated tag is configured to emit unique identifying information regarding the target.

12. A target as set forth in claim 1 further comprising a light source mounted on the support.

13. A target as set forth in claim 12 wherein the light source is configured for flashing infrared light.

14. A target as set forth in claim 12 wherein the light source is configured to be activated by the photographic scanning device to flash in concert with image acquisition by the photographic scanning device.

15. A target as set forth in claim 12 wherein the radar reflector and light source are located along a common axis.

16. A target as set forth in claim 15 wherein the common axis is coincident with a longitudinal axis of the support.

17. A target as set forth in claim 1 further comprising a radar device mounted on the support.

18. A target as set forth in claim 1 further comprising a marking device mounted on the support for marking a surface in a zone to be surveyed.

19. A target as set forth in claim 1 wherein the radar reflector is embedded within the support.

20. A target as set forth in claim 1 wherein the generally symmetrical structure is formed with a surface color contrasting natural environments.

21-91. (canceled)
